(19) United States
(12) Patent Application Publication
(10) Pub. No.: US 2026/0152220 A1
(43) Pub. Date: Jun. 4, 2026

(54) CHILD CARRIER

(71) Applicant: WONDERLAND SWITZERLAND AG, Steinhausen (CH)

(72) Inventor: Zhiren ZHONG, Dongguan (CN)

(21) Appl. No.: 19/130,743

(22) PCT Filed: Nov. 17, 2023
(86) PCT No.: PCT/EP2023/082302

§ 371 Date: May 16, 2025

(30) Foreign Application Priority Data
Nov. 17, 2022 (CN) 202211440807.8
Nov. 17, 2022 (CN) 202211440825.6
Nov. 17, 2022 (CN) 202211460082.9
May 19, 2023 (CN) 202310575120.3

(51) Int. Cl. B62B 7/04; B62B 9/00; B62B 9/20

(52) U.S. Cl. CPC B62B 7/042; B62B 7/044; B62B 9/00; B62B 9/20

(57) ABSTRACT

The present disclosure relates to a child carrier. The child carrier includes a frame body, a leading assembly, a front wheel assembly, a rear wheel assembly, a push rod, and a traction assembly. The leading assembly is rotatably connected to the frame body. The front wheel assembly has a front wheel and a front fork, the front fork is coaxially connected to the leading assembly and configured to be selectively fixedly connected or rotatably connected to the leading assembly. The rear wheel assembly is connected to the frame body. The push rod is rotatably arranged at a rear end of the frame body. The traction assembly is connected between the front fork and the push rod, so that the push rod controls a rotation direction of the front wheel assembly through rotation.

### CROSS-REFERENCE TO RELATED APPLICATIONS

This application is an U.S. national phase application under 35 U.S.C. § 371 based upon international patent application No. PCT/EP2023/082302 filed on Nov. 17, 2023, which itself claims priority to Chinese patent applications No. 202211440825.6, filed on Nov. 17, 2022, No. 202310575120.3, filed on May 19, 2023, No. 202211460082.9, filed on Nov. 17, 2022, and No. 202211440807.8, filed on Nov. 17, 2022. The contents of the above identified applications are hereby incorporated herein in their entireties by reference.

### TECHNICAL FIELD

The present disclosure relates to the field of child carriers, and in particular, to a child carrier and a wheel assembly, a footrest device, and a pedal device thereof.

### BACKGROUND

At present, children's pedal tricycles are increasingly popular, which may generally be equipped with a push rod to control head and front wheel assemblies for steering. However, control structures thereof are generally complex, and the head and wheel assemblies are fixed together for synchronous steering, which is not conducive to children's control.

In addition, children's pedal tricycles on the market have single functions and lack entertainment.

### SUMMARY

In one aspect, the present disclosure is intended to provide a child carrier with a simple structure and enhanced user steering control. In another aspect, the present disclosure is intended to provide a child carrier with enhanced functionality related to electrical performance.

According to one aspect of the present disclosure, a child carrier is provided, including: a frame body, a leading assembly, a front wheel assembly, a rear wheel assembly, a push rod and a traction assembly. The leading assembly is rotatably connected to the frame body. The front wheel assembly has a front wheel and a front fork. The front fork is coaxially connected to the leading assembly and configured to be selectively fixedly connected or rotatably connected to the leading assembly. The rear wheel assembly is connected to the frame body. The push rod rotatably is arranged at a rear end of the frame body. The traction assembly is connected between the front fork and the push rod, so that the push rod controls a rotation direction of the front wheel assembly through rotation.

In one of the embodiments, the front fork further includes a pair of fork arms and a rotating base. The pair of fork arms is configured to be coupled to two opposite sides of the front wheel respectively. The rotating base is connected between the pair of fork arms and selectively rotatably connected or fixedly connected to the leading assembly. The traction assembly is connected between the rotating base and the push rod, and the push rod drives, through the traction assembly, the rotating base to rotate.

In one of the embodiments, the traction assembly further includes a two-way traction cable connected between the rotating base and the push rod. End coupling protrusions are arranged at two ends of the two-way traction cable, and an intermediate coupling protrusion is arranged on a middle section of the two-way traction cable. One of the end coupling protrusions and the intermediate coupling protrusion is fixed to the push rod, and the other of the end coupling protrusions and the intermediate coupling protrusion is mounted to the rotating base.

In one of the embodiments, one of the rotating base and the push rod is provided with a first positioning structure, and the other of the rotating base and the push rod is provided with a second positioning structure. The first positioning structure is adapted to fix the end coupling protrusions of the two-way traction cable, and the second positioning structure is adapted to fix the intermediate coupling protrusion of the two-way traction cable.

In one of the embodiments, the rotating base is further provided with a mounting groove and end engaging grooves located at two ends of the mounting groove. The mounting groove is adapted to mount the two-way traction cable, and the end engaging grooves are adapted to be engaged with the end coupling protrusions. A depth of each of the end engaging grooves is greater than that of the mounting groove, and/or a width of each of the end engaging grooves is greater than that of the mounting groove.

In one of the embodiments, the rotating base is further provided with an annular mounting groove and an intermediate engaging groove located in the annular mounting groove. The annular mounting groove is adapted to mount the two-way traction cable, and the intermediate engaging groove is adapted to be engaged with the intermediate coupling protrusion. A depth of the intermediate engaging groove is greater than that of the annular mounting groove, and/or a width of the intermediate engaging groove is greater than that of the annular mounting groove.

In one of the embodiments, the push rod is further provided with a mounting groove and end engaging grooves located at two ends of the mounting groove. The mounting groove is adapted to mount the two-way traction cable, and the end engaging grooves are adapted to be engaged with the end coupling protrusions. A depth of each of the end engaging grooves is greater than that of the mounting groove, and/or a width of each of the end engaging grooves is greater than that of the mounting groove.

In one of the embodiments, the push rod is further provided with an annular mounting groove and an intermediate engaging groove located in the annular mounting groove. The annular mounting groove is adapted to mount the two-way traction cable, and the intermediate engaging groove is adapted to be engaged with the intermediate coupling protrusion. A depth of the intermediate engaging groove is greater than that of the annular mounting groove, and/or a width of the intermediate engaging groove is greater than that of the annular mounting groove.

In one of the embodiments, the child carrier further includes an unlocking assembly. The unlocking assembly is arranged between the leading assembly and the front fork and has a lock position and an unlock position. At the lock position, the leading assembly and the front wheel assembly are circumferentially locked to rotate synchronously, and at the unlock position, the leading assembly and the front wheel assembly are rotatably connected to rotate independently of each other.

In one of the embodiments, the front fork further includes a pair of fork arms and a rotating base connected between the pair of fork arms. The unlocking assembly includes a locking member. The locking member is slidably arranged on the leading assembly and has a locking pin and an operating portion arranged on the locking pin. At the lock position, the locking pin is vertically inserted into a pin hole formed in the rotating base, and at the unlock position, the locking pin is detached from the pin hole.

In one of the embodiments, the unlocking assembly further includes an elastic member and a support protrusion. The elastic member is configured to includes a first fixed end, a second fixed end, and a bent elastic body located between the first fixed end and the second fixed end. The support protrusion is arranged on the leading assembly and adjacent to the locking member. The first fixed end and the second fixed end are respectively fixed to the locking member. The elastic body includes a first part and a second part. When the locking member is at the lock position, the support protrusion supports the first part to apply a downward elastic force to the locking member, and when the locking member is at the unlock position, the support protrusion supports the second part to apply an upward elastic force to the locking member.

In one of the embodiments, the leading assembly includes a handlebar assembly and a connecting assembly. The handlebar assembly has a handlebar and a connecting portion extending downwards from a middle portion of the handlebar. The connecting assembly is configured to support the unlocking assembly and fixedly connected to the connecting portion of the handlebar assembly and rotatably connected to the rotating base. The connecting assembly includes a support frame having the support protrusion and a gland detachably connected to the support frame. The unlocking assembly is slidably arranged between the gland and the support frame, and the operating portion is exposed through an opening in the gland.

In one of the embodiments, the support frame includes a connecting pipe located at a lower part thereof. A lamp support portion is located at an upper part thereof, a locking member support portion is located at a middle part thereof, and a hollow connecting shaft is located at the center of the connecting pipe. The locking member support portion has the support protrusion and is connected to the gland and the connecting portion.

In one of the embodiments, the front fork further includes a stepped connecting hole, a rotating nail and a fastening assembly. The stepped connecting hole is arranged at the center of the rotating base, and the connecting shaft is inserted into the stepped connecting hole. The rotating nail is inserted into a central hole of the connecting shaft and the stepped connecting hole, so as to rotatably axially connect the front fork and the leading assembly.

In one of the embodiments, the connecting pipe is further provided with a pair of stop ribs. The rotating base further includes a limiting protrusion arranged adjacent to the pin hole, and is configured such that when the unlocking assembly is at the unlock position, the rotating base is rotatable between the pair of stop ribs.

In one of the embodiments, the child carrier further includes a first connecting member, a second connecting member and a cover plate. The first connecting member is configured to rotatably connect the leading assembly and the front wheel assembly to the frame body. The second connecting member is configured to connect the frame body and the push rod. The cover plate is configured to cover a bottom side of the frame body and/or a bottom end surface of the push rod. The first connecting member includes a tubular connecting portion and at least one connecting rib. The tubular connecting portion rotatably connect the leading assembly and a rotating base of the front fork. At least one connecting rib is connected between the tubular connecting portion and the frame body.

In one of the embodiments, the traction assembly includes a two-way traction cable, a sheath and at least one protective clamp. The two-way traction cable is connected between the front fork and the push rod. The sheath wrapping a part of the two-way traction cable other than a part connected to the push rod and the front fork. At least one protective clamp is arranged on an end portion of the sheath and clamped in the first connecting member and/or the second connecting member.

In one of the embodiments, the second connecting member has a through hole for accommodating the push rod, and a pair of spaced snap protrusions are arranged at a bottom end of the through hole to constrain a bottom end of the push rod.

In one of the embodiments, the front wheel assembly further includes pedal assemblies respectively mounted at two ends of a front axle of the front wheel.

In one of the embodiments, the child carrier further includes a backrest assembly connected to the frame body. A top end of the backrest assembly is provided with a sunshade assembly.

In one of the embodiments, the backrest assembly is connected to the frame body through a connecting bracket. The backrest assembly further includes an armrest frame connected to the connecting bracket.

In one of the embodiments, the traction assembly further includes a two-way traction cable connected between the front wheel assembly and the push rod. End coupling protrusions are arranged at two ends of the two-way traction cable, and an intermediate coupling protrusion is arranged on a middle section of the two-way traction cable. The end coupling protrusions are engaged with one of the push rod and the front fork, the intermediate coupling protrusion is engaged with the other of the push rod and the front fork, and the two-way traction cable is mounted around the other.

In one of the embodiments, the child carrier further includes at least one of a light-emitting device, an electronic sound-generating module, a battery, and a USB interface.

In one of the embodiments, the light-emitting device and a switch for the light-emitting device are respectively located on a front side and a rear side of the leading assembly. The child carrier further includes a reflective sheet that reflects light from the light-emitting device.

In one of the embodiments, the child carrier further includes at least one power generation assembly. The at least one power generation assembly is mounted in at least one wheel of the front wheel assembly and a rear wheel assembly.

In one of the embodiments, the power generation assembly is mounted in the front wheel, and includes a supporting member, a generator assembly, a drive gear and a transmission gear. The supporting member is mounted on the front axle of the front wheel and has an extending end extending from the front wheel along an extension direction of the front axle. The extending end is fixed and supported by a lower end of the front fork. The generator assembly is mounted on the supporting member and having an input shaft. The drive gear is mounted on the input shaft. The transmission gear is mounted on the front axle and configured to rotate with rotation of the front axle to cause the drive gear to rotate and generate power.

In one of the embodiments, the power generation assembly is mounted in a rear wheel of the rear wheel assembly, and includes a supporting member, a generator assembly, a drive gear and a transmission gear. The supporting member is mounted on a rear axle of the rear wheel and has an extending end extending from the rear wheel along an extension direction of the rear axle. The extending end is fixed and supported by a lower end of a rear wheel stand of the rear wheel assembly. The generator assembly is mounted on the supporting member and has an input shaft. The drive gear is mounted on the input shaft. The transmission gear is mounted on the rear axle and configured to rotate with rotation of the rear axle to cause the drive gear to rotate and generate power.

In one of the embodiments, the power generation assembly includes a generator assembly and a rectifier electrically connected to the generator assembly to output a direct current.

In one of the embodiments, the rectifier is arranged in the leading assembly, the front fork, the rear wheel stand of the rear wheel assembly, or the frame body.

In one of the embodiments, the child carrier further includes at least one power generation assembly mounted in at least one wheel of the front wheel assembly and the rear wheel assembly. The power generation assembly has a rectifier to transmit, through the rectifier, power generated by the power generation assembly to at least one of the light-emitting device, the electronic sound-generating module, the battery, and the USB interface.

According to one aspect of the present disclosure, a wheel assembly is provided, including an axle, a wheel, a generator assembly, a first driving component and a first operating member. The wheel has a rim and a hub mounted on the axle to support the rim. The generator assembly is mounted in the wheel and configured to be rotatably supported by the axle and selectively receive torque from the axle. The first driving component is slidably arranged on the axle and rotating synchronously with the axle. The first operating member is connected to the first driving component and moving between a first position and a second position to cause the first driving component to slide along the axle. The first driving component is configured to enable the generator assembly to receive torque generated by rotation of the axle when the first operating member is at the first position and to disable the generator assembly from receiving the torque generated by the rotation of the axle when the first operating member is at the second position.

In one of the embodiments, the wheel assembly further includes a fork, a supporting member and a transmission gear. The fork has at least a first fork arm and a second fork arm respectively connected to two sides of the wheel and connected to each other. A supporting member supports the generator assembly and configured to be fixed relative to the first fork arm and rotatably supported by the axle. The transmission gear is slidably mounted on the axle and rotating synchronously with the axle. The hub includes a first hub and a second hub connected to each other, and the generator assembly includes an input shaft and a drive gear selectively engaged with the transmission gear. At least part of the first driving component is arranged between the supporting member and the transmission gear, and the first driving component is configured to drive the transmission gear to slide to be disengaged from the drive gear.

In one of the embodiments, the first operating member is vertically arranged in the first fork arm and is capable of sliding up and down relative to the first fork arm. The first operating member is configured to clamp an extending end of the supporting member to prevent rotation of the supporting member, and/or push the first driving component to slide along the axle to disengage the transmission gear from the drive gear.

In one of the embodiments, the first driving component includes at least one rod-shaped portion extending along the axle. The at least one rod-shaped portion is configured to pass through the supporting member to contact the first operating member. A tail end of the at least one rod-shaped portion is configured to be pushed by a lower end of the first operating member to push the transmission gear along the axle to be disengaged from the drive gear. The tail end of the at least one rod-shaped portion and/or the lower end of the first operating member are/is formed as an inclined slope or a curved surface.

In one of the embodiments, the wheel assembly further includes a first axle sleeve and a first elastic member. The first axle sleeve is fixed to the axle, rotatably supports the second hub, and axially abuts against the second hub. The first elastic member is arranged between the transmission gear and the first axle sleeve to apply an elastic force to the transmission gear.

In one of the embodiments, the first fork arm includes a first fork arm body and a first fork arm housing to form a space in the first fork arm to accommodate at least the first operating member. The first opening is formed in the first fork arm housing, and the first operating member includes a first body part, a first operating button and a first positioning assembly. The first body part extends vertically and has a lower end clamping an extending end of the supporting member. The first operating button is arranged on the first body part and exposed through the first opening. The first positioning assembly is movably arranged between the first body part and the first fork arm body to position the first operating member. One of the first body part and the first fork arm body is provided with a first positioning concave portion and a second positioning concave portion for accommodating part of the first positioning assembly. The first positioning concave portion corresponds to one of the first position and the second position, and the second positioning concave portion corresponds to the other of the first position and the second position.

In one of the embodiments, the wheel assembly further includes a second driving component and a second operating member. The second driving component is slidably arranged on the axle and rotating synchronously with the axle. The second operating member contacts the second driving component and moves between a third position and a fourth position to cause the second driving component to slide along the axle. The second driving component is configured to be engaged with the second hub so as to transmit torque between the wheel and the axle when the second operating member is at the third position, and to be disengaged from the second hub so as not to transmit the torque between the wheel and the axle when the second operating member is at the fourth position.

In one of the embodiments, the second operating member is vertically arranged in the second fork arm and is capable of sliding up and down relative to the second fork arm. The second operating member is configured to push the second driving component to slide along the axle to be disengaged from the second hub. At least one contact surface between the second driving component and the second operating member is shaped as a slope or a curved surface.

In one of the embodiments, the second fork arm includes a second fork arm body and a second fork arm housing to form a space in the second fork arm to accommodate at least the second operating member. A second opening is formed in the second fork arm housing, and the second operating member includes a second body part, a second operating button and a second positioning assembly. The second body part extends vertically and has a lower end slidably contacting the second driving component. The second operating button is arranged on the second body part and exposed through the second opening. The second positioning assembly is movably arranged between the second body part and the second fork arm body to position the second operating member. One of the second body part and the second fork arm body is provided with a third positioning recess and a fourth positioning recess for accommodating part of the second positioning assembly. The third positioning recess corresponds to one of the third position and the fourth position, and the fourth positioning recess corresponds to the other of the third position and the fourth position.

In one of the embodiments, the wheel assembly further includes a second axle sleeve and a second elastic member. The second axle sleeve is fixed to the axle, rotatably supporting the second hub, and axially abutting against the second hub. The second elastic member is arranged between the second driving component and the second axle sleeve to apply an elastic force to the second driving component.

In one of the embodiments, the fork further includes a rotating base configured to be connected to a corresponding connecting portion of a child carrier. The rotating base is arranged between the first fork arm and the second fork arm.

In one of the embodiments, the wheel assembly further includes a rectifier connected to the generator assembly through an electric wire. The rectifier is mounted in an internal space formed at a lower end of the rotating base, and the electric wire passes through the supporting member and the first fork arm and is connected to the rectifier.

In one of the embodiments, the electric wire passes around the axle and the first operating member in the first fork arm and goes up to the internal space where the rectifier is mounted.

In one of the embodiments, the axle includes a cylindrical section and a non-cylindrical section. The supporting member or both the first driving component and the supporting member are mounted on the cylindrical section to be rotatably supported by the axle.

In one of the embodiments, a limiting rib is formed on an outer peripheral surface of the supporting member to abut against an inner side of the first hub.

In one of the embodiments, the second driving component includes a body part in a frustoconical shape and at least one engaging portion axially and/or radially protruding from the body part. The second hub has at least one slot engaged with the at least one engaging portion, or the second driving component includes a body part in a frustoconical shape and at least one slot formed on the body part and axially and/or radially recessed, and the second hub has at least one engaging portion engaged with the at least one slot.

In one of the embodiments, the second hub has a central recessed part to accommodate the second driving component disengaged from the second hub. The second hub is rotatably supported by the axle.

In one of the embodiments, the second hub has a central recessed part to accommodate the second driving component disengaged from the second hub. An inner periphery of the central recessed part is rotatably supported by the axle, the second axle sleeve axially abuts against an inner side of the second hub, and the second axle sleeve axially abuts against an outer side of the second hub.

In one of the embodiments, the generator assembly includes a micro motor and a reducer.

In one of the embodiments, the wheel assembly further includes a pair of pedal devices respectively mounted to an outer side of the first fork arm and an outer side of the second fork arm and connected to two ends of the axle.

According to one aspect of the present disclosure, a wheel assembly is provided, including an axle, a wheel, a second driving component and a second operating member. The wheel has a rim and a first hub and a second hub mounted on the axle to support the rim. The second driving component is slidably arranged on the axle and rotating synchronously with the axle. The second operating member contacts the second driving component and moves between a third position and a fourth position to cause the second driving component to slide along the axle. The second driving component is configured to be engaged with the second hub so as to transmit torque between the wheel and the axle when the second operating member is at the third position, and to be disengaged from the second hub so as not to transmit the torque between the wheel and the axle when the second operating member is at the fourth position.

In one of the embodiments, the wheel assembly further includes a fork connected to two sides of the wheel and a generator assembly arranged in the wheel and fixed relative to the fork. The generator assembly is configured to selectively receive torque from the axle.

In one of the embodiments, the wheel assembly further includes a pair of pedal devices respectively mounted to an outer side of the fork and connected to two ends of the axle.

According to one aspect of the present disclosure, a child carrier is provided, including the aforementioned wheel assembly. The wheel assembly is a rear wheel assembly.

According to one aspect of the present disclosure, a child carrier is provided, including the aforementioned wheel assembly. The wheel assembly is a front wheel assembly.

In one of the embodiments, the child carrier further includes a frame body and a leading assembly, a seat, and a rear wheel assembly that are connected to the frame body. The leading assembly is fixedly or rotatably connected to the wheel assembly.

In one of the embodiments, the child carrier further includes a first connecting member. The leading assembly and the wheel assembly are connected to the frame body through the first connecting member.

In one of the embodiments, the child carrier further includes a push rod and a traction assembly. The push rod is arranged behind the seat, and the traction assembly is connected between the push rod and the front wheel assembly to control steering of the front wheel assembly by rotating the push rod.

In one of the embodiments, the child carrier further includes a second connecting member. The push rod is connected to the frame body or connected to both the frame body and the rear wheel assembly through the second connecting member.

In one of the embodiments, the rear wheel assembly includes a rear wheel and a rear wheel stand connected to the frame body. The rear wheel is connected to the rear wheel stand.

In one of the embodiments, the rear wheel assembly has a same structure as the aforementioned wheel assembly.

In one of the embodiments, the child carrier further has at least one of a rechargeable battery, a light-emitting module, a sound-generating module, and a USB interface.

According to one aspect of the present disclosure, a pedal device is provided, including a pedal assembly, a pedal base and a second disassembly mechanism. The pedal base is connected to a wheel assembly. The pedal assembly is detachably connected to the pedal base through the second disassembly mechanism.

According to one aspect of the present disclosure, a pedal device is provided, including a pedal base, a pedal assembly and a second disassembly mechanism. The pedal assembly is detachably connected to the pedal base. The pedal assembly is detachably connected to the pedal base through the second disassembly mechanism.

In one of the embodiments. the pedal assembly is provided with a second locking groove. The second disassembly mechanism includes a second locking member movably arranged on the pedal base. The second locking member has a first movable position and a second movable position. When the second locking member is at the first movable position, the second locking member is capable of being inserted into the second locking groove so that the pedal assembly is fixedly connected to the pedal base, and when the second locking member is at the second movable position, the second locking member is detached from the second locking groove, and the pedal assembly is detachable from the pedal base.

In one of the embodiments, the pedal assembly includes a pedal body and a second pin shaft connected to each other. The second pin shaft is provided with a second locking groove, and the second disassembly mechanism includes a second locking member movably arranged on the pedal base. The second locking member has a second locking hole. A radial dimension of the second locking hole is greater than that of the second pin shaft. The second pin shaft passes through the second locking hole. A position of the second locking groove corresponds to the second locking hole. The second locking member has a first movable position and a second movable position. When the second locking member is at the first movable position, part of a hole wall of the second locking hole is inserted into the second locking groove, and when the second locking member is at the second movable position, the hole wall of the second locking hole is detached from the second locking groove.

In one of the embodiments, the disassembly mechanism further includes an operating member and an operation reset member. The operating member is fixedly connected to the second locking member. The operating member is operated to move the second locking member from the first movable position to the second movable position. The operation reset member is arranged between the operating member and the pedal base. The operation reset member biases the operating member so that the operating member drives the second locking member to move to the first movable position.

In one of the embodiments, the pedal base includes a first housing and a second housing. The first housing is connected to a wheel assembly. The first housing is provided with an accommodating groove and an accommodating boss. The accommodating boss is provided with an accommodating cavity that runs through the accommodating boss. A first groove wall of the accommodating groove is provided with an insertion hole. The accommodating groove is in communication with the accommodating cavity through the insertion hole. The second housing has an operating hole and a mounting hole arranged at intervals. The first housing and the second housing are interlocked to form a mounting cavity. The accommodating groove and the accommodating boss are located in the mounting cavity. The accommodating boss passes through the mounting hole and protrudes from an outer surface of the second housing. At least part of the second pin shaft is inserted into the accommodating cavity. The second locking member and at least part of the operating member are movably arranged in the mounting cavity. At least part of the second locking member is inserted into the accommodating cavity through the insertion hole so as to fit or unfit the second locking groove of the second pin shaft, and at least part of the operating member extends out of the mounting cavity through the operating hole.

In one of the embodiments, two ends of the operation reset member abut against the operating member and a second groove wall of the accommodating groove respectively, and the second groove wall is arranged opposite to the first groove wall.

In one of the embodiments, the first groove wall forms a first limiting portion. The operating member is provided with a second limiting portion, and when the second locking member is at the first movable position, the first limiting portion abuts against the second limiting portion.

In one of the embodiments, at least two pedal devices are provided. The at least two pedal devices are drivingly connected to two sides of a wheel assembly respectively.

According to one aspect of the present disclosure, a child carrier is provided, including a frame and the aforementioned pedal device.

### BRIEF DESCRIPTION OF THE DRAWINGS

The above and other objectives, features, and advantages of specific embodiments of the present disclosure will become more apparent from the following description made in conjunction with the accompanying drawings, in which

FIG. 1 schematically shows a perspective view of a child carrier according to a first embodiment of the present disclosure, in which an unlocking assembly is at an unlock position;

FIG. 2 schematically shows another perspective view of the child carrier shown in FIG. 1, in which the unlocking assembly is at a lock position;

FIG. 3 schematically shows a bottom view of the child carrier shown in FIG. 1;

FIG. 4 schematically shows a bottom view of the child carrier according to the first embodiment of the present disclosure, in which a cover plate is removed to show a traction assembly;

FIG. 5 schematically shows a perspective view of the child carrier according to the first embodiment of the present disclosure, in which a first connecting member and the cover plate are removed;

FIG. 6 schematically shows a perspective view of the child carrier according to the first embodiment of the present disclosure, in which a seat is removed and the unlocking assembly is at the unlock position;

FIG. 7 schematically shows a perspective view of another state of the child carrier shown in FIG. 6;

FIG. 8 schematically shows a partially exploded perspective view of a child carrier according to another embodiment of the present disclosure, in which a leading assembly is in a partially disassembled state and a first connecting member is removed;

FIG. 9 is a partial enlarged view of C in FIG. 8;

FIG. 10 is a longitudinal cross-sectional view of the child carrier shown in FIG. 8, in which the leading assembly is in an assembled state and an unlocking assembly is at a lock position;

FIG. 11 is a longitudinal cross-sectional view of the child carrier shown in FIG. 8, in which the leading assembly is in an assembled state and the unlocking assembly is at an unlock position;

FIG. 12 is a partial enlarged view of E in FIG. 10;

FIG. 13 is a partial enlarged view of D in FIG. 11;

FIG. 14 is a perspective view of a front fork according to the first embodiment of the present disclosure, in which a housing of a fork arm of the front fork is removed;

FIG. 15 is a perspective view of a traction assembly according to the first embodiment of the present disclosure;

FIG. 16 is a partial enlarged view of A in FIG. 4;

FIG. 17 is a partial enlarged view of B in FIG. 10;

FIG. 18 schematically shows a perspective view of a child carrier according to another embodiment of the present disclosure;

FIG. 19 schematically shows another perspective view of the child carrier in the embodiment shown in FIG. 18, in which the push rod is removed;

FIG. 20 schematically shows yet another perspective view of the child carrier in the embodiment shown in FIG. 18, in which the push rod is removed;

FIG. 21 schematically shows yet another perspective view of the child carrier in the embodiment shown in FIG. 18, in which the push rod is removed;

FIG. 22 schematically shows a perspective view of a front wheel assembly shown in FIG. 21;

FIG. 23 schematically shows a perspective view of a pedal device according to the first embodiment of the present disclosure;

FIG. 24 schematically shows a perspective view of a power generation assembly and a rectifier according to the first embodiment of the present disclosure;

FIG. 25 schematically shows another perspective view of the power generation assembly and the rectifier shown in FIG. 24;

FIG. 26 schematically shows a perspective view of a child carrier according to a second embodiment of the present disclosure;

FIG. 27 schematically shows a partial three-dimensional view of the front wheel assembly shown in FIG. 26, in which a first operating member is shown;

FIG. 28 schematically shows another partial three-dimensional view of the front wheel assembly shown in FIG. 26, in which a second operating member is shown;

FIG. 29 is a three-dimensional exploded view of a front wheel assembly according to another embodiment of the present disclosure;

FIG. 30 is another three-dimensional exploded view of the front wheel assembly shown in FIG. 29;

FIG. 31 is a schematic three-dimensional view of a front wheel assembly according to yet another embodiment of the present disclosure, which shows engagement between a second hub and a second driving component;

FIG. 32 is a three-dimensional exploded view of the front wheel assembly shown in FIG. 31;

FIG. 33 is a longitudinal cross-sectional view of the front wheel assembly shown in FIG. 26 taken along a center line of a front axle, in which the first operating member and the second operating member are at a first position and a third position respectively;

FIG. 34 is another longitudinal cross-sectional view of the front wheel assembly shown in FIG. 33, in which the front fork is omitted;

FIG. 35 is a longitudinal cross-sectional view of the front wheel assembly shown in FIG. 33 taken along a center line of a rod-shaped portion of a first driving component, in which the front fork is omitted;

FIG. 36 is a longitudinal cross-sectional view of the front wheel assembly shown in FIG. 26 taken along the center line of the front axle, in which the first operating member and the second operating member are at a second position and the third position respectively;

FIG. 37 is a longitudinal cross-sectional view of the front wheel assembly shown in FIG. 36 taken along a center line of a rod-shaped portion of a first driving component, in which the front fork is omitted;

FIG. 38 is a longitudinal cross-sectional view of the front wheel assembly shown in FIG. 26 taken along a center line of a front axle, in which the first operating member and the second operating member are at the first position and a fourth position respectively;

FIG. 39 is a schematic structural diagram of a child carrier according to a third embodiment of the present disclosure, in which case a footrest device is in a use state;

FIG. 40 is a schematic structural diagram when the footrest device of the child carrier shown in FIG. 39 is in a non-use state;

FIG. 41 is a schematic structural diagram of the child carrier shown in FIG. 39 from another perspective;

FIG. 42 is an enlarged view of F in FIG. 41;

FIG. 43 is a schematic structural diagram of the footrest device of the child carrier shown in FIG. 39;

FIG. 44 is a schematic structural diagram when the footrest device shown in FIG. 43 is in a semi-folded state;

FIG. 45 is a schematic structural diagram when the footrest device shown in FIG. 43 is in a folded state;

FIG. 46 is a sectional view of the footrest device shown in FIG. 43 along a line G-G;

FIG. 47 is a sectional view of the footrest device shown in FIG. 44 along a line H-H;

FIG. 48 is a schematic structural diagram of a support member in the footrest device shown in FIG. 43;

FIG. 49 is a schematic structural diagram of a front wheel assembly and a pedal device shown in FIG. 39;

FIG. 50 is a schematic structural diagram when a pedal assembly and a pedal base in the front wheel assembly and the pedal device shown in FIG. 49 are in a disassembled and detached state;

FIG. 51 is a schematic structural diagram of the pedal device shown in FIG. 49;

FIG. 52 is an exploded view of the pedal device shown in FIG. 51;

FIG. 53 is a sectional view of the pedal device shown in FIG. 51 along a line K-K, in which case a second locking member is at a first movable position;

FIG. 54 is another sectional view of the pedal device shown in FIG. 51 along the line K-K, in which case the second locking member is at a second movable position;

FIG. 55 is a schematic structural diagram of the child carrier according to the second embodiment of the present disclosure, in which case the footrest device is in a use state;

FIG. 56 is a schematic structural diagram when the footrest device of the child carrier shown in FIG. 55 is in a non-use state, in which case the support member is at a second rotation position;

FIG. 57 is a schematic diagram of a partial structure of the footrest device of the child carrier shown in FIG. 55;

FIG. 58 is a sectional view of the footrest device shown in FIG. 57 along a line I-I, in which case a first locking member is at a first lock position;

FIG. 59 is a sectional view of the footrest device shown in FIG. 57 along a line I-I, in which case the first locking member is at a first unlock position;

FIG. 60 is a schematic structural diagram when a footrest assembly and the support member in the footrest device shown in FIG. 58 are in a disassembled state;

FIG. 61 is another schematic structural diagram of the child carrier shown in FIG. 56, in which case the support member is at a first rotation position;

FIG. 62 is yet another schematic structural diagram of the child carrier shown in FIG. 56, in which case the support member is between the first rotation position and the second rotation position;

FIG. 63 is a schematic structural diagram of the child carrier shown in FIG. 56 from another perspective, in which case the support member is at the second rotation position; and

FIG. 64 is an enlarged view of J in FIG. 63.

Throughout the drawings, the same reference numerals should be understood as referring to same components, parts, and structures.

### Reference Signs

100: child carrier;
10: frame body; 11: first connecting member; 111: tubular connecting portion; 112: connecting rib; 12: second connecting member; 121: through hole; 122: snap protrusion; 13: cover plate; 130: USB interface; 131: first cover plate; 132: second cover plate; 140: light-emitting device; 141: switch;
20: leading assembly; 201: support protrusion; 21: handlebar assembly; 211: handlebar; 212: connecting portion; 22: connecting assembly; 221: support frame; 222: connecting shaft; 228: central hole; 223: connecting pipe; 229: stop rib; 224: locking member support portion; 225: lamp support portion; 231: gland; 232: opening; 241: connecting ring;
30: front wheel assembly; 31: front wheel; 310: rim; 311: first hub; 3110: first central hole; 312: second hub; 3120: second central hole; 3125: central recessed part; 3127: slot; 3128: engaging portion; 3129: interval space; 32: front fork; 320: internal space; 321: fork arm; 3210: fork arm body; 3201: first positioning concave portion; 3202: second positioning concave portion; 3211: first fork arm; 3212: second fork arm; 3213: first lower housing; 3214: second lower housing; 3215: second opening; 3216: first opening; 3217: first shaft hole; 3218: second shaft hole; 322: rotating base; 323: mounting groove; 324: end engaging groove; 325: pin hole; 326: connecting hole; 327: limiting protrusion; 328: rotating nail; 329: fastening assembly; 33: front axle; 330: first clamping groove; 340: second clamping groove; 34: pedal device; 341: pedal assembly; 3411: pedal body; 3411a: second insertion groove; 3412: second pin shaft; 3412a: second locking groove; 342: pedal base; 3421: first housing; 3421a: accommodating groove; 3421b: accommodating boss; 3421c: accommodating cavity; 3421d: insertion hole; 3421e: first limiting portion; 3421f: first groove wall; 3421g: second groove wall; 3422: second housing; 3422a: operating hole; 3422b: mounting hole; 343: second disassembly mechanism; 3431: operating member; 3431a: operating portion; 3431b: second limiting portion; 3432: operation reset member; 3434: second locking member; 3434a: second locking hole;
40: rear wheel assembly; 41: rear wheel; 42: rear wheel stand; 43: rear axle;
50: seat;
60: push rod; 64: annular mounting groove; 65: intermediate engaging groove;
70: traction assembly; 71: two-way traction cable; 72: end coupling protrusion; 74: end coupling protrusion; 73: intermediate coupling protrusion; 75: sheath; 76: protective clamp;
80: unlocking assembly; 81: locking member; 82: locking pin; 83: operating portion; 84: elastic member; 85: first fixed end; 86: second fixed end; 87: elastic body; 88: first part; 89: second part;
90: backrest assembly; 91: connecting bracket; 92: armrest frame; 95. sunshade assembly;
500: power generation assembly; 501: electric wire; 510: supporting member; 511: extending end; 512: transmission gear; 513: support body part; 514: generator mounting portion; 518: threading hole; 519: limiting rib; 520: generator assembly; 521: input shaft; 522: drive gear; 530: rectifier; 540: first operating member; 541: first operating button; 542: first body part; 543: lower end; 545: first spring; 546: first ball; 550: second operating member; 551: second operating button; 552: second body part; 553: lower end; 555: second spring; 556: second ball; 560: first driving component; 562: rod-shaped portion; 570: second driving component; 571: body part; 572: connecting hole; 573: engaging portion; 580: first elastic member; 590: second elastic member; 596: first axle sleeve; 595: second axle sleeve;
600: footrest device; 610: support member; 611: first end surface; 612: second end surface; 613: first connecting portion; 614: second connecting portion; 615: first pivot portion; 615a: pivot hole; 615b: first side surface; 616: support body; 617a: first accommodating cavity; 617b: second accommodating cavity; 617c: insertion port; 618a: first perforation; 618b: second perforation; 619a: first cavity wall; 619b: second cavity wall; 620: connecting member; 621: fixed portion; 622: second pivot portion; 622a: mounting groove; 622b: second side surface; 630: footrest assembly; 631: first footrest; 632: second footrest; 633: footrest body; 633a: first insertion groove; 634: first pin shaft; 634a: first locking groove; 641: first pivot shaft; 642: second pivot shaft; 643: rotating shaft; 650: fixed assembly; 651: first magnetic portion; 652: second magnetic portion; 660: synchronization mechanism; 661: first driving member; 661a: first wheel tooth portion; 662: second driving member; 662a: second wheel tooth portion; 670: positioning mechanism; 671: first positioning recess; 672: second positioning recess; 673: positioning protrusion; 674: positioning reset member; 680: fastener; 690: first disassembly mechanism; 691: first locking member; 691a: first locking hole; 692: locking reset member;
P1: lock position; P2: unlock position.

### DETAILED DESCRIPTION OF THE EMBODIMENTS

Content such as detailed structures and assemblies defined in the specification are only intended to help comprehensively understand embodiments of the present disclosure. Therefore, those of ordinary skill in the art should understand that various changes and modifications may be made to the embodiments described herein without departing from the scope and spirit of the present disclosure. Therefore, descriptions of well-known functions and structures will be omitted for clarity and conciseness.

The present disclosure is intended to improve steering control performance of a child carrier and/or to increase various electricity-related functionality of the child carrier. Although in the various embodiments of the present disclosure described below, a child tricycle is used as an example of the child carrier for explanation, the present disclosure is not limited thereto. The child carrier involved in the present disclosure may be various strollers with wheels for pushing and/or riding.

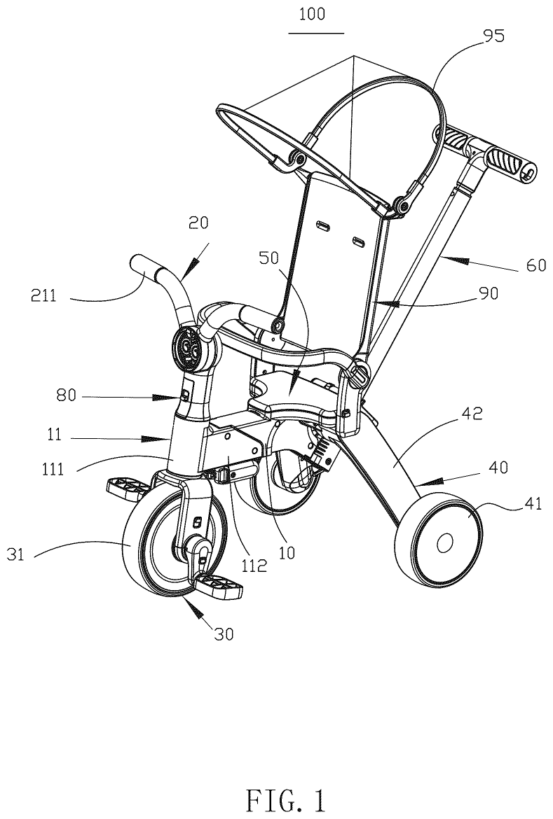

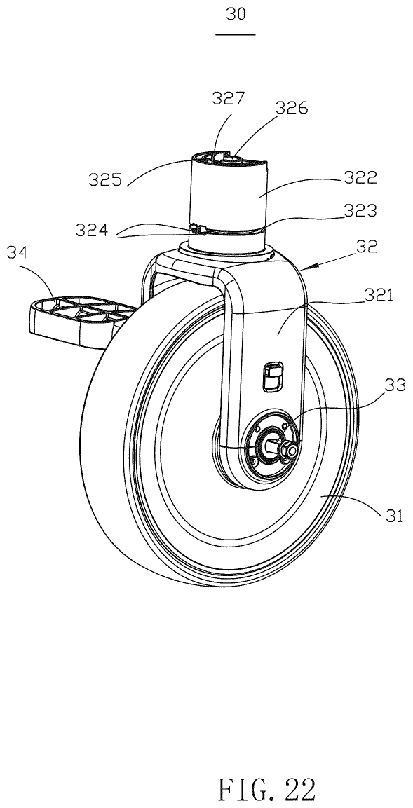

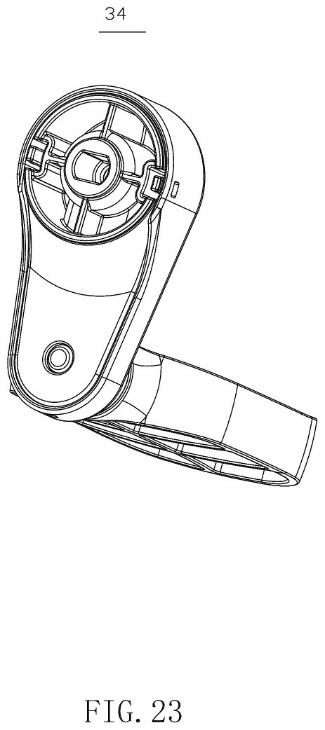

A child carrier 100 according to various embodiments of the present disclosure will be described in detail below with reference to FIG. 1 to FIG. 25.

FIG. 1 to FIG. 4 schematically show a child carrier 100 according to a first embodiment of the present disclosure. The child carrier 100 includes a frame body 10 and a leading assembly 20, a front wheel assembly 30, a rear wheel assembly 40, and a seat 50 that are directly and/or indirectly connected to the frame body 10.

The leading assembly 20 and the front wheel assembly 30 are rotatably connected to a first connecting member 11 fixedly connected to the frame body 10. Therefore, the leading assembly 20 and the front wheel assembly 30 are connected to the frame body 10 through the first connecting member 11 in a manner of synchronous or separate rotation. When the child carrier 100 is pushed or ridden to cause the front wheel assembly 30 to move forward or backward, the first connecting member 11 drives the frame body 10 and the rear wheel assembly 40 to move forward or backward together. The rear wheel assembly 40 may be directly fixedly connected to the frame body 10. The seat 50 may be fixedly or detachably arranged on the frame body 10.

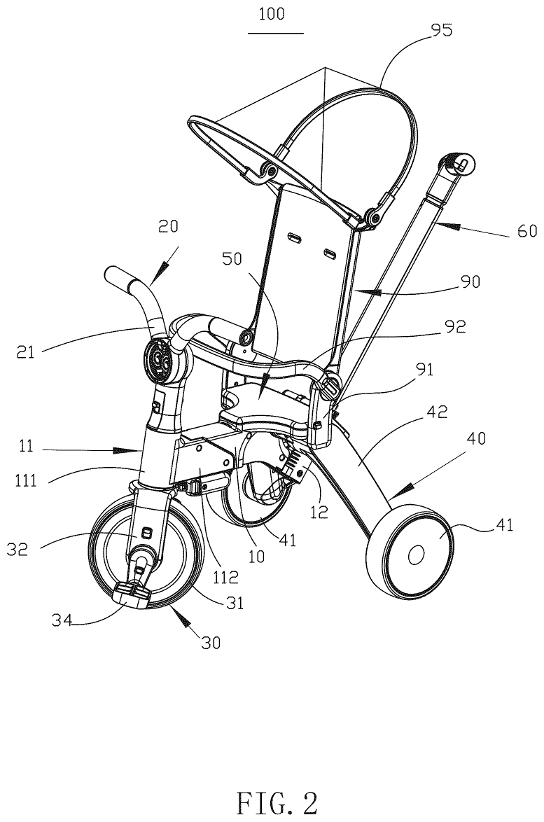

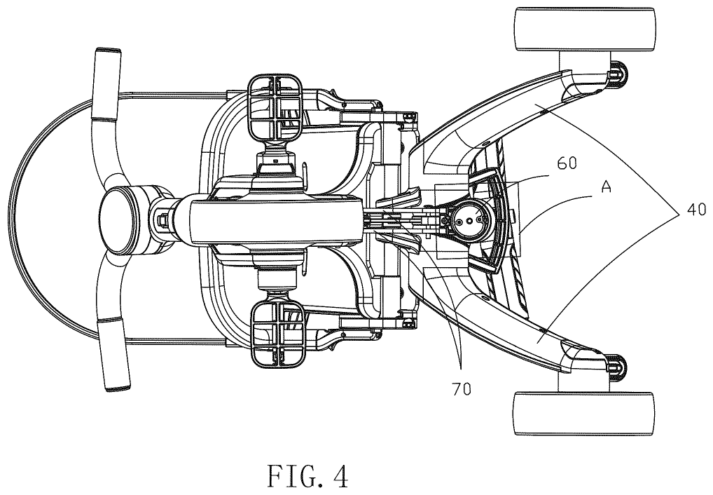

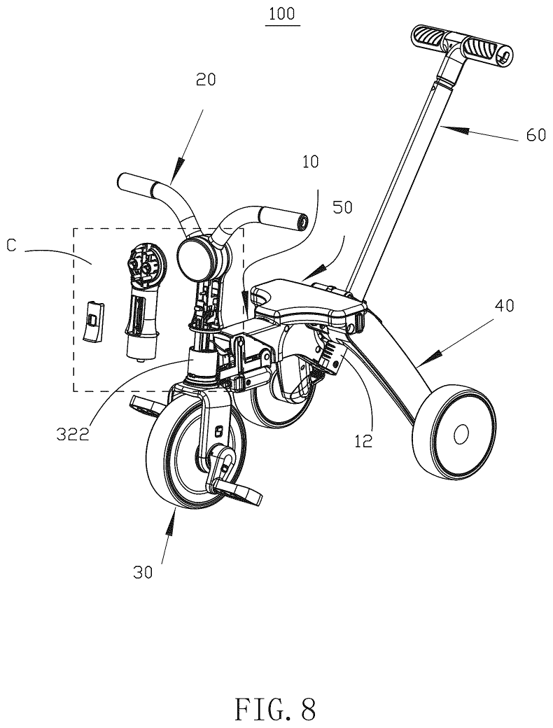

Referring to FIG. 1 and FIG. 2, in at least one embodiment according to the present disclosure, the first connecting member 11 is configured to rotatably connect the leading assembly 20 and the front wheel assembly 30 to the frame body 10. Specifically, as shown in FIG. 1 and FIG. 2, the front wheel assembly 30 has a front wheel 31 and a front fork 32, the front fork 32 is coaxially connected to the leading assembly 20 and configured to be selectively fixedly or rotatably connected to the leading assembly 20, the first connecting member 11 includes a tubular connecting portion 111 and at least one connecting rib 112, the tubular connecting portion 111 is rotatably connected to the leading assembly 20 and a rotating base 322 (see FIG. 8) of the front fork 32, and the at least one connecting rib 112 is connected between the tubular connecting portion 111 and the frame body 10. In addition, the child carrier 100 may further include a push rod 60 rotatably arranged at a rear end of the frame body 10, a traction assembly 70 (see FIG. 4) connected between the push rod 60 and the front wheel assembly 30, an unlocking assembly 80 arranged between the leading assembly 20 and the front wheel assembly 30, and a backrest assembly 90 arranged on a rear side of the seat 50.

As shown in FIG. 1 to FIG. 5, the backrest assembly 90 is connected to the frame body 10 through a connecting bracket 91. In addition, the backrest assembly 90 includes an armrest frame 92 connected to the connecting bracket 91. A top end of the backrest assembly 90 is provided with a foldable sunshade assembly 95. The sunshade assembly 95 includes a foldable sunshade frame connected to the top end of the backrest assembly 90. Shade cloth may cover the sunshade frame.

As shown in FIG. 1 to FIG. 2, the rear wheel assembly 40 has a rear wheel 41 and a rear wheel stand 42, and the rear wheel stand 42 is fixedly connected to the frame body 10. In at least one embodiment according to the present disclosure, the child carrier 100 has a front wheel assembly 30 and two rear wheel assemblies 40. In addition, two rear wheel stands 42 may be fixedly connected to the frame body 10 respectively, or may be integrally formed and fixedly connected to the frame body 10. In at least one embodiment according to the present disclosure, the rear wheel assembly 40 may have a similar structure to the front wheel assembly and be connected to the frame body 10 through an additional rear wheel stand. Quantities of the front wheel assembly 30 and the rear wheel assembly 40 may be changed according to specific design requirements of the child carrier, and are not limited to one front wheel assembly and two rear wheel assemblies.

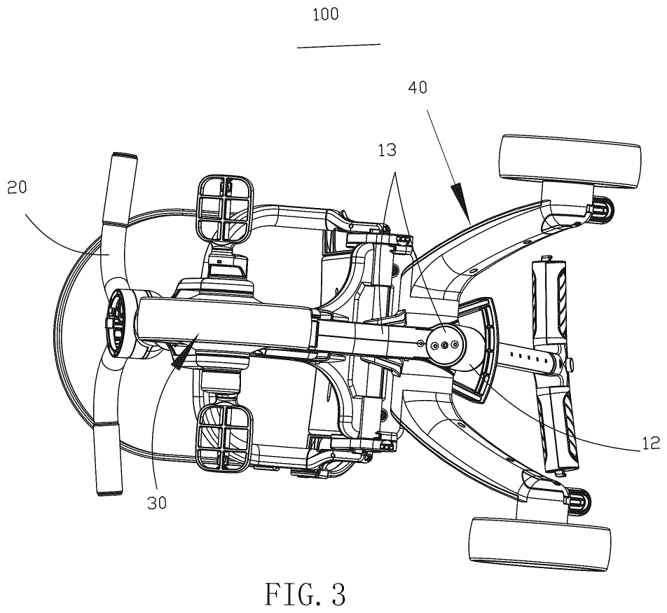

FIG. 3 and FIG. 4 are bottom views of a child carrier 100 according to different embodiments of the present disclosure. The child carrier 100 shown in FIG. 3 is provided, at the bottom, with a cover plate 13 that covers the traction assembly 70 to prevent accidental falling of the traction assembly 70. The cover plate 13 is removed from the bottom of the child carrier 100 shown in FIG. 4, whereby the traction assembly 70 is exposed.

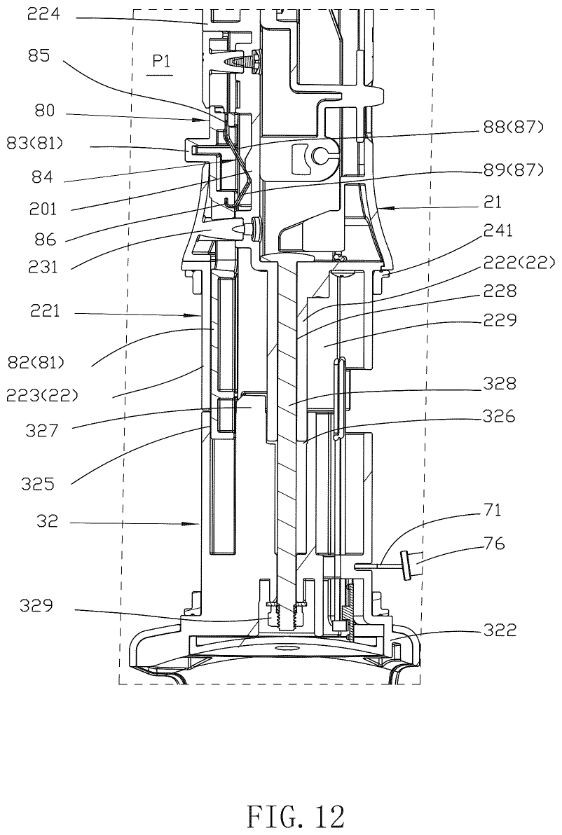

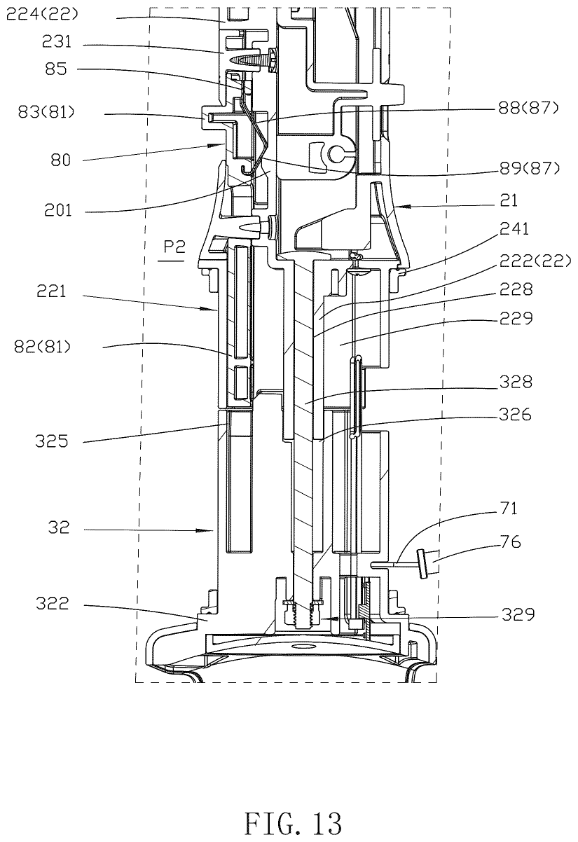

As shown in FIG. 4, in at least one embodiment according to the present disclosure, the traction assembly 70 includes a two-way traction member arranged on a bottom side of the frame body 10 and located between a pair of rear wheel assemblies 40. The two-way traction member may be, for example, a two-way traction cable 71 (see FIG. 12 and FIG. 13). The two-way traction cable 71 may be a traction member with certain flexibility such as a steel wire rope, a chain, a metal chain, a metal wire, or a rope with low elasticity. Herein, the two-way traction member may drive the front wheel assembly 30 to pivot around an axis in different rotation directions (clockwise or counterclockwise) relative to the frame body 10, and the aforementioned axis passes vertically through a rim of the front wheel 31. In this way, the front wheel assembly 30 can be turned left and right by using the push rod 60, to control a forward direction of the child carrier 100.

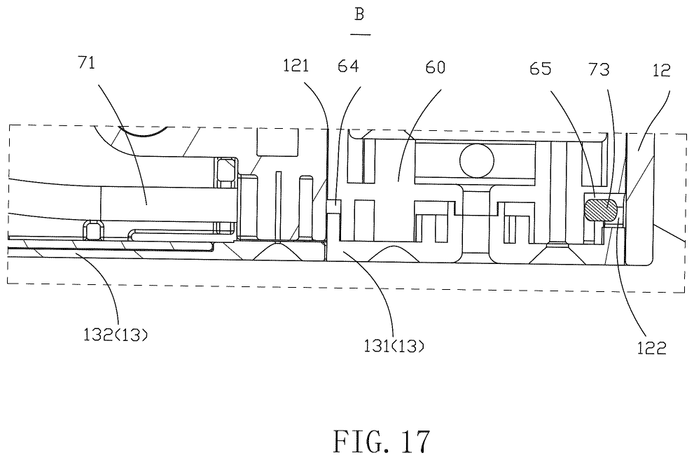

As shown in FIG. 3 and FIG. 17, the cover plate 13 may include a first cover plate 131 and a second cover plate 132. The second cover plate 132 covers the bottom side of the frame body 10, and the first cover plate 131 covers only a bottom end surface of the push rod 60 or covers only a bottom side of the second connecting member 12. The first cover plate 131 and the second cover plate 132 may be arranged separately, or may be formed integrally.

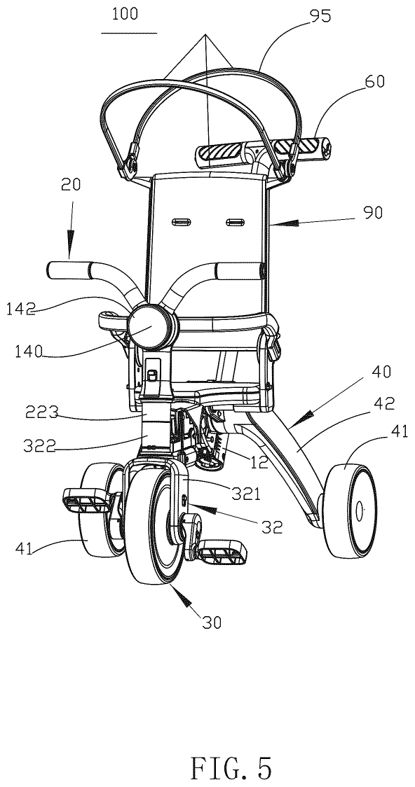

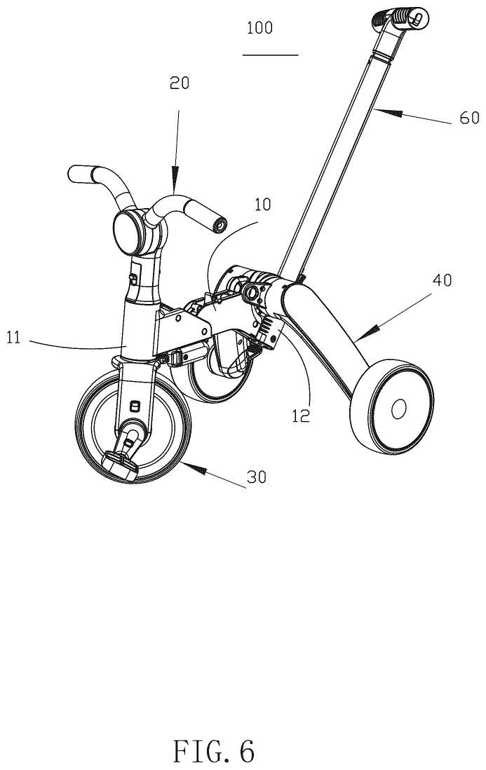

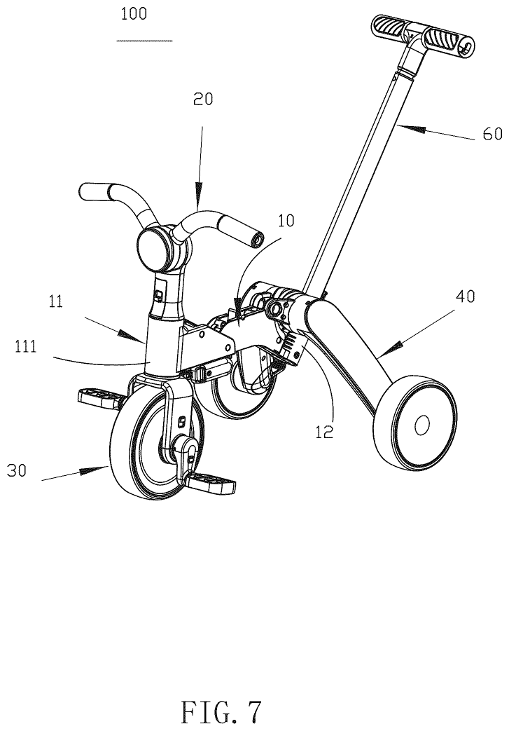

As shown in FIG. 5 to FIG. 7, FIG. 5 is a perspective view of a child carrier 100 according to an embodiment of the present disclosure, in which the first connecting member 11 and the cover plate 13 are removed, and a connection relationship between the front wheel assembly 30 and the leading assembly 20 is shown. FIG. 6 schematically shows a perspective view of a child carrier according to an embodiment of the present disclosure, in which the seat 50 is removed and the unlocking assembly 80 is at an unlock position. In this case, the leading assembly 20 and the front wheel assembly 30 respectively correspond to different orientations. FIG. 7 schematically shows a perspective view of another state of the child carrier 100 shown in FIG. 6, in which the leading assembly 20 and the front wheel assembly 30 respectively correspond to a same orientation.

In at least one embodiment according to the present disclosure, the push rod 60 is connected to the frame body 10 through the second connecting member 12. That is, as shown in FIG. 5 to FIG. 7, the second connecting member 12 is connected to the frame body 10, and a lower portion of the push rod 60 is rotatably inserted into the second connecting member 12 and is connected to the traction assembly 70, to control steering of the front wheel assembly 30 or both the front wheel assembly 30 and the leading assembly 20.

In at least one embodiment according to the present disclosure, according to structural characteristics of the frame body 10 and the rear wheel assembly 40, the second connecting member 12 has one part connected to the pair of rear wheel stands 42 and the other part connected to the frame body 10. That is, the second connecting member 12 may be configured to connect the push rod 60 to the frame body 10 and the rear wheel assembly 40 (specifically the rear wheel stand 42).

As shown in FIG. 5, the front fork 32 further includes a pair of fork arms 321 and a rotating base 322 connected between the pair of fork arms 321. The pair of fork arms 321 is configured to be coupled to two opposite sides of the front wheel 31 respectively. The rotating base 322 is connected between the pair of fork arms 321 and selectively rotatably connected or fixedly connected to the leading assembly 20. The pair of fork arms 321 may be formed separately, or may be formed integrally.

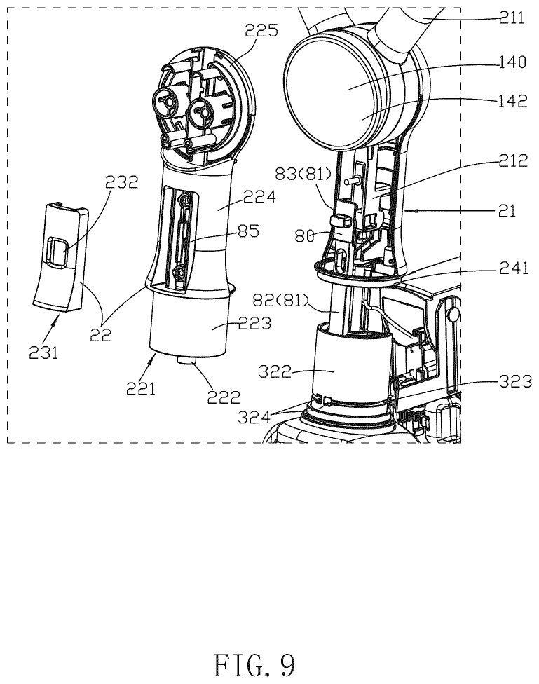

Referring to FIG. 8 to FIG. 9, more specifically, the rotating base 322 is selectively rotatably or fixedly connected to a lower end of the leading assembly 20 through the unlocking assembly 80. FIG. 8 schematically shows a partially exploded perspective view of a child carrier according to another embodiment of the present disclosure, in which a leading assembly is in a partially disassembled state and a first connecting member is removed. FIG. 9 is a partial enlarged view of C in FIG. 8.

It is to be first noted that, as shown in FIG. 8 and FIG. 9, the leading assembly 20 includes: a handlebar assembly 21 having a handlebar 211 and a connecting portion 212 extending downwards from a middle portion of the handlebar 211; and a connecting assembly 22 configured to support the unlocking assembly 80 and fixedly connected to the connecting portion 212 of the handlebar assembly 21 and rotatably connected to the rotating base 322. The connecting assembly 22 includes a support frame 221 and a gland 231. The gland 231 is detachably connected to the support frame 221 or may be fixedly connected to the support frame 221. The unlocking assembly 80 is slidably arranged between the gland 231 and the support frame 221.

In at least one embodiment according to the present disclosure, as shown in FIG. 8 and FIG. 9, the support frame 221 includes a connecting pipe 223 located at a lower part thereof, a lamp support portion 225 located at an upper part thereof, a locking member support portion 224 located at a middle part thereof, and a hollow connecting shaft 222 located at the center of the connecting pipe 223. The locking member support portion 224 is provided with a support protrusion 201 (see FIG. 12 and FIG. 13) and is connected to the gland 231 and the connecting portion 212. However, the present disclosure is not limited thereto.

In addition, referring to FIG. 7 to FIG. 9, an upper end and/or a lower end of the tubular connecting portion 111 of the first connecting member 11 may be connected to an upper end of the connecting pipe 223 and a lower end of the rotating base 322 through a connecting ring 241 respectively. In some embodiments according to the present disclosure, the connecting ring 241 may be an annular member with threads. In some embodiments according to the present disclosure, the connecting ring 241 may alternatively be a seal ring to achieve dual functions of shock absorption and sealing.

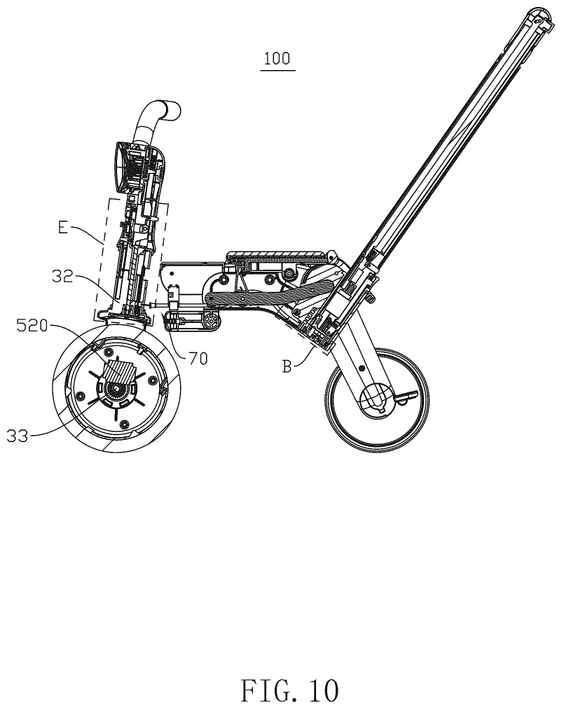

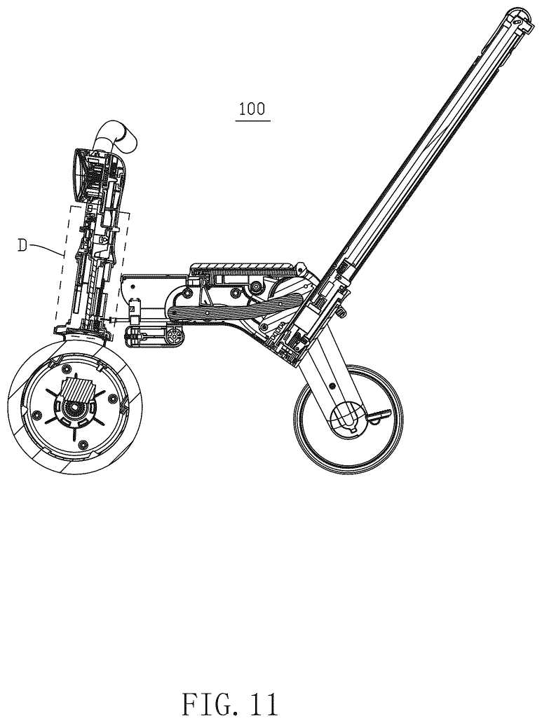

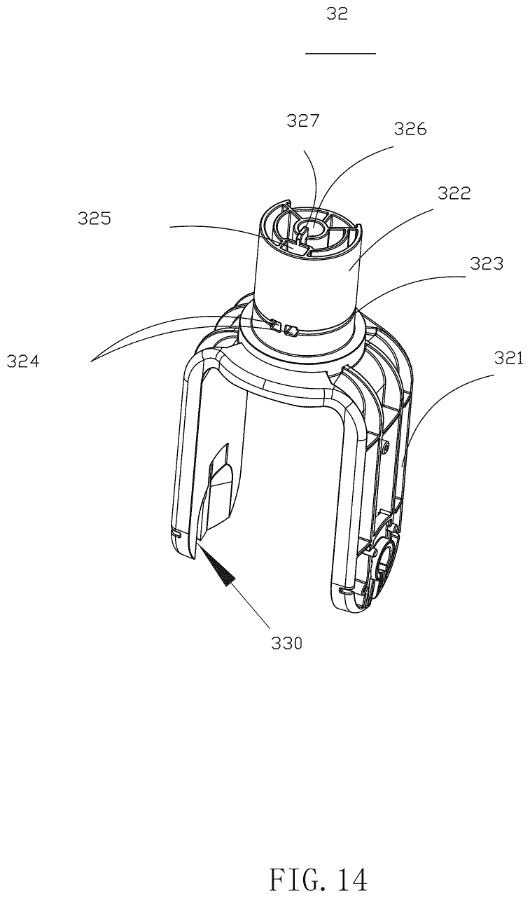

Referring to FIG. 10 to FIG. 14, specific structures of the unlocking assembly 80, the leading assembly 20, and the front fork 32 and locking and unlocking principles of the unlocking assembly 80 are described in more detail. FIG. 10 is a longitudinal cross-sectional view of the child carrier shown in FIG. 8, in which the leading assembly 20 is in an assembled state and the unlocking assembly 80 is at a lock position. FIG. 11 is a longitudinal cross-sectional view of the child carrier shown in FIG. 8, in which the leading assembly 20 is in an assembled state and the unlocking assembly 80 is at an unlock position. FIG. 12 is a partial enlarged view of E in FIG. 10. FIG. 13 is a partial enlarged view of D in FIG. 11. FIG. 14 is a perspective view of a front fork according to an embodiment of the present disclosure, in which a housing of a fork arm 321 of the front fork 32 is removed.

The unlocking assembly 80 has a lock position P1 (see FIG. 12) and an unlock position P2 (see FIG. 13). At the lock position P1, the leading assembly 20 and the front wheel assembly 30 are circumferentially locked and rotate synchronously. At the unlock position P2, the leading assembly 20 and the front wheel assembly 30 are rotatably connected, so that the leading assembly 20 and the front wheel assembly 30 can rotate respectively.

More specifically, when the unlocking assembly 80 is at the unlock position P2, the rotating base 322 is rotatably connected to the lower end of the leading assembly 20, so that the leading assembly 20 no longer controls the steering of the front wheel assembly 30, but the steering of the front wheel assembly 30 can only be controlled by the push rod 60 through the traction assembly 70 (the two-way traction cable 71). When the unlocking assembly 80 is at the lock position P1, the rotating base 322 and the lower end of the leading assembly 20 are circumferentially locked to rotate synchronously, so that both the leading assembly 20 and the push rod 60 can control the steering of the front wheel assembly 30.

For example, FIG. 8 shows the child carrier 100 with the unlocking assembly 80 at the lock position P1. In this case, the leading assembly 20 and the front wheel assembly 30 can rotate synchronously. In this case, both a child riding the child carrier 100 and a caregiver pushing the child carrier 100 can control a direction of the front wheel assembly 30, and a rotation direction of the front wheel assembly 30 is ultimately determined by the party exerting a greater force.

FIG. 6 shows the child carrier 100 with the unlocking assembly 80 at the unlock position P2. In this case, the leading assembly 20 and the front wheel assembly 30 may rotate asynchronously. That is, when the unlocking assembly 80 is at the unlock position P2, the leading assembly 20 will no longer be capable of controlling the steering of the front wheel assembly 30, but can only change the rotation direction of the front wheel assembly 30 by controlling the push rod 60. In this case, a user can change a forward direction of the front wheel assembly 30 by rotating the push rod 60, while the child can continue to operate the leading assembly 20 without affecting each other. As shown in FIG. 6, a direction of the leading assembly 20 and a direction of the front wheel assembly 30 are not consistent. The former may be controlled by the child riding the child carrier 100, and the latter may be controlled by the child caregiver pushing the child carrier 100.

As shown in FIG. 12 to FIG. 13, the unlocking assembly 80 includes a locking member 81, and the locking member 81 is slidably arranged on the support frame 221 of the leading assembly 20 and has a locking pin 82 and an operating portion 83 arranged on the locking pin 82. The operating portion 83 is exposed through an opening 232 (e.g., FIG. 9) in the gland 231 for the user to operate.

The unlocking assembly 80 further includes an elastic member 84. The elastic member 84 is configured to include a first fixed end 85 and a second fixed end 86 respectively fixed to upper and lower ends of the operating portion 83, and a bent elastic body 87 located between the first fixed end 85 and the second fixed end 86. The elastic body 87 includes a first part 88 and a second part 89, and on the support frame 221 of the leading assembly 20, a support protrusion 201 is provided at a position corresponding to the elastic body 87.

As shown in FIG. 12, when the locking member 81 is at the lock position P1, the support protrusion 201 abuts against the first part 88 to apply a downward elastic force to the locking member 81. As shown in FIG. 13, when the locking member 81 is at the unlock position P2, the support protrusion 201 abuts against the second part 89 to apply an upward elastic force to the locking member 81. Since the locking member 81 is subject to an elastic force of the elastic member 84 at both the lock position P1 and the unlock position P2, the unlocking assembly 80 can be maintained at the lock position P1 or the unlock position P2 without automatically resetting.

In this way, by operating the operating portion 83 to slide the locking member 81 downwards against the elastic force of the elastic member 84, the unlocking assembly 80 can be moved from the unlock position P2 to the lock position P1. As shown in FIG. 12, when the unlocking assembly 80 is at the lock position P1, the locking pin 82 is vertically inserted into a pin hole 325 formed in the rotating base 322, so that the leading assembly 20 and the front wheel assembly 30 are circumferentially locked to rotate synchronously. By operating the operating portion 83 to slide the locking member 81 upwards against the elastic force of the elastic member 84, the unlocking assembly 80 can be moved from the lock position P1 to the unlock position P2. At the unlock position P2, the locking pin 82 is detached from the pin hole 325, so that the circumferential locking between the leading assembly 20 and the front wheel assembly 30 is released. In this way, the leading assembly 20 and the front wheel assembly 30 are rotatably connected so that they can rotate independently of each other. That is, the rotation of the leading assembly 20 no longer drives the front wheel assembly 30 to rotate.

In at least one embodiment according to the present disclosure, the elastic member 84 may be a spring leaf with a curved shape, and is pressed between the support protrusion 201 and the locking member 81. In at least one embodiment according to the present disclosure, one side of the support protrusion 201 is configured to support the first part 88 to apply a downward elastic force to the locking member 81, and the other side of the support protrusion 201 is configured to support the second part 89 to apply an upward elastic force to the locking member 81.

In at least one embodiment according to the present disclosure, as shown in FIG. 12 to FIG. 14, the front fork 32 further includes a stepped connecting hole 326 arranged at the center of the rotating base 322, and the connecting shaft 222 is inserted into the stepped connecting hole 326. The front fork 32 further includes a rotating nail 328 and a fastening assembly 329, and the rotating nail 328 is inserted, through a central hole 228 of the connecting shaft 222, into the stepped connecting hole 326, so as to rotatably axially connect the front fork 32 and the leading assembly 20. Therefore, the front wheel assembly 30 and the leading assembly 20 can be axially connected to eliminate or reduce axial movement of the leading assembly 20.

In addition, as shown in FIG. 14, the rotating base 322 further includes a limiting protrusion 327 arranged adjacent to the pin hole 325. In at least one embodiment according to the present disclosure, the limiting protrusion 327 is between the pin hole 325 and the stepped connecting hole 326. Correspondingly, as shown in FIG. 12 and FIG. 13, a pair of stop ribs 229 circumferentially spaced apart from each other is also provided in the connecting pipe 223. The pair of stop ribs 229 is connected between the connecting pipe 223 and the connecting shaft 222, and a circumferential angle between the pair of stop ribs 229 corresponds to a rotation range of the leading assembly 20. That is, when the unlocking assembly 80 is at the unlock position P2, the pair of stop ribs 229 respectively defines a left stop point for left rotation and a right stop point for right rotation of the front wheel assembly 30 relative to the leading assembly 20. In some embodiments according to the present disclosure, when the unlocking assembly 80 is at the lock position P1, rotation angles of the front wheel assembly 30 and the leading assembly 20 may be constrained through the first connecting member 11.

A detailed structure of the traction assembly 70 according to at least one embodiment of the present disclosure will be described in detail below with reference to FIG. 14 to FIG. 17.

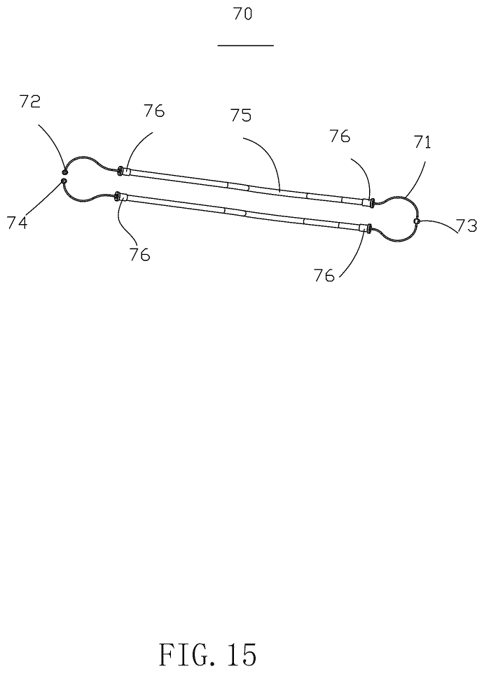

As described above, the traction assembly 70 includes a two-way traction cable 71 connected between the rotating base 322 and the push rod 60. In at least one embodiment according to the present disclosure, as shown in FIG. 15, the traction assembly 70 further includes end coupling protrusions 72 and 74 arranged at two ends of the two-way traction cable 71 and an intermediate coupling protrusion 73 arranged on a middle section of the two-way traction cable 71. The end coupling protrusions 72 and 74 are engaged with one of the push rod 60 and the front fork 32 (specifically the rotating base 322), the intermediate coupling protrusion 73 is engaged with the other of the push rod 60 and the front fork 32 (specifically the rotating base 322), and the two-way traction cable 71 is mounted around the other. One of the rotating base 322 and the push rod 60 is provided with a first positioning structure, and the other is provided with a second positioning structure, the first positioning structure is adapted to fix the end coupling protrusions 72 and 74 of the two-way traction cable 71, and the second positioning structure is adapted to fix the intermediate coupling protrusion 73 of the two-way traction cable 71.

More specifically, one of the end coupling protrusions 72 and 74 and the intermediate coupling protrusion 73 may be engaged with a bottom end surface or a circumferential surface of the push rod 60, and the other of the end coupling protrusions 72 and 74 and the intermediate coupling protrusion 73 may be mounted to a circumferential surface of the rotating base 322.

In this embodiment, as shown in FIG. 14, the first positioning structure is provided on a surface (e.g., a side surface) of the rotating base 322, and the first positioning structure may be a mounting groove 323 and end engaging grooves 324 located at two ends of the mounting groove 323. The mounting groove 323 is adapted to mount the two-way traction cable 71, and the end engaging grooves 324 are adapted to be engaged with the end coupling protrusions 72 and 74. In at least one embodiment according to the present disclosure, a depth of each of the end engaging grooves 324 is greater than that of the mounting groove 323, and/or a width of each of the end engaging grooves 324 is greater than that of the mounting groove 323.

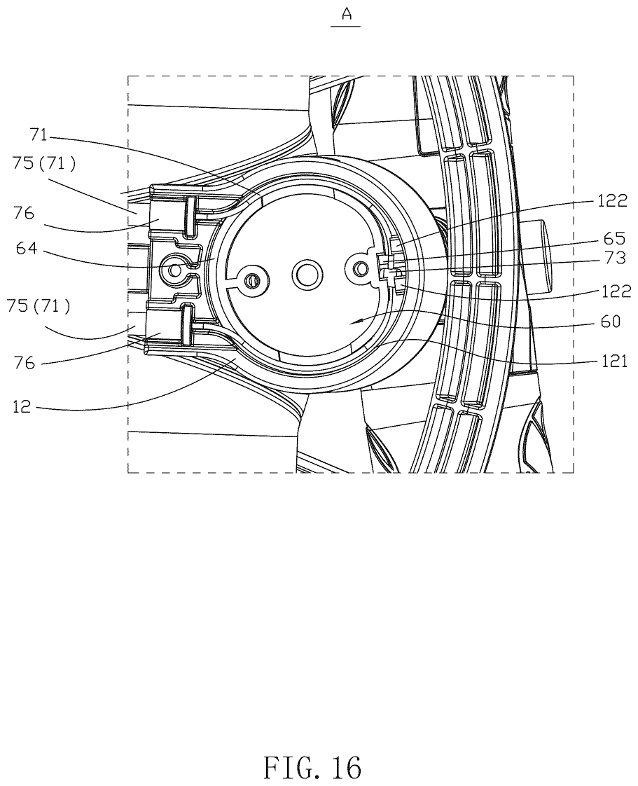

Referring to FIG. 16, correspondingly, the push rod 60 (e.g., the bottom end surface or side surface) is further provided with the second positioning structure. The second positioning structure is, for example, an annular mounting groove 64 and an intermediate engaging groove 65 located in the annular mounting groove 64. The annular mounting groove 64 is adapted to mount the two-way traction cable 71, and the intermediate engaging groove 65 is adapted to be engaged with the intermediate coupling protrusion 73. In at least one embodiment according to the present disclosure, a depth of the intermediate engaging groove 65 is greater than that of the annular mounting groove 64, and/or a width of the intermediate engaging groove 65 is greater than that of the annular mounting groove 64.

However, the present disclosure is not limited thereto. For example, the two-way traction cable 71 may alternatively be mounted reversely. That is, the push rod 60 is further provided with a mounting groove 323 and end engaging grooves 324 located at two ends of the mounting groove 323. The mounting groove 323 is adapted to mount the two-way traction cable 71, and the end engaging grooves 324 are adapted to be engaged with the end coupling protrusions 72 and 74. In at least one embodiment according to the present disclosure, a depth of each of the end engaging grooves 324 is greater than that of the mounting groove 323, and/or a width of each of the end engaging grooves 324 is greater than that of the mounting groove 323.

Correspondingly, the rotating base 322 is further provided with an annular mounting groove 64 and an intermediate engaging groove 65 located in the annular mounting groove 64. The annular mounting groove 64 is adapted to mount the two-way traction cable 71, and the intermediate engaging groove 65 is adapted to be engaged with the intermediate coupling protrusion 73. In at least one embodiment according to the present disclosure, a depth of each of the intermediate engaging groove 65 is greater than that of the annular mounting groove 64, and/or a width of each of the intermediate engaging groove 65 is greater than that of the annular mounting groove 64.

In the above embodiments, a manner in which the two-way traction cable 71 is connected to the front fork 32 and the push rod 60 is described with an engagement structure, but the present disclosure is not limited thereto. For example, the two-way traction cable 71 may be connected to the front fork 32 and the push rod 60 in various other fixed or detachable connection manners such as screw connection, welding, riveting, and dovetail connection, as long as the connections can ensure that rotation of the push rod 60 can drive the steering of the front wheel assembly 30 through the two-way traction cable 71, all of which may be considered to fall within the scope of the present disclosure.

Since the two-way traction cable 71 of the traction assembly 70 may produce stress on a component in contact therewith during the traction operation, in order to eliminate the stress, in at least one embodiment according to the present disclosure, as shown in FIG. 15 to FIG. 17, the traction assembly 70 may further include a sheath 75 and at least one protective clamp 76. The sheath 75 wraps a part of the two-way traction cable 71 other than a part connected to the push rod 60 and the front fork 32. The at least one protective clamp 76 is arranged on an end portion of the sheath and clamped in the first connecting member 11 and/or the second connecting member 12.

In addition, as shown in FIG. 16, the second connecting member 12 has a through hole 121 for accommodating the push rod 60, and a pair of spaced snap protrusions 122 are arranged at a bottom end of the through hole 121 to constrain a bottom end of the push rod 60, especially for preventing accidental detachment of the two-way traction cable 71, the intermediate coupling protrusion 73 or the end coupling protrusions 72 and 74 from the push rod 60. The first cover plate 131 and the second cover plate 132 above may further prevent accidental falling of the two-way traction cable 71.

In addition, in at least one embodiment according to the present disclosure, the fork arm 321 of the front fork 32 may include a body part (as shown in FIG. 14) and a housing (in FIG. 14, the housing has been removed) coupled to the body part. Therefore, a space may be defined between the body part and the housing of the fork arm 321 for accommodating electricity-related devices, such as an electric wire 501, a rectifier 530, a USB interface, a switch device, a battery, and a charging port that will be described in detail below. In addition, if necessary, in at least one embodiment according to the present disclosure, a cavity may alternatively be formed at the bottom of the rotating base 322 for alternatively or further accommodating the electric wire 501, the rectifier 530, the USB interface, the switch device, the battery, and the charging port that will be described in detail below.

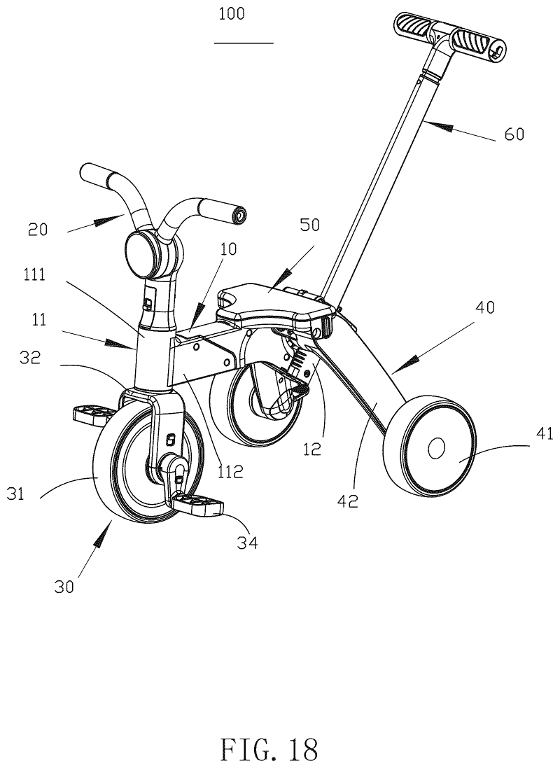

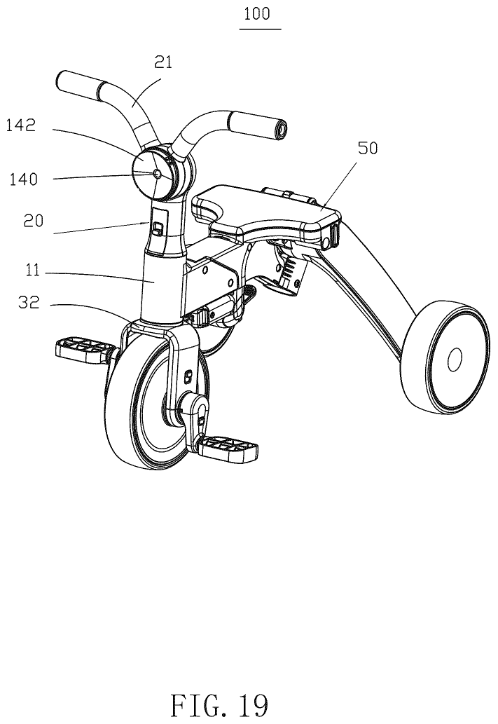

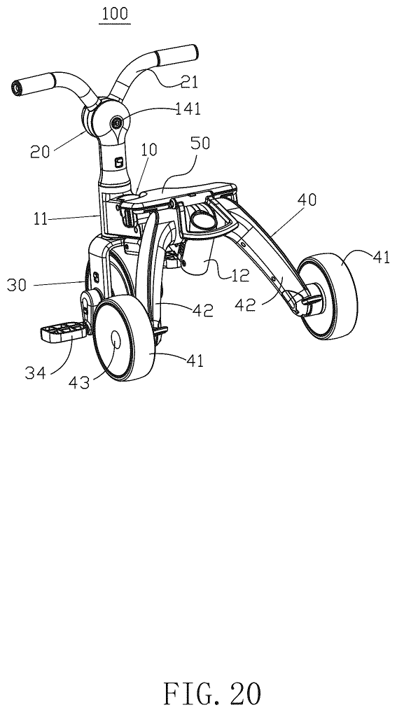

As shown in FIG. 18 to FIG. 21, the child carrier 100 includes a light-emitting device 140. The light-emitting device 140 may be used as a lighting lamp of the child carrier 100 to provide illumination for the child to play at night. The light-emitting device 140 and a switch 141 for the light-emitting device 140 (see FIG. 19 and FIG. 20) are respectively located on a front side and a rear side of the leading assembly 20. More specifically, the light-emitting device 140 and the switch 141 may be arranged at an intersection of two handlebars 211 of the leading assembly 20. In addition, as shown in FIG. 19, a reflective sheet 142 that reflects light from the light-emitting device 140 may be arranged around the light-emitting device 140. The light-emitting device 140 may be, for example, an LED lamp. The reflective sheet 142 may be, for example, a chrome-plated reflective sheet.

In addition, the child carrier 100 may be further provided with an electronic sound-generating module (not shown) and/or a rechargeable battery (not shown). Correspondingly, the child carrier 100 may be further provided with a switch (not shown) that controls the electronic sound-generating module and a charging port (not shown) connected to the rechargeable battery. Optionally, the child carrier 100 may be further provided with a primary battery (not shown) instead of a rechargeable battery, or may be provided with both a primary battery and a rechargeable battery. The light-emitting device 140 and the electronic sound-generating module may be electrically connected to the primary battery and/or the rechargeable battery to add lighting and sound functions to the child carrier 100, thereby increasing functionality and entertainment of the child carrier 100.

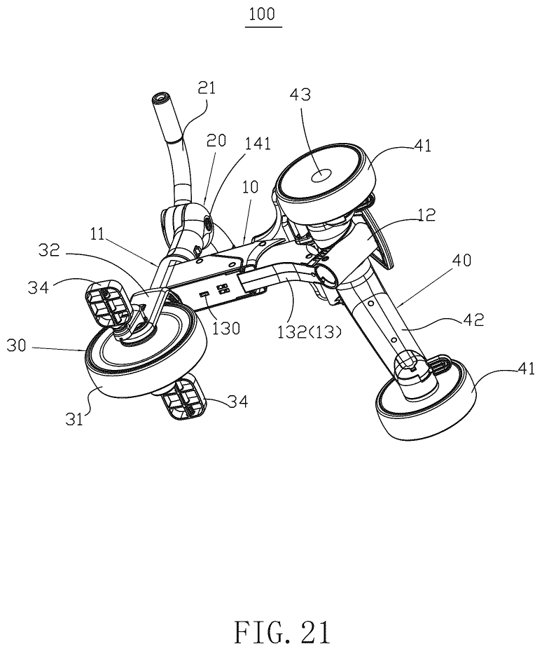

In addition, referring to FIG. 21, in at least one embodiment according to the present disclosure, the child carrier 100 may be further provided with a USB interface 130. The USB interface 130 may be electrically connected to the primary battery and/or the rechargeable battery. As an example, the USB interface 130 may be arranged on a bottom side of the frame body 10. In addition, as shown in FIG. 21, the USB interface 130 may be provided with an openable seal cover to prevent contamination of the USB interface 130 by dust, rainwater, and the like.

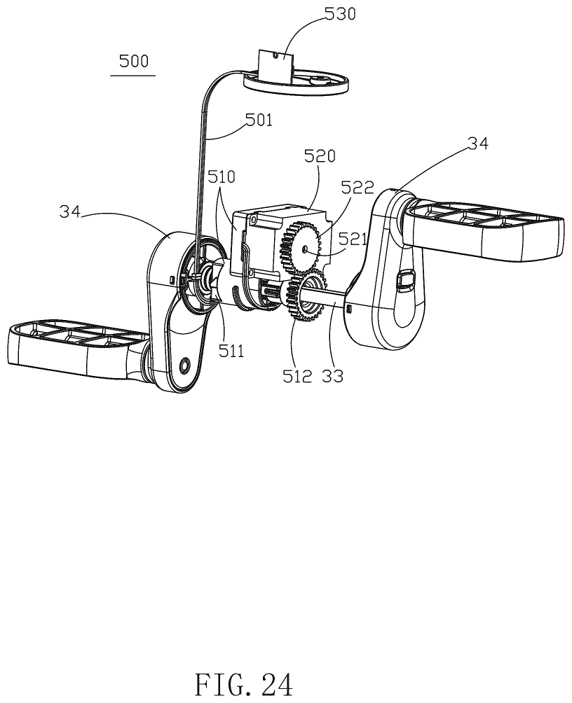

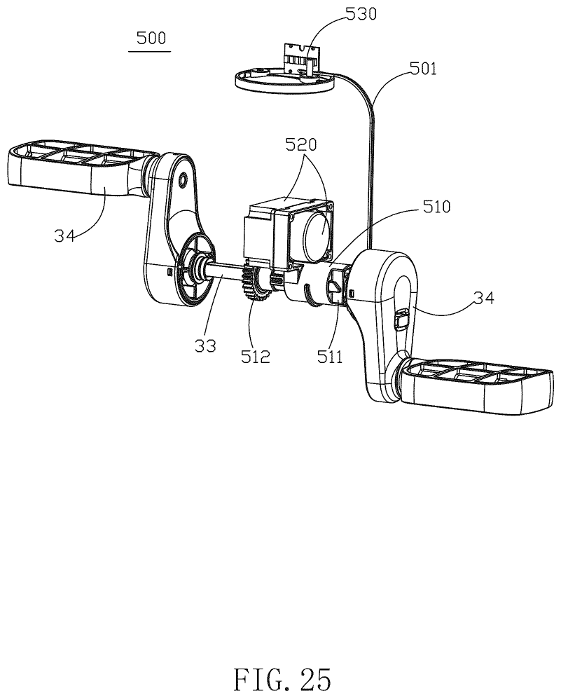

As shown in FIG. 24 to FIG. 25, in at least one embodiment according to the present disclosure, the child carrier 100 may further include at least one power generation assembly 500 mounted in at least one of the front wheel 31 and the rear wheel 41. The power generation assembly 500 generates power through the rotation of the wheel. The power may be converted into a direct current by the rectifier 530 (see FIG. 24 and FIG. 25) to power at least one of the light-emitting device 140, the electronic sound-generating module, the rechargeable battery, and the USB interface 130 mentioned above. The power generation assembly 500 according to at least one embodiment of the present disclosure and the child carrier 100 having the power generation assembly will be described in detail below.

In at least one embodiment according to the present disclosure, the child carrier 100 further includes at least one power generation assembly 500 mounted in at least one of the front wheel 31 and the rear wheel 41. The power generation assembly 500 may have a rectifier 530 to transmit, through the rectifier 530, power generated by the power generation assembly 500 to at least one of the light-emitting device 140, the electronic sound-generating module, the rechargeable battery, and the USB interface 130 mentioned above. In the case of more than one power generation assembly 500, two or more power generation assemblies 500 may share one rectifier, or may have respective rectifiers. The rectifier 530 rectifies and filters an alternating current generated by the power generation assembly 500 to form a stable direct current to be supplied to loads such as the light-emitting device 140, the electronic sound-generating module, and the USB interface 130. In addition to converting the alternating current to the direct current, the rectifier 530 may also be configured to transmit the power generated by the power generation assembly 500 to the rechargeable battery, providing a stable charging voltage for the rechargeable battery, thereby serving as a charger. The rectifier 530 may assist in detecting radio signals and the like. For example, the rectifier 530 may assist in receiving remote control signals for controlling the light-emitting module and the sound-generating module of the child carrier 100.

Referring to FIG. 24 to FIG. 25, the power generation assembly 500 may be mounted in the front wheel 31, and may include: a supporting member 510 mounted on the front axle 33 of the front wheel 31 and having an extending end 511 extending from the front wheel 31 along an extension direction of the front axle 33. The extending end 511 is fixed to a lower end of the front fork 32. The power generation assembly 500 includes a generator assembly 520, a drive gear 522, and a transmission gear 512. The generator assembly 520 is mounted on the supporting member 510 and has an input shaft 521. In an embodiment, the generator assembly 520 may include a generator and a reducer. The generator may be a micro-generator, and the reducer is axially connected to the micro-generator. Through transmission cooperation between the drive gear 522 and the reducer, the micro generator is driven to rotate and generate power. Specifically, the drive gear 522 is mounted on the input shaft 521, and the transmission gear 512 is mounted on the front axle 33 and configured to rotate with rotation of the front axle 33 to cause the drive gear 522 to rotate and generate power.

Similarly, the power generation assembly 500 may alternatively be mounted in the rear wheel 41, and may include a supporting member 510. The supporting member 510 is mounted on the rear axle 43 of the rear wheel 41 and has an extending end 511 extending from the rear wheel 41 along an extension direction of the rear axle 43. The extending end 511 is fixed and supported by the lower end of the rear wheel stand 42. The power generation assembly 500 further includes a generator assembly 520, a drive gear 522, and a transmission gear 512. The generator assembly 520 is mounted on the supporting member 510 and has an input shaft 521. The drive gear 522 is mounted on the input shaft 521, and the transmission gear 512 is mounted on the rear axle 43 and configured to rotate with rotation of the rear axle 43 to cause the drive gear 522 to rotate and generate power.

In this embodiment, the drive gear 522 and the transmission gear 512 are engaged with each other. A transmission ratio of the transmission gear 512 to the drive gear 522 may be 1:1. However, the present disclosure is not limited thereto. According to a size of an internal space of the wheel on which the power generation assembly 500 is mounted and/or a specification of the power generation assembly 500, the transmission ratio of the transmission gear 512 to the drive gear 522 may alternatively be greater than 1:1 or less than 1:1.

The rectifier 530 is electrically connected to the generator assembly 520 through the electric wire 501 to output a direct current. The rectifier 530 may be arranged in the wheel or arranged in the leading assembly 20 or in a corresponding cavity in the front fork 32 or in a cavity defined in the rear wheel stand 42, to reduce vibration and facilitate transmission of the power generated by the power generation assembly 500 to at least one of the light-emitting device 140, the electronic sound-generating module, the battery (e.g., the rechargeable battery), and the USB interface 130 mentioned above through the rectifier 530. In addition, the electricity-related devices may alternatively be mounted in the frame body 10. For example, the electricity-related devices may be supported and/or covered by the first connecting member 11 mentioned above or other similar connecting members.

As shown in FIG. 1 to FIG. 9 and FIG. 18 to FIG. 25, the front wheel assembly 30 may have a pedal device 34. When the power generation assembly 500 is arranged in the front wheel 31, when the child rides using the pedal device 34, the front axle 33 and the front wheel 31 may be driven to rotate. In this case, the generator assembly 520 may generate power under the driving of the transmission gear 512 and the drive gear 522. In addition, when the caregiver pushes, by pushing the push rod 60, the child carrier 100 and the front wheel 31 rotates, the front axle 33 may also be driven to rotate, so that the generator assembly 520 generates power.

Similarly, the power may alternatively be generated by hand turning the pedal device 34 in situ or by rotating the wheel in which the power generation assembly is mounted or by pushing the child carrier 100. If necessary, the power generation assembly 500 may also be provided with a corresponding control switch or clutch to stop unnecessary power generation or power supply. In addition, the generator assembly 520 is mounted in the front wheel and/or the rear wheel, the addition of the power generation assembly 500 may not affect the overall appearance of the child carrier 100, and most of the sound generated when the power generation assembly 500 is operating is isolated or absorbed. The resulting noise pollution is low.

The child carrier according to an embodiment of the present disclosure has a simple traction structure, and control flexibility of the leading assembly 20 is enhanced. When the unlocking assembly is at the unlock position, the leading assembly 20 and the front wheel assembly 30 can rotate separately, which helps the user save effort in pushing and improves the child's manipulation experience of the child carrier.

In addition, according to the child carrier provided in an embodiment of the present disclosure, since the wheel is provided with the power generation assembly, self-driven power generation can be achieved through wheel rotation regardless of whether the child carrier is pushed by the user or ridden by the child, or even the wheel is rotated by pedaling in situ or hand turning, and the generated power may be used for lighting, battery charging, USB charging, electronic sound generation, and the like, which expands the functionality of the child carrier. Since a main noise-generating device (i.e., the generator assembly) of the power generation assembly is mounted in the wheel, the child carrier with the power generation assembly according to the present disclosure has low power generation noise and is more suitable for use by children.

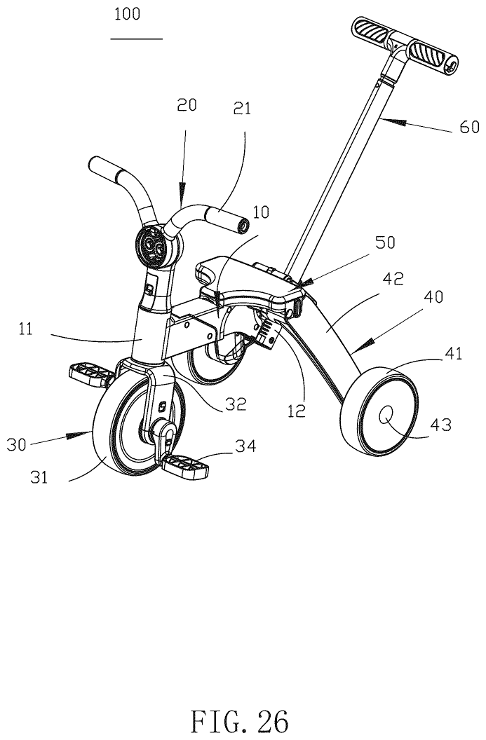

FIG. 26 to FIG. 29 schematically show a child carrier 100 according to a second embodiment of the present disclosure. The child carrier 100 in this embodiment includes a frame body 10, a leading assembly 20, a front wheel assembly 30, a rear wheel assembly 40, a seat 50, a push rod 60, and a power generation assembly 500. The frame body 10, the leading assembly 20, the rear wheel assembly 40, the seat 50, and the push rod 60 in this embodiment all have a same structure and connection relationship as the frame body 10, the leading assembly 20, the rear wheel assembly 40, the seat 50, and the push rod 60 in the first embodiment, and a main difference lies in specific structures of the front wheel assembly 30 and the power generation assembly 500.

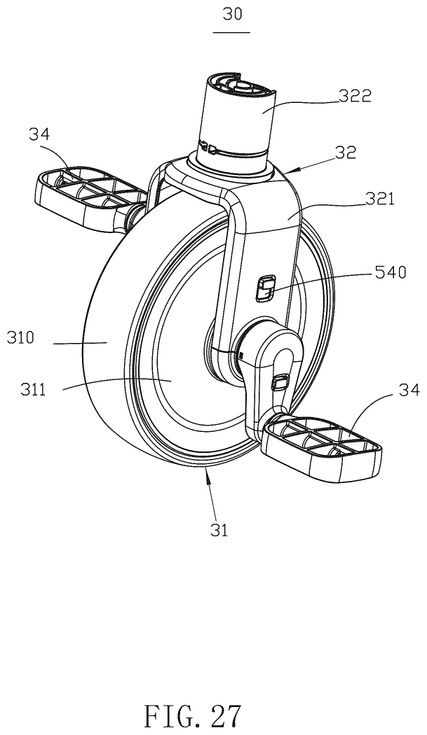

As shown in FIG. 26 to FIG. 27, the front wheel assembly 30 has a front wheel 31 and a front fork 32. In an embodiment according to the present disclosure, the front fork 32 is coaxially connected to the leading assembly 20 and configured to be selectively fixedly connected or rotatably connected to the leading assembly 20. The leading assembly 20 and the front wheel assembly 30 are rotatably connected to a first connecting member 11 fixedly connected to the frame body 10. Therefore, the leading assembly 20 and the front wheel assembly 30 are connected to the frame body 10 through the first connecting member 11 in a manner of synchronous or separate rotation. When the front wheel assembly 30 is pushed or ridden forward or backward, the first connecting member 11 drives the frame body 10 and the rear wheel assembly 40 to move forward or backward together.

As shown in FIG. 27 to FIG. 30, the front fork 32 further includes a pair of fork arms 321 and a rotating base 322 connected between the pair of fork arms 321. The pair of fork arms 321, i.e., a first fork arm 3211 and a second fork arm 3212, is configured to be coupled to two opposite sides of the front wheel 31 respectively. The rotating base 322 is configured to be located between the pair of fork arms 321 and selectively rotatably connected or fixedly connected to the leading assembly 20. The pair of fork arms 321 may be formed separately, or may be formed integrally.

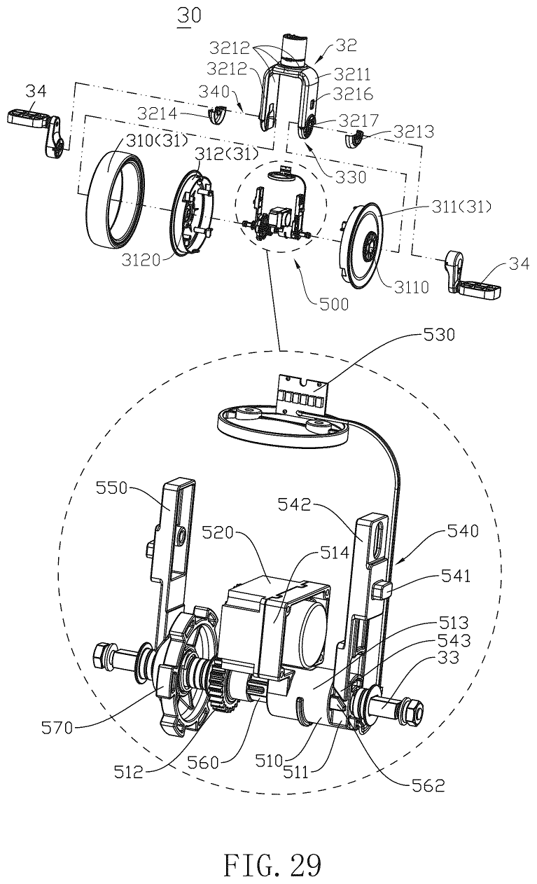

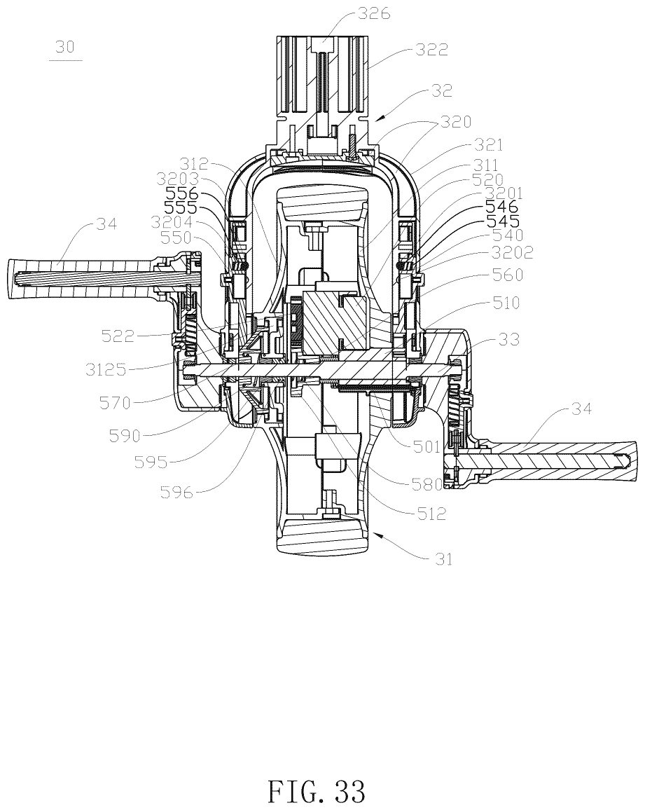

Referring to FIG. 29 and FIG. 33, in an embodiment, an internal space 320 is formed in each of the first fork arm 3211 and the second fork arm 3212. For example, the first fork arm 3211 includes a first fork arm body and a first fork arm housing to form the internal space 320 between the first fork arm body and the first fork arm housing. The second fork arm 3212 includes a second fork arm body and a second fork arm housing to form the internal space 320 between the second fork arm body and the second fork arm housing. The first fork arm body and the second fork arm body may be formed separately and connected to each other, or may be integrally formed as a fork arm body 3210. Similarly, the first fork arm housing and the second fork arm housing may also be formed separately and connected to the fork arm body 3210 or respectively connected to the first fork arm body and the second fork arm body to form the first fork arm 3211 and the second fork arm 3212. Alternatively, the first fork arm housing and the second fork arm housing may be integrally formed and connected to the fork arm body 3210 to simultaneously form the first fork arm 3211 and the second fork arm 3212.

As shown in FIG. 33, the rotating base 322 is arranged between the pair of fork arms 321, with an internal space 320 further formed at the bottom thereof. The internal space 320 may be in communication with or not in communication with the internal spaces 320 formed in the first fork arm 3211 and the second fork arm 3212.

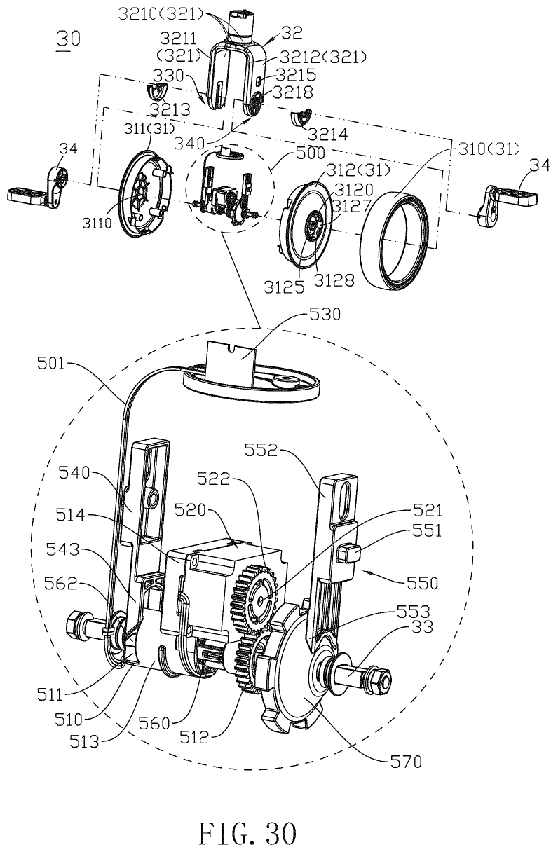

Referring to FIG. 29 and FIG. 30, the internal spaces 320 formed in the first fork arm 3211 and the second fork arm 3212 are respectively configured to accommodate a first operating member 540 and a second operating member 550 described in detail below. The first fork arm housing and the second fork arm housing configured to form the aforementioned internal spaces 320 are respectively provided with a first opening 3216 and a second opening 3215, so that a first operating button 541 of the first operating member 540 and a second operating button 551 of the second operating member 550 are exposed for the user to operate.

More specifically, referring to FIG. 29 and FIG. 30, the first operating member 540 includes a first body part 542, and the first body part 542 vertically extends and a lower end 543 thereof is configured to clamp the supporting member 510. The supporting member 510 configured to support the generator assembly 520 will be described in more detail below. The first operating button 541 is arranged on the first body part 542 and exposed through the first opening 3216. In this embodiment, the first operating button 541 may protrude from an outer surface of the first fork arm 3211. Similarly, as shown in FIG. 30, the second operating member 550 includes a second body part 552 vertically extending and a lower end 553 thereof is configured to contact and push a second driving component 570. The second driving component 570 will be described in more detail below. The second operating button 551 is arranged on the second body part 552 and exposed through the second opening 3215. In this embodiment, the second operating button 551 protrudes from the outer surface of the second fork arm 3212 through the second opening 3215.

The first fork arm 3211 and the second fork arm 3212 are respectively provided with a first axle hole 3217 and a second axle hole 3218 opposite to each other and used for insertion of the front axle 33. More specifically, a lower end of the first fork arm body and a lower end of the second fork arm body may be respectively provided with a first clamping groove 330 and a second clamping groove 340. In addition, the first fork arm housing may include a first upper housing coupled to a part of the first fork arm body above the first axle hole 3217 and a first lower housing 3213 coupled to a part of the first fork arm body below the first axle hole 3217. Similarly, the second fork arm housing may include a second upper housing coupled to a part of the second fork arm body above the second axle hole 3218 and a second lower housing 3214 coupled to a part of the second fork arm body below the second axle hole 3218.

When the first lower housing 3213 and the second lower housing 3214 are not assembled, two sides of the front axle 33 may be respectively coupled to the first axle hole 3217 and the second axle hole 3218 or disassembled from the first axle hole 3217 and the second axle hole 3218 through the first clamping groove 330 and the second clamping groove 340. In at least one embodiment according to the present disclosure, the two sides of the front axle 33 may be machined to have opposite flat surfaces, so that a minimum radial dimension thereof can be smaller or slightly smaller than widths of the first clamping groove 330 and the second clamping groove 340. After the front axle 33 is mounted in the first axle hole 3217 and the second axle hole 3218, the mounting of the front fork 32 and the front wheel 31 may be completed by mounting the first lower housing 3213 and the second lower housing 3214 to the first fork arm body and the second fork arm body respectively.

In addition, in at least one embodiment according to the present disclosure, the front wheel assembly 30 further includes a pair of pedal devices 34 respectively mounted to outer sides of the first fork arm 3211 and the second fork arm 3212 and firmly connected to two ends of the front axle 33. When the child sitting on the child carrier 100 presses the pair of pedal devices 34 with two feet, the front axle 33 and the pedal devices 34 rotate synchronously.

According to at least one embodiment of the present disclosure, the generator assembly 520 of the power generation assembly 500 is mounted in the front wheel assembly 30. However, in other embodiments, the generator assembly 520 of the power generation assembly 500 may alternatively be mounted in the rear wheel assembly 40. Referring to FIG. 29 to FIG. 32, the front wheel assembly 30 with the generator assembly 520 will be described in detail.

As shown in FIG. 29 and FIG. 30, the front wheel 31 has a rim 310 and a hub mounted on the front axle 33 to support the rim 310. In this embodiment, the hub may include a first hub 311 and a second hub 312 connected to each other. The generator assembly 520 and the supporting member 510 thereof are mounted in the front wheel 31 and are configured to be rotatably supported by the front axle 33 and selectively receive torque from the front axle 33. The supporting member 510 fixedly supports the generator assembly 520, and is configured to be fixedly supported relative to the first fork arm 3211 and rotatably supported relative to the front axle 33. In the present disclosure, “rotatably supported” means that the supported member rotates asynchronously with the supporting member, or the supported member cannot be driven by the supporting member to rotate while the supporting member rotates.

Referring to FIG. 29, the supporting member 510 has a support body part 513 and a generator mounting portion 514 extending radially from the support body part 513. The generator assembly 520 is mounted on the generator mounting portion 514. The support body part 513 is mounted on the front axle 33 and abuts against an inner side of the first hub 311. The supporting member 510 further includes an extending end 511 connected to the support body part 513. The extending end 511 of the supporting member 510 may extend out of the first hub 311, and be clamped by the first operating member 540 to prevent rotation of the supporting member 510. The extending end 511 is machined to have a flat surface or a pair of flat surfaces parallel to each other, so as to be clamped by the lower end 543 of the first operating member 540 mounted in the first fork arm 3211.

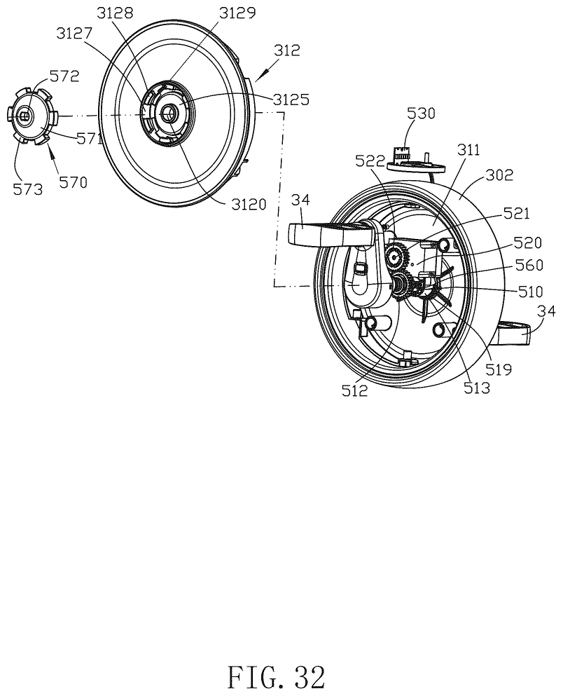

Referring to FIG. 32, more specifically, a radially protruding limiting rib 519 is formed on an outer peripheral surface of the support body part 513. The limiting rib 519 abuts against an inner side of the first hub 311. Therefore, the supporting member 510 is relatively fixed relative to the first fork arm 3211, and the generator assembly 520 may be fixed relative to the front fork 32 without rotating along with the rotation of the front wheel 31 and the front axle 33. In order to achieve the above “rotatably supported”, the front axle 33 and the supporting member 510 are configured to be in clearance fit, and the first hub 311 and the supporting member 510 are configured to be in clearance fit.

Still referring to FIG. 29 to FIG. 32, the front wheel assembly 30 further includes a transmission gear 512 slidably mounted on the front axle 33 and rotating synchronously with the front axle 33. Correspondingly, the generator assembly 520 further includes an input shaft 521 and a drive gear 522 selectively engaged with the transmission gear 512. The drive gear 522 is mounted on the input shaft 521 and may be configured to selectively receive torque from the transmission gear 512 and the front axle 33. In at least one embodiment of the present disclosure, the generator assembly 520 includes a generator and a reducer. The generator may be a micro-generator, and the reducer is axially connected to the micro-generator. Through transmission cooperation between the drive gear 522 and the reducer, the micro generator is driven to rotate and generate power.

To this end, as shown in FIG. 29 to FIG. 32, in at least one embodiment according to the present disclosure, the front wheel assembly 30 further includes a first driving component 560 and the aforementioned first operating member 540 in direct or indirect connection or contact with the first driving component 560. The first driving component 560 is slidably arranged on the front axle 33 and rotates synchronously with the front axle 33. In at least one embodiment of the present disclosure, one part of the first driving component 560 is arranged between the supporting member 510 and the transmission gear 512, the other part of the first driving component 560 is formed as a rod-shaped portion 562, and the rod-shaped portion 562 may pass through the supporting member 510 and contact the first operating member 540. The first driving component 560 is configured to be disengaged from the drive gear 522 by driving the transmission gear 512 to slide. More specifically, the extending end 511 of the supporting member 510 is machined to have a pair of parallel flat surfaces or to have a flat surface. The rod-shaped portion 562 passes through the support body part 513 of the supporting member 510 and extends out along the flat surface of the extending end 511, and a tail end of the rod-shaped portion 562 is formed as a slope. The lower end 543 of the first operating member 540 vertically arranged is also formed as a slope. When the first operating member 540 slides downwards relative to the first fork arm 3211 by operating the first operating button 541 on the first operating member 540, the first driving component 560 can be pushed by resistance between the slopes to squeeze the transmission gear 512 to disengage the transmission gear 512 from the drive gear 522. In this way, the generator assembly 520 no longer receives torque from the rotating front axle 33, so that a power generation function of the generator assembly 520 is disabled.

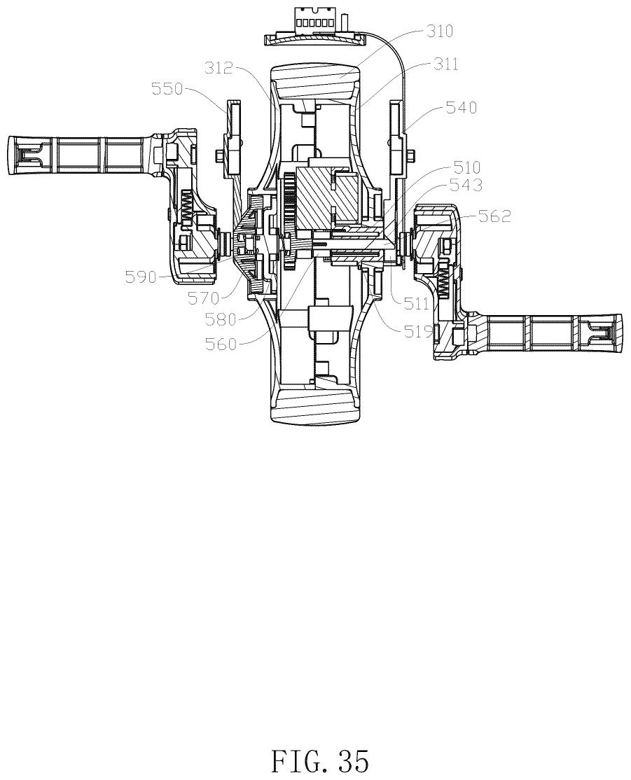

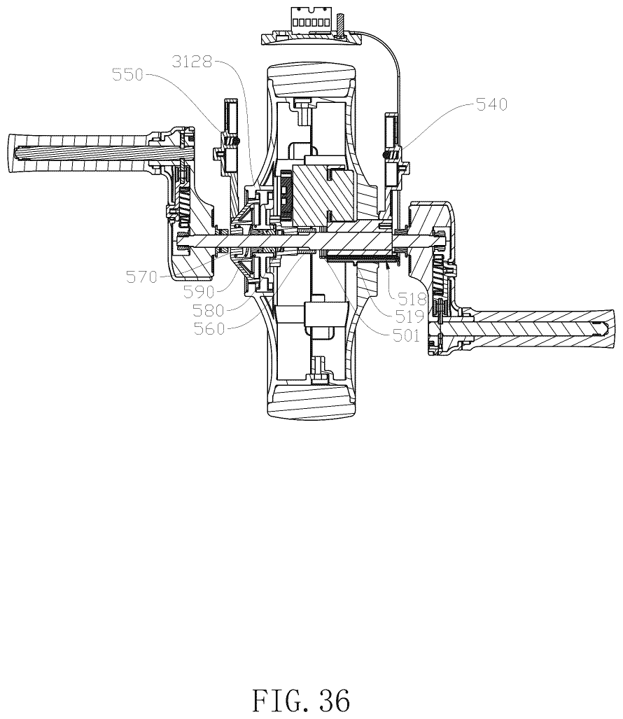

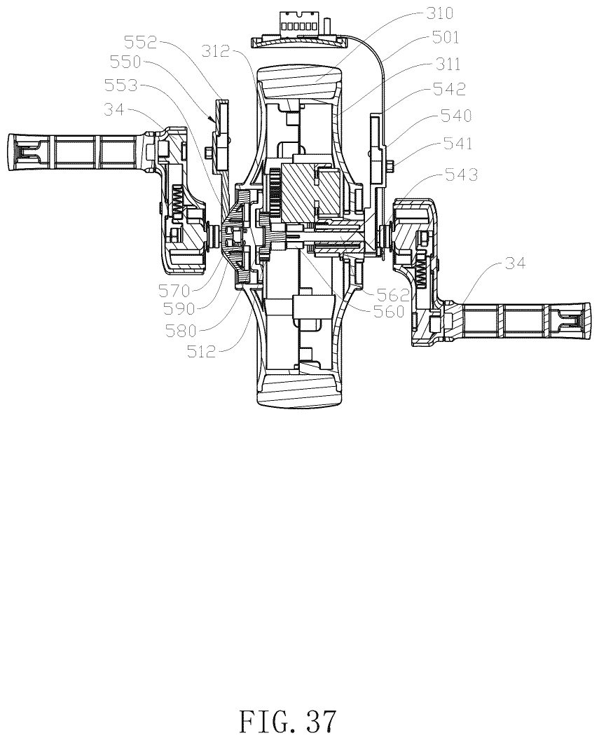

Referring to FIG. 33 to FIG. 38, the front wheel assembly 30 further includes a first elastic member 580 arranged between the second hub 312 and the first driving component 560. FIG. 33 to FIG. 35 show that the first operating member 540 is at a first position, in which case the first elastic member 580 is in a normal state, and the first driving component 560 enables the transmission gear 512 to transmit the torque generated by the rotation of the front axle 33 to the generator assembly 520. FIG. 36 and FIG. 37 show that the first operating member 540 is at a second position, in which case the first elastic member 580 is in a compressed state, and the first driving component 560 makes the transmission gear 512 not engaged with the drive gear 522, so that the torque generated by the rotation of the front axle 33 cannot be transmitted to the generator assembly 520.

When the first operating member 540 moves from the second position to the first position, the compressed first elastic member 580 drives the first driving component 560 to move towards the first hub 311, so that the transmission gear 512 is engaged again with the drive gear 522, and when the front axle 33 rotates, the transmission gear 512 transmits the torque generated by the rotation of the front axle 33 to the generator assembly 520 for power generation. A transmission ratio of the transmission gear 512 to the drive gear 522 may be 1:1. However, the present disclosure is not limited thereto. According to a size of the internal space of the wheel on which the power generation assembly 500 is mounted and/or the specification of the power generation assembly 500, the transmission ratio of the transmission gear 512 to the drive gear 522 may be greater than 1:1 or less than 1:1.

Although a clutch function of the generator is introduced in the above embodiments by taking the first driving component 560 having the rod-shaped portion 562 as an example, those skilled in the art should understand that the structure of the first driving component 560 is not limited thereto, which may have other suitable structures. For example, the rod-shaped portion 562 may be formed separately from the first driving component 560. For example, the tail end of the rod-shaped portion 562 may be formed as a curved surface. Correspondingly, the lower end 543 of the first operating member 540 may also be formed as a curved surface. That is, at least one of the tail end of the rod-shaped portion 562 and the lower end 543 of the first operating member 540 is formed as an inclined slope or a curved surface, so that the lower end 543 of the first operating member 540 can push the first driving component 560 to push the transmission gear 512 along the front axle 33 to be disengaged from the drive gear 522.

In addition, although the first operating member 540 and the first driving component 560 are in direct contact in the above embodiments, the present disclosure is not limited thereto. For example, the first operating member 540 can indirectly control the sliding of the first driving component 560 on the front axle 33 through a traction cable, a spring member, or the like. In addition, although the torque generated by the front axle 33 is selectively transmitted to the generator assembly 520 by changing an axial position of the transmission gear 512 through the first driving component 560 in the above embodiments of the present disclosure, the present disclosure is not limited thereto. For example, a driving component may be arranged between the generator assembly 520 and the supporting member 510 to change an axial and/or radial position of the drive gear 522 relative to the front axle 33, so as to selectively transmit the torque generated by the front axle 33 to the generator assembly 520. That is, the generator assembly 520 may be slidably mounted on the generator mounting portion 514 and configured to be axially and/or radially moveable relative to the front axle 33 to cause the drive gear 522 to be engaged with or disengaged from the transmission gear 512. In the above description, the first elastic member 580 is described as being arranged between the second hub 312 and the first driving component 560, the present disclosure is not limited thereto.

For example, as shown in FIG. 33 to FIG. 38, the front wheel assembly 30 may further include a first axle sleeve 596 fixed to the front axle 33 to rotatably support the second hub 312 and axially abut against an inner side of the second hub 312. The first elastic member 580 may be arranged between the transmission gear 512 and the first axle sleeve 596 to apply an elastic force to the transmission gear 512. The second hub 312 is rotatably supported by the first axle sleeve 596, which means that the second hub 312 cannot receive torque from the front axle 33 through the first axle sleeve 596.

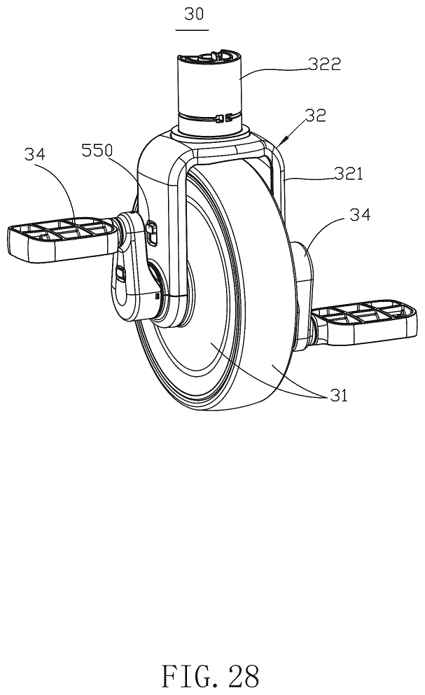

A front wheel drive clutch mechanism according to at least one embodiment of the present disclosure will be described in more detail below with reference to FIG. 28 to FIG. 38.

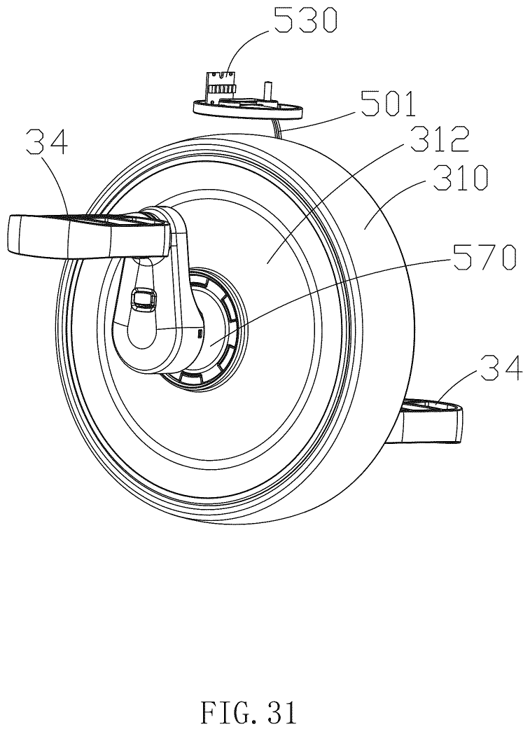

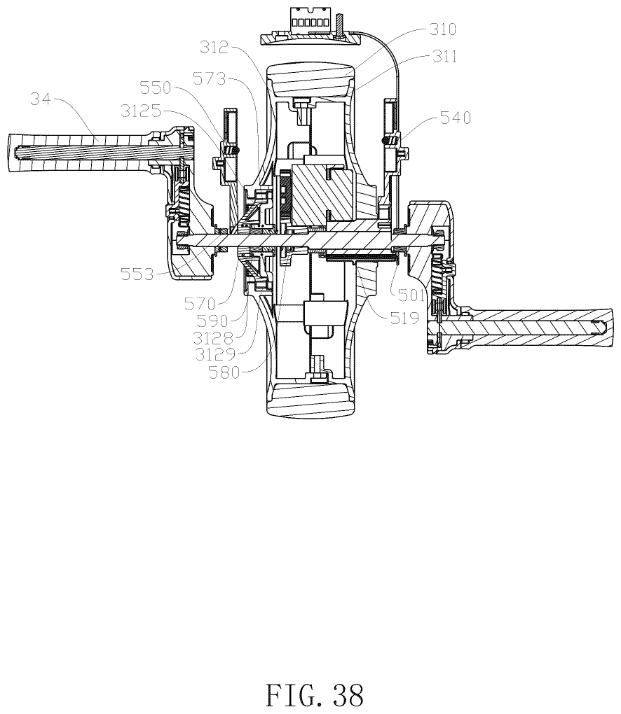

As shown in FIG. 29 to FIG. 32, the second hub 312 may be configured to selectively receive torque from the front axle 33 through the second operating member 550 and the second driving component 570 and transmit torque generated when the front wheel 31 rotates to the front axle 33. In at least one embodiment according to the present disclosure, as shown in FIG. 33 to FIG. 38, the second driving component 570 is slidably arranged on the front axle 33 and rotates synchronously with the front axle 33. The lower end 553 of the second operating member 550 remains in contact with the second driving component 570 and moves between a third position and a fourth position to enable the second driving component 570 to slide along the front axle 33. When the second operating member 550 is at the third position, as shown in FIG. 31 and FIG. 33 to FIG. 37, the second driving component 570 is engaged with the second hub 312 to transmit torque between the front wheel 31 and the front axle 33. When the second operating member 550 is at the fourth position, as shown in FIG. 38, the second driving component 570 is disengaged from the second hub 312, so as not to transmit torque between the front wheel 31 (i.e., the second hub 312) and the front axle 33.

A front wheel drive clutch function is added to the front wheel assembly 30 by selectively transmitting the torque between the front wheel 31 and the front axle 33, which increases a use mode and functionality of the child carrier having the front wheel assembly 30. In a case where the second operating member 550 is at the fourth position, when the child carrier 100 is pushed, the front wheel 31 rotates but the front axle 33 does not rotate. In this case, it saves effort for the user to push. In addition, when the child pedals the pedal device 34, the torque can only be applied to the front axle 33. In this way, it is easy for the child to pedal without interfering with the user's pushing operation. In addition, if the first operating member 540 is at the second position, the generator assembly 520 may generate power. Therefore, when the child pedals the pedal device 34, the drive gear 522 of the generator assembly 520 and the front axle 33 rotate synchronously to generate power.

As shown in FIG. 30 to FIG. 33, the second operating member 550 is vertically arranged in the second fork arm 3212 and is capable of sliding up and down relative to the second fork arm 3212. The second operating member 550 is configured to push the second driving component 570 to slide along the front axle 33 to be disengaged from the second hub 312. As shown in FIG. 30 and FIG. 33, a contact surface between the second driving component 570 and the second operating member 550 is formed as a slope. However, the present disclosure is not limited thereto, and the contact surface between the second driving component 570 and the second operating member 550 may alternatively be formed as a curved surface. Those skilled in the art should understand that, as long as one contact surface between the second driving component 570 and the second operating member 550 is shaped as a slope or a curved surface, the second operating member 550 can be moved from the third position to the fourth position. As a result, the second driving component 570 moves to a position where it is disengaged from the second hub 312.

Specific structures of the second hub 312 and the second driving component 570 according to at least one embodiment of the present disclosure will be described in more detail below with reference to FIG. 31 to FIG. 33.

The second driving component 570 includes a body part 571 in a frustoconical shape and a connecting hole 572 formed in the body part 571. The body part 571 is slidably connected to the front axle 33 through the connecting hole 572 so as to be capable of rotating synchronously with the front axle 33. As shown in FIG. 32, a hole wall of the connecting hole 572 is provided with a pair of opposite flat surfaces so as to be slidable relative to the front axle 33. The second driving component 570 further includes a plurality of engaging portions 573 extending radially outwards from the body part 571.

The second hub 312 has a central recessed part 3125 and a second central hole 3120 located in the center of the second hub 312. The second central hole 3120 may be inserted into and rotatably support a second axle sleeve 595 of the second hub 312, and the second axle sleeve 595 is slidably or fixedly connected to the front axle 33 to rotate synchronously with the front axle 33. To this end, the second axle sleeve 595 is in clearance fit with the second central hole 3120 of the second hub 312 so that the second axle sleeve 595 rotatably supports the second hub 312.

In addition, the second axle sleeve 595 is arranged in the central recessed part 3125 of the second hub 312 and is mounted close to one side of the second driving component 570. That is, the second axle sleeve 595 cannot transmit the torque from the second hub 312 to the front axle 33 or transmit the torque from the front axle 33 to the second hub, but is configured to rotatably support the second hub 312. In addition, the second axle sleeve 595 is mounted on the front axle 33 axially against the outer side of the second hub 312 and is opposite to the first axle sleeve 596. More specifically, the first axle sleeve 596 and the second axle sleeve 595 are respectively mounted against two sides of the central recessed part 3125. The second axle sleeve 595 may slide relative to the front axle 33 or be fixed to the front axle 33 by interference fit. The second elastic member 590 is axially arranged between the second axle sleeve 595 and the second driving component 570, so as to provide an elastic force for the second driving component 570.

A plurality of engaging portions 3128 are formed on a circumferential side wall of the central recessed part 3125, and slots 3127 are formed between adjacent engaging portions 3128. When the second driving component 570 is engaged with the second hub 312, the plurality of engaging portions 573 are placed between the corresponding slots 3127, so that the second driving component 570 can transmit torque between the front axle 33 and the second hub 312, so as to transmit the torque from the front axle 33 to the front wheel 31 or transmit the torque from the front wheel 31 to the front axle 33.

In addition, as shown in FIG. 32, the plurality of engaging portions 573 are axially spaced apart from a bottom side of the central recessed part 3125 (i.e., the side close to the second driving component 570), thereby forming an interval space 3129 for accommodating the second driving component 570. When the second operating button 551 is operated to move the second operating member 550 downwards from the third position to the fourth position, as shown in FIG. 38, the lower end 553 of the second operating member 550 pushes the second driving component 570 to move towards the first hub 311 and into the interval space 3129, so that the second driving component 570 is disengaged from the second hub 312. In this case, the second driving component 570 can rotate synchronously with the front axle 33 but does not transmit the torque between the second hub 312 (i.e., the front wheel 31) and the front axle 33.

When the second operating button 551 is operated to move the second operating member 550 upwards from the fourth position to the third position, the elastic force of the second elastic member 590 pushes the second driving component 570 to move towards the outer side of the second hub 312, so as to be engaged again with the second hub 312. In this case, the second driving component 570 can rotate synchronously with the front axle 33 and at the same time, transmit the torque between the second hub 312 (i.e., the front wheel 31) and the front axle 33.

It is clear from the above description that, by operating the second operating member 550 to change an axial position of the second driving component 570, the second driving component 570 is enabled to selectively transmit the torque between the front axle 33 and the front wheel 31. Therefore, the front wheel assembly 30 realizes the front wheel drive clutch function through the second operating member 550 and the second driving component 570, thereby increasing the use mode and functionality of the child carrier 100.

In the above embodiments, although the second hub 312 and the second driving component 570 are radially engaged through a plurality of engaging portions, the present disclosure is not limited thereto. For example, a quantity and a protruding direction of the engaging portions are not limited to the quantity and the direction shown in the drawings of the present disclosure. That is, the second driving component 570 may have at least one engaging portion protruding axially and/or radially, and the second hub 312 has at least one slot engaged with the at least one engaging portion. In some other embodiments, the second driving component 570 includes a body part 571 in a frustoconical shape and at least one slot formed on the body part and axially and/or radially recessed, and the second hub 312 has at least one engaging portion engaged with the at least one slot.

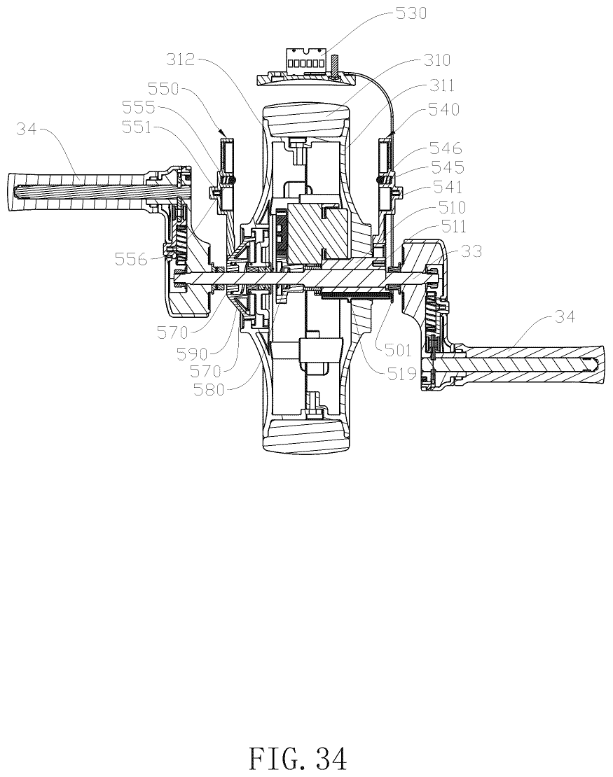

As can be seen from the above description, the first operating member 540 and the first driving component 560 resist each other, and the first driving component 560 is moved along the front axle 33 by moving the first operating member 540 between the first position and the second position and by means of the elastic force of the first elastic member 580, thereby selectively transmitting the torque generated by the front axle 33 to the generator assembly 520. In order to stably maintain the first operating member 540 at the first position or the second position, as shown in FIG. 34, the first operating member 540 further includes a first positioning assembly movably arranged between the first body part 542 and the first fork arm body to position the first operating member 540. In this embodiment, the first positioning assembly may include a first ball 546 and a first spring 545, and the first ball 546 and the first spring 545 are arranged in the first body part 542. As shown in FIG. 33, a corresponding first positioning concave portion 3201 and a corresponding second positioning concave portion 3202 are provided on the first fork arm body to receive part of the first ball 546. Alternatively, the first ball 546 and the first spring 545 may be arranged in the first fork arm body, and a corresponding first positioning concave portion 3201 and a corresponding second positioning concave portion 3202 are provided on the first body part 542 to receive part of the first ball 546.

As shown in FIG. 33, when the first ball 546 is accommodated in the first positioning concave portion 3201, the first operating member 540 is located at the first position. When the first ball 546 is accommodated in the second positioning concave portion 3202, the first operating member 540 is located at the second position. Depending on specific positions of the first positioning concave portion 3201 and the second positioning concave portion 3202, when the first ball 546 is accommodated in the first positioning concave portion 3201, the first operating member 540 may be located at the second position, and when the first ball 546 is accommodated in the second positioning concave portion 3202, the first operating member 540 may be located at the first position.

Similarly, in order to stably maintain the second operating member 550 at the third position or the fourth position, as shown in FIG. 34, the second operating member 550 further includes a second positioning assembly movably arranged between the second body part 552 and the second fork arm body to position the second operating member 550. As shown in FIG. 33, the second positioning assembly may include a second ball 556 and a second spring 555, and the second ball 556 and the second spring 555 are arranged in the second body part 552. The second fork arm body is provided with a corresponding third positioning recess 3203 and a corresponding fourth positioning recess 3204 to accommodate part of the second ball 556. Alternatively, the second ball 556 and the second spring 555 may be arranged in the second fork arm body, and a corresponding third positioning recess 3203 and a corresponding fourth positioning recess 3204 are provided on the second body part 552 to receive part of the second ball 556.

As shown in FIG. 33, when the second ball 556 is accommodated in the third positioning recess 3203, the second operating member 550 is located at the third position. When the second ball 556 is accommodated in the fourth positioning recess 3204, the second operating member 550 is located at the fourth position. Depending on specific positions of the third positioning recess 3203 and the fourth positioning recess 3204, when the second ball 556 is accommodated in the third positioning recess 3203, the second operating member 550 may be located at the fourth position. When the second ball 556 is accommodated in the fourth positioning recess 3204, the second operating member 550 is located at the third position.

Detailed arrangement of the power generation assembly 500 is described below with reference to FIG. 29 to FIG. 30, FIG. 33, FIG. 34, and FIG. 36.

In addition to the above generator assembly, similar to the first embodiment, the power generation assembly 500 further includes an electric wire 501 and a rectifier 530. In an embodiment according to the present disclosure, as shown in FIG. 30 and FIG. 34, the rectifier 530 may be mounted in the internal space 320, and more specifically located in the internal space 320 at the bottom of the rotating base 322 of the front fork 32.

In addition, the supporting member 510 is provided with a threading hole 518 (see FIG. 36) extending axially. Referring to FIG. 29 and FIG. 30 together, the electric wire 501 extending from the generator assembly 520 may extend into the first fork arm 3211 of the front fork 32 through the wiring hole 518. In order to prevent interference between the electric wire 501 and the first operating member 540, the electric wire 501 may be extended downwards or upwards to avoid the front axle 33, and the first operating member 540 and other movable components extend to the rectifier 530. Since the supporting member 510 is fixed relative to the front fork 32, when the front wheel 31 and/or the front axle rotate/rotates, the electric wire 501 may not cause any interference.

Similar to the first embodiment, the child carrier 100 may further include at least one of a rechargeable battery, a light-emitting module, a sound-generating module (not shown), and a USB interface (not shown) to be electrically connected to the above power generation assembly 500. The power generated by the generator assembly may be stored in the rechargeable battery after being rectified by the rectifier 530, or used for lighting, playing music, and external power supply through the USB interface. The light-emitting module may be used as a lighting lamp of the child carrier 100 to provide illumination for the child to play at night. For example, the light-emitting module may include a light-emitting device and a switch for the light-emitting device. The light-emitting device and the switch for the light-emitting device may be respectively mounted on a front side and a rear side of the leading assembly. The sound-generating module may include a sound-generating device and a switch for the sound-generating device. The light-emitting module and the sound-generating module (not shown) may be electrically connected to the rechargeable battery (not shown). Optionally, the child carrier 100 may be additionally provided with a primary battery (not shown) or may be alternatively provided with a primary battery without a rechargeable battery. The light-emitting module and the sound-generating module may be electrically connected to the primary battery and/or the rechargeable battery, and the USB interface may also be electrically connected to the primary battery and/or the rechargeable battery. The light-emitting module and the sound-generating module may add lighting and sound functions to the child carrier 100, thereby increasing functionality and entertainment of the child carrier 100. The USB interface provides a power emergency solution for the child carrier 100. For example, the USB interface may transmit power generated by the primary battery, the rechargeable battery or the power generation assembly to a device required to be charged, for example, the user's portable electronic product such as a mobile phone, a game console, or a PAD. In addition, when the child carrier 100 is provided with the sound-generating module, the USB interface may also provide a data transmission function.

In addition, in at least one embodiment according to the present disclosure, the generator assembly 520 may be arranged in at least one of the front wheel 31 and the rear wheel 41 of the child carrier 100. The generator assembly generates power through the rotation of axles of the front wheel 31 and the rear wheel 41 (i.e., the front axle 33 and the rear axle 43). The power may be converted into direct currents through one or more rectifiers 530 to power at least one of the light-emitting module, the sound-generating module, the rechargeable battery, and the USB interface respectively or together. As an example, the USB interface may be arranged on a bottom side of the frame body 10. In addition, the USB interface may be provided with an openable seal cover to prevent contamination of the USB interface by dust, rainwater, and the like.

As described above, in the case of more than one power generation assembly 500, two or more power generation assemblies 500 may share a rectifier or have respective rectifiers to rectify and filter an alternating current generated by the power generation assembly 500 to form a stable direct current to be supplied to loads such as the light-emitting module, the sound-generating module, and the USB interface. In addition, when there is no electrical load, the rectifier 530 may transmit the power generated by the power generation assembly 500 to the rechargeable battery and provide a stable charging voltage for the rechargeable battery, thereby serving as a charger.

In the above embodiments, the power generation assembly 500 is mounted in the front wheel assembly 30. However, the present disclosure is not limited thereto. That is, the generator assembly 520 and the electric wire 501 of the power generation assembly 500 may alternatively be mounted in the rear wheel 41. That is, in addition to the pedal assembly, the rear wheel assembly 40 may have a same structure and internal arrangement as the front wheel assembly 30.

In the foregoing description, the rectifier 530 is configured to be electrically connected to the generator assembly 520 through the electric wire 501 to output a direct current. The rectifier 530 may be arranged in the corresponding wheel or arranged in the leading assembly 20 or in a corresponding cavity in the front fork 32 or in a cavity defined in the rear wheel stand 42, to reduce vibration and facilitate transmission of the power generated by the power generation assembly 500 to at least one of the light-emitting module, the sound-generating module, the rechargeable battery, and the USB interface mentioned above through the rectifier 530. In addition to the generator assembly 520, the electricity-related devices may alternatively be mounted in the frame body 10. For example, the electricity-related devices may be supported and/or covered by the first connecting member 11 mentioned above or other similar connecting members.

According to the child carrier disclosed in the present disclosure, the front wheel assembly 30 may have a pedal device 34. When the power generation assembly 500 is arranged in the front wheel 31, the first operating member 540 is at the first position and the second operating member 550 is at the third position, and the child rides using the pedal device 34 or the user pushes the child carrier 100, the front axle 33 may be driven to rotate together. In this case, the generator assembly 520 may generate power under the driving of the transmission gear 512 and the drive gear 522.

When the first operating member 540 is at the first position and the second operating member 550 is at the fourth position, the power may alternatively be generated by hand turning the pedal device 34 in situ or by riding in situ and rotating the axle of the wheel in which the power generation assembly is mounted. In this case, pushing the child carrier 100 may not drive the axle to rotate, so power may not be generated.

When the first operating member 540 is at the second position and the second operating member 550 is at the third position, the power generation function is disabled, and the child carrier 100 may be simply pushed or simply ridden. When the first operating member 540 is at the second position and the second operating member 550 is at the fourth position, the power generation function is disabled, and pushing and riding may not interfere with each other.

In various embodiments of the present disclosure, since the generator assembly 520 is mounted in the front wheel and/or the rear wheel, the addition of the power generation assembly 500 may not affect the overall appearance of the child carrier 100, and most of the sound generated when the power generation assembly 500 is operating is isolated or absorbed. The resulting noise pollution is low.

In addition, according to the child carrier provided in the present disclosure, since the wheel is provided with the power generation assembly, self-driven power generation can be achieved through rotation of the axle of the wheel regardless of whether the child carrier is pushed by the user or ridden by the child, or even the wheel is rotated by pedaling in place or hand turning, and the generated power may be used for lighting, battery charging, USB charging, electronic sound generation, and the like, which expands the functionality of the child carrier. Since a main noise-generating device (i.e., the generator assembly) of the power generation assembly is mounted in the wheel, the child carrier with the power generation assembly according to the present disclosure has low power generation noise and is more suitable for use by children.

According to at least some embodiments of the present disclosure, the child carrier includes a wheel assembly with a generator clutch function, which enables the child carrier to switch between a simple pedal riding function and a pedal power generation riding function, or between a simple push function and a push power generation function, to meet multiple functional requirements for the child carrier.

According to at least some embodiments of the present disclosure, the child carrier includes a wheel assembly with a wheel drive clutch function, which allows rotation of only the front wheel and/or rear wheel during the pushing of the child carrier, without transmitting torque between the wheel and the axle thereof. Therefore, the user can push the child carrier with less effort, and at the same time, the pushing behavior does not interfere with the child's riding of the child carrier.

It is to be noted that, according to at least some embodiments of the present disclosure, the child carrier may alternatively include only a wheel assembly with a generator clutch function, or only a wheel assembly with a wheel drive clutch function.

According to at least some embodiments of the present disclosure, the child carrier includes a wheel assembly with both a generator clutch function and a wheel drive clutch function, which may realize various operating modes such as power generation by in-situ pedaling and riding, power generation by riding and pedaling, power generation by pushing, simple pushing, simple riding, parallel pushing and riding, power generation by riding and pedaling during the pushing, and power generation by hand turning the pedal assembly in situ.

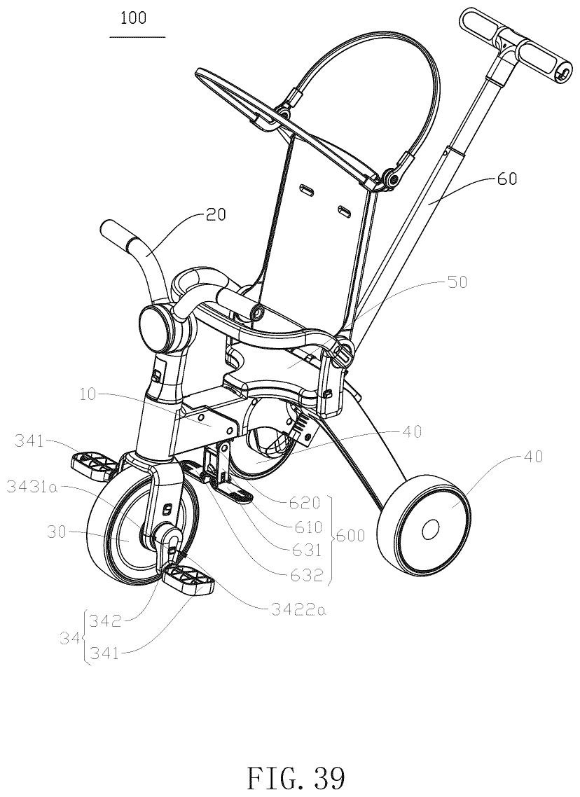

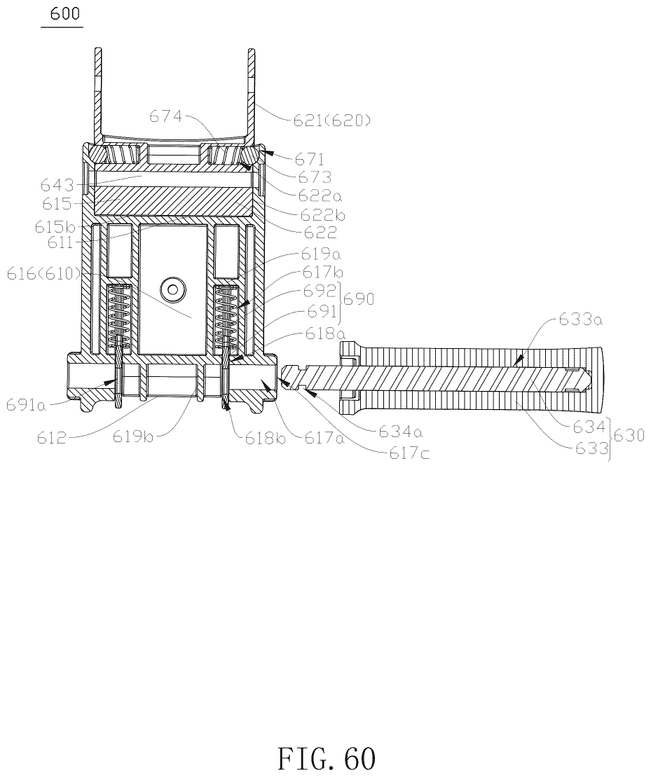

FIG. 39 to FIG. 60 schematically show a child carrier 100 according to a third embodiment of the present disclosure, which may be, for example, a child tricycle, a child bicycle, or the like. The child carrier enables the child's feet to rest more fully, and provides better user experience.

As shown in FIG. 39 to FIG. 41, the child carrier 100 in this embodiment includes a frame body 10, a leading assembly 20, a front wheel assembly 30, a rear wheel assembly 40, a seat 50, a push rod 60, and a footrest device 600. The frame body 10, the leading assembly 20, the rear wheel assembly 40, the seat 50, and the push rod 60 in this embodiment all have a same structure and connection relationship as the frame body 10, the leading assembly 20, the rear wheel assembly 40, the seat 50, and the push rod 60 in the first embodiment, and a main difference lies in specific structures of the front wheel assembly 30 and the footrest device 600.

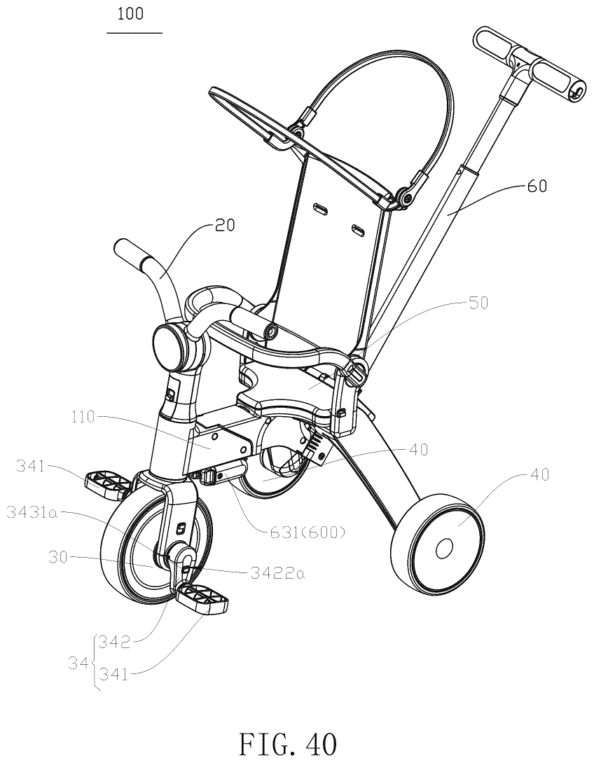

As shown in FIG. 39 to FIG. 41, the footrest device 600 is connected below the frame body 10 and located between the front wheel assembly 30 and the seat 50. The footrest device 600 has a use state (as shown in FIG. 39) and a non-use state (as shown in FIG. 40) relative to the frame body 10. During the traveling of the child carrier, the footrest device 600 can be maintained in the use state relative to the frame body 10. In this case, the footrest device 600 may be configured to carry the child's feet, so that the child can place the feet on the footrest device 600 to get a full rest, and may not get tired easily due to the feet hanging in the air for a long time or riding for a long time. In addition, in this embodiment, the pedal device 34 is configured to drive the front wheel assembly 30. Therefore, the front wheel assembly 30 can be rotated by stepping on the pedal device 34, so that the child carrier moves forward as a whole.

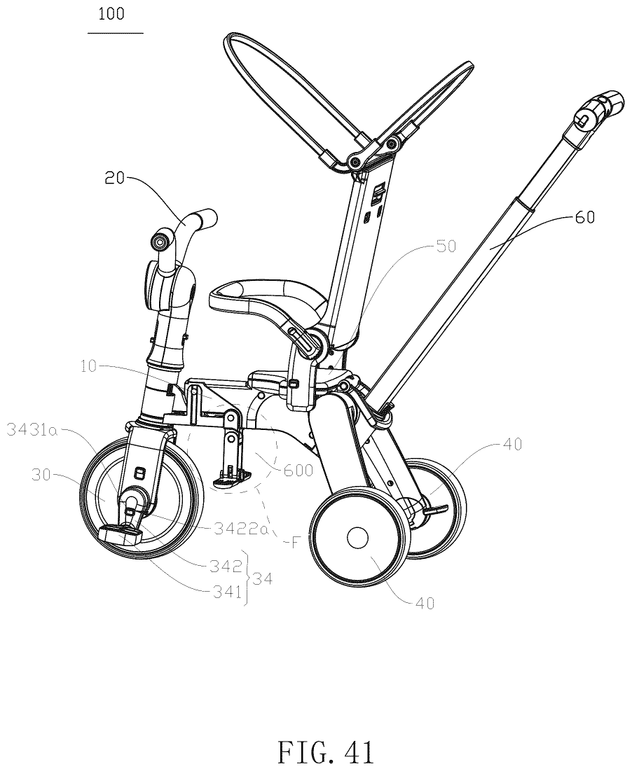

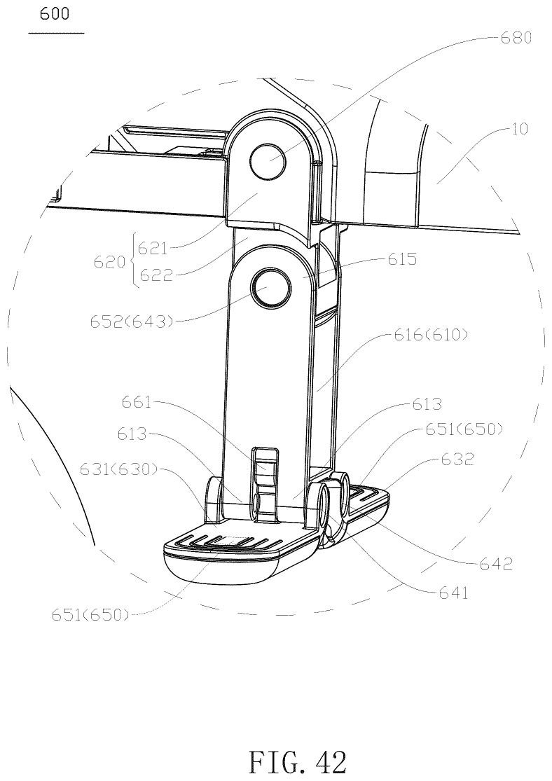

Specifically, the footrest device 600 may be in a variety of forms. For example, in this embodiment, as shown in FIG. 41 and FIG. 42, the footrest device 600 includes a footrest assembly 630, a support member 610, and a connecting member 620. When the footrest device 600 is in the use state, the support member 610 is at a first rotation position, and the footrest assembly 630 is in an unfolded state. When the footrest device 600 is in the non-use state, the support member 610 is at a second rotation position, and the footrest assembly 630 is in a folded state.

In this embodiment, two footrest assemblies 630 are provided, which are a first footrest 631 and a second footrest 632 respectively. The first footrest 631 and the second footrest 632 are pivotally connected to one end of the support member 610 through a first pivot shaft 641 and a second pivot shaft 642 respectively, the other end of the support member 610 is pivotally connected to the connecting member 620 through a rotating shaft 643, and one end of the connecting member 620 away from the support member 610 is fixed to the frame body 10.

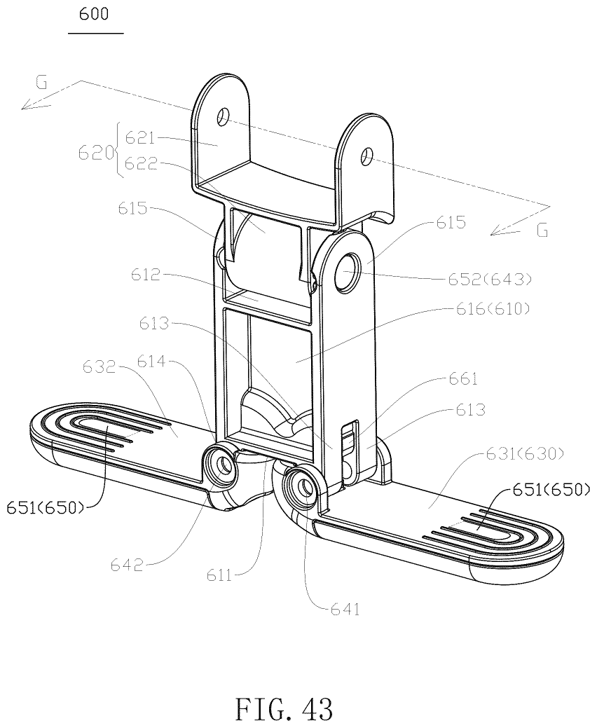

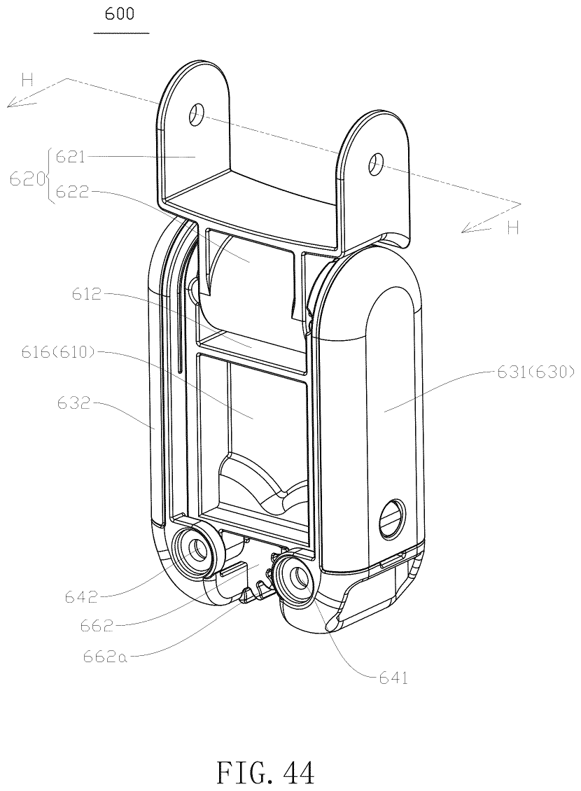

Specifically, as shown in FIG. 43 to FIG. 45, the support member 610 includes a support body 616, and the support body 616 has a roughly cuboid structure. The cuboid structure has a first end surface 611 and a second end surface 612 located at two ends. The first end surface 611 is convexly provided with two first connecting portions 613 and two second connecting portions 614. The first footrest 631 is pivotally connected to the two first connecting portions 613 through the first pivot shaft 641, and the second footrest 632 is pivotally connected to the two second connecting portions 614 through the second pivot shaft 642. Both the first footrest 631 and the second footrest 632 have an unfolded state and a folded state relative to the support member 610. When the first footrest 631 or the second footrest 632 is in the unfolded state, as shown in FIG. 43, the first footrest 631 or the second footrest 632 can be configured to carry the child's feet. When the first footrest 631 or the second footrest 632 is in the folded state, as shown in FIG. 44, the first footrest 631 or the second footrest 632 is folded close to the support member 610.

Further, as shown in FIG. 43 and FIG. 44, the footrest device 600 further includes a fixed assembly 650. In this embodiment, a fixed assembly 650 is provided between the first footrest 631 and the support member 610 and between the second footrest 632 and the support member 610. When the first footrest 631 (or the second footrest 632) is in the folded state, the first footrest 631 (or the second footrest 632) can be fixed to a corresponding side of the support member 610 through the fixed assembly 650.

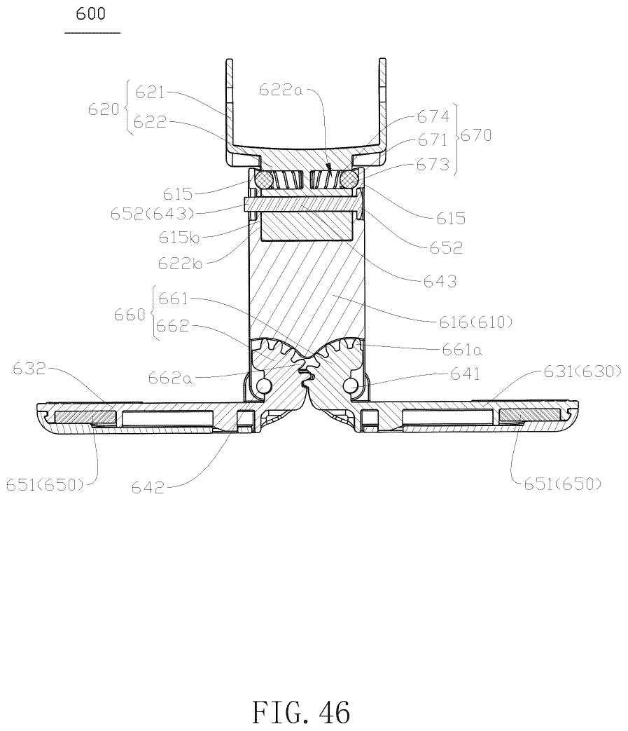

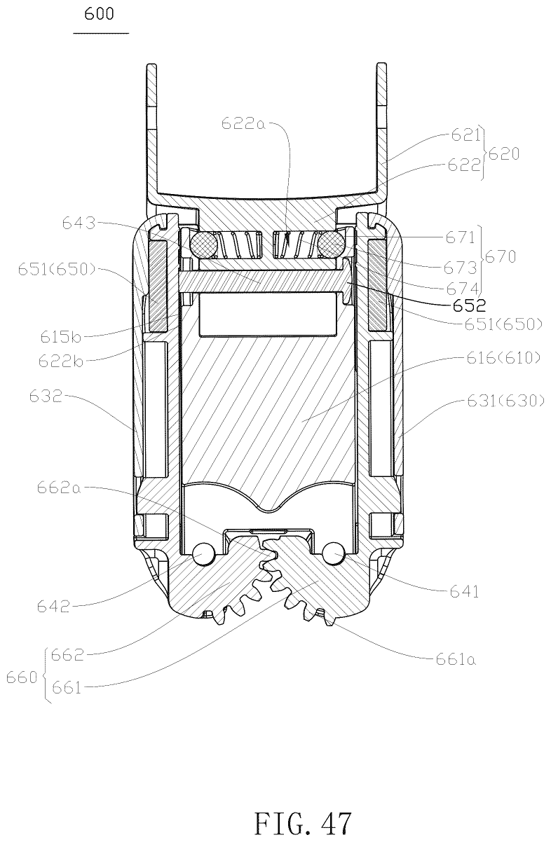

Taking the fixed assembly 650 between the first footrest 631 and the support member 610 as an example, as shown in FIG. 43, FIG. 46, and FIG. 47, the fixed assembly 650 includes a first magnetic portion 651 arranged on the first footrest 631 and a second magnetic portion 652 arranged on the support member 610. When the first footrest 631 is in the folded state, the first magnetic portion 651 and the second magnetic portion 652 can be adsorbed together. In this embodiment, the first magnetic portion 651 may be a permanent magnet embedded in the first footrest 631. The second magnetic portion 652 may be integrally formed with the rotating shaft 643. Specifically, the rotating shaft 643 may be made of a ferromagnetic material, such as iron, cobalt, or nickel, and two ends of the rotating shaft 643 protrude from two sides of the support member 610 to form two second magnetic portions 652. As shown in FIG. 47, when the first footrest 631 and the second footrest 632 are in the folded state, the first magnetic portions 651 of the first footrest 631 and the second footrest 632 can be adsorbed and engaged with the two second magnetic portions 652 respectively, so that both the first footrest 631 and the second footrest 632 are fixed in the folded state. When the first footrest 631 (or the second footrest 632) is required to be switched from the folded state to the unfolded state as shown in FIG. 46, there is only a need to apply an external force to the first footrest 631 (or the second footrest 632) to overcome a magnetic force between the first magnetic portion 651 and the second magnetic portion 652. In this way, the rotating shaft 643 plays a role of pivotally connecting the support member 610 and the connecting member 620, and at the same time, can also play a role of adsorbing and fixing the first footrest 631 and the second footrest 632. There is no need to additionally arrange the second magnetic portion 652, so a mounting process of the footrest device 600 can be simplified. Certainly, in other embodiments, the second magnetic portion 652 may alternatively have a structure which is additionally arranged on the support member 610 and is ferromagnetic or has opposite magnetic properties to the first magnetic portion 651.

Further, as shown in FIG. 46 and FIG. 47, a synchronization mechanism 660 is further arranged between the first footrest 631 and the second footrest 632. The synchronization mechanism 660 can realize synchronous rotation of the first footrest 631 and the second footrest 632. In this embodiment, the synchronization mechanism 660 includes a first driving member 661 and a second driving member 662. Specifically, one end of the first footrest 631 and the first driving member 661 are pivotally connected to the first connecting portion 613 through the first pivot shaft 641, and both one end of the first footrest 631 and the first driving member 661 are fixed to the first pivot shaft 641. As shown in FIG. 43, the first pivot shaft 641 is rotatably connected to the first connecting portion 613. Similarly, one end of the second footrest 632 and the second driving member 662 are also pivotally connected to the second connecting portion 614 respectively through the second pivot shaft 642, and both one end of the second footrest 632 and the second driving member 662 are fixed to the second pivot shaft 642. As shown in FIG. 43, the second pivot shaft 642 is rotatably connected to the second connecting portion 614.

As shown in FIG. 46 and FIG. 47, in this embodiment, the first driving member 661 has a first wheel tooth portion 661a, and the second driving member 662 has a second wheel tooth portion 662a. The first wheel tooth portion 661a and the second wheel tooth portion 662a are engaged with each other. In this way, when one (e.g., the first footrest 631) of the first footrest 631 and the second footrest 632 rotates relative to the support member 610, through the engagement between the first wheel tooth portion 661a and the second wheel tooth portion 662a, the other (e.g., the second footrest 632) of the first footrest 631 and the second footrest 632 is driven to rotate synchronously, so that it is convenient for the user to unfold or fold the first footrest 631 and the second footrest 632 at the same time. That is, through the actuation of the first driving member 661 and the second driving member 662, the first footrest 631 and the second footrest 632 can be driven to rotate in opposite directions synchronously.

In this embodiment, both the first driving member 661 and the second driving member 662 are quarter gears. In this way, rotation angles of the first footrest 631 and the second footrest 632 relative to the support member 610 can be limited, so that the first footrest 631 and the second footrest 632 always pivot between the unfolded state and the folded state. Certainly, in other embodiments, the first driving member 661 and the second driving member 662 may alternatively be one-third gears, one-fifth gears, or the like as required, which is not limited in the present disclosure.

Certainly, in other embodiments, the first driving member 661 and the second driving member 662 may alternatively be directly fixed to one end of the first footrest 631 and one end of the second footrest 632 respectively. In this way, the first pivot shaft 641 may alternatively be rotatably connected to one end of the first footrest 631 and be fixedly connected to the first connecting portion 613, and the second pivot shaft 642 may alternatively be rotatably connected to one end of the second footrest 632 and be fixedly connected to the second connecting portion 614.

Specifically, as shown in FIG. 43 to FIG. 45, the connecting member 620 includes a fixed portion 621 and a second pivot portion 622 connected to each other. The fixed portion 621 has a substantially U-shaped structure, and two ends of the fixed portion 621 are fixedly connected to two sides of the frame body 10 through a fastener 680 (as shown in FIG. 42). The fastener 680 may be a rivet, a screw, or the like. The second pivot portion 622 has a substantially cylindrical structure and is pivotally connected to the support member 610 through the rotating shaft 643.

Specifically, as shown in FIG. 46 to FIG. 48, two opposite sides of the first end surface 611 of the support body 616 are respectively raised to form two first pivot portions 615. The two first pivot portions 615 each have two pivot holes 615a. The rotating shaft 643 passes through the pivot hole 615a on one side, the second pivot portion 622, and the pivot hole 615a on the other side in sequence, thereby realizing a pivotal connection between the support member 610 and the connecting member 620. In this embodiment, the rotating shaft 643 is fixedly connected to the two first pivot portions 615, and the second pivot portion 622 is rotatable relative to the rotating shaft 643. Certainly, in other embodiments, the rotating shaft 643 may alternatively be fixedly connected to the second pivot portion 622, and the two first pivot portions 615 are rotatable relative to the rotating shaft 643. In this embodiment, the first pivot shaft 641 and the second pivot shaft 642 are both perpendicular to the rotating shaft 643. Certainly, in other embodiments, an angle between the first pivot shaft 641 and the rotating shaft 643 and an angle between the second pivot shaft 642 and the rotating shaft 643 may alternatively be greater than 90 degrees or less than 90 degrees. In other words, extension directions of the first pivot shaft 641 (or the second pivot shaft 642) and the rotating shaft 643 are not parallel to each other.

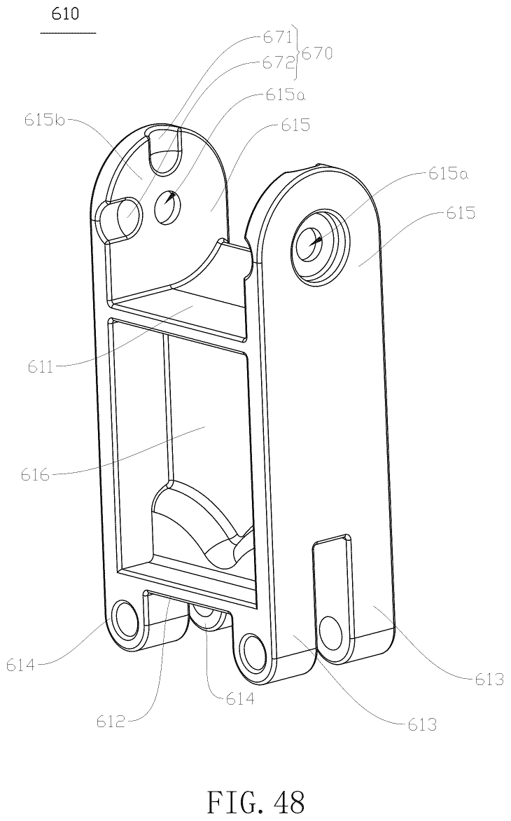

Further, as shown in FIG. 46 and FIG. 48, the footrest device 600 further includes a positioning mechanism 670. The positioning mechanism 670 is arranged between the support member 610 and the connecting member 620, and the positioning mechanism 670 is configured to fix the support member 610 relative to the connecting member 620 at the first rotation position as shown in FIG. 39 or the second rotation position as shown in FIG. 40. In this embodiment, two positioning mechanisms 670 are provided and are respectively configured to realize positioning and fixing between the two sides of the second pivot portion 622 and the two first pivot portions 615, so that the support member 610 can be better positioned relative to the connecting member 620 and is not easily displaced. Certainly, in other embodiments, the positioning mechanism 670 may alternatively be arranged only between one side of the second pivot portion 622 and the corresponding first pivot portion 615.

Specifically, as shown in FIG. 46 to FIG. 48, taking one positioning mechanism 670 as an example, the positioning mechanism 670 includes a first positioning recess 671, a second positioning recess 672, a positioning protrusion 673, and a positioning reset member 674. The first positioning recess 671 and the second positioning recess 672 are arranged at intervals on a first side surface 615b of the first pivot portion 615, and the first positioning recess 671 and the second positioning recess 672 are arranged at intervals around a periphery of the pivot hole 615a. The positioning protrusion 673 is movably arranged on the second pivot portion 622, and the positioning protrusion 673 may move to protrude from a second side surface 622b of the second pivot portion 622. The first side surface 615b abuts against the second side surface 622b. As shown in FIG. 47, the positioning protrusion 673 is movably arranged in the second pivot portion 622 and is spaced apart from the rotating shaft 643. In this embodiment, the positioning protrusion 673 may move in a direction substantially parallel to the rotating shaft 643. The positioning protrusion 673 has a first movement position and a second movement position. There is a symmetry plane between the two first pivot portions 615, and the two first pivot portions 615 are mirror symmetrical with respect to the symmetry plane. The positioning protrusion 673 at the first movement position is further away from the symmetry plane than at the second movement position. When the positioning protrusion 673 is at the first movement position, the positioning protrusion 673 can be engaged with the first positioning recess 671 or the second positioning recess 672. When the positioning protrusion 673 is at the second movement position, the positioning protrusion 673 can be disengaged from the first positioning recess 671 or the second positioning recess 672 and abut against the first side surface 615b. In this embodiment, the positioning protrusion 673 is a ball, and the first positioning recess 671 and the second positioning recess 672 are a first positioning groove and a second positioning groove that can match the positioning protrusion 673. In this embodiment, both the first positioning groove and the second positioning groove are partially spherical grooves. By use of smooth rotation characteristics of the ball, when the support member 610 rotates around the connecting member 620, the ball can move between the first positioning groove and the second positioning groove more smoothly. Certainly, in other embodiments, the positioning protrusion 673 may alternatively be a pin-shaped structure, a tapered structure, or the like.

Further, as shown in FIG. 46 to FIG. 48, the positioning reset member 674 is arranged between the positioning protrusion 673 and the support member 610, and the positioning reset member 674 biases the positioning protrusion 673 to move towards the first movement position. Specifically, a mounting groove 622a extending in a direction parallel to the rotating shaft 643 may be arranged in the second pivot portion 622, the positioning reset member 674 and at least part of the positioning protrusion 673 are arranged in the mounting groove 622a, and two ends of the positioning reset member 674 abut against a groove bottom of the mounting groove 622a and the positioning protrusion 673. When the support member 610 rotates to the first rotation position or the second rotation position relative to the connecting member 620, the positioning reset member 674 can push at least part of the positioning protrusion 673 out of the mounting groove 622a through a notch of the mounting groove 622a to be engaged with the first positioning recess 671 or the second positioning recess 672, so as to implement a function of fixing the support member 610 to the first rotation position or the second rotation position through the connecting member 620. Optionally, the positioning reset member 674 is a spring.

Certainly, in other embodiments, the positioning mechanism 670 may alternatively be in other forms. For example, a first positioning portion and a second positioning portion may be arranged on the connecting member 620, and a third positioning portion is arranged on the support member 610, and the magnetic properties of the first positioning portion and the second positioning portion are opposite to the magnetic property of the third positioning portion. In this way, when the support member 610 is at the first rotation position, the third positioning portion is magnetically locked with the first positioning portion, and when the support member 610 is at the second rotation position, the third positioning portion is magnetically locked with the second positioning portion. In short, the form of the positioning mechanism 670 is not limited, as long as the positioning between the support member 610 and the connecting member 620 can be realized. In addition, alternatively, the first positioning portion and the second positioning portion may be arranged on the support member 610, the third positioning portion may be arranged on the connecting member 620, and so on.

In this way, as shown in FIG. 43, the footrest device 600 is in the unfolded state. When the footrest device 600 is not required or the child carrier is required to be folded as a whole, the first footrest 631 (or the second footrest 632) in the unfolded state can be rotated in a direction close to the support member 610 to the folded state. In this process, through mutual engagement between the first driving member 661 and the second driving member 662, a tail end of the second footrest 632 (or the first footrest 631) in the unfolded state (that is, the end of the second footrest 632 not connected to the support member 610) can be driven to also synchronously rotate in a direction close to the support member 610 to the folded state.

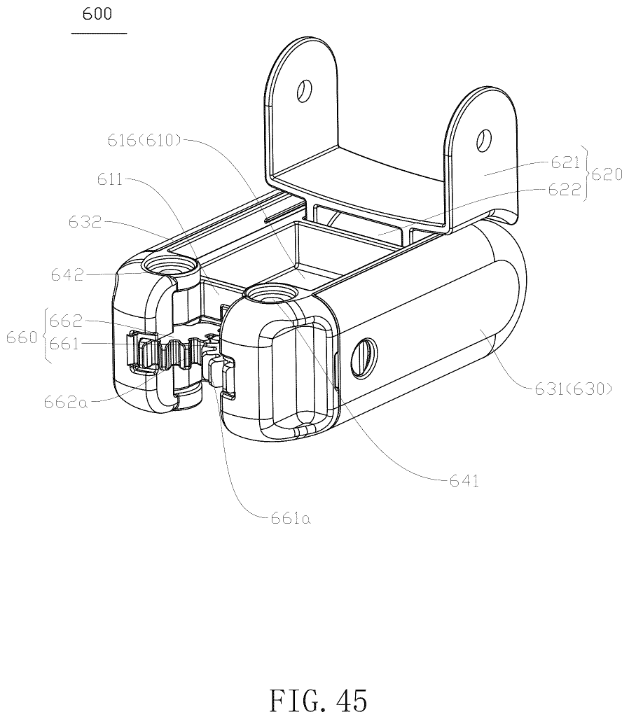

As shown in FIG. 47, the first footrest 631 and the second footrest 632 may be fixed to two sides of the support member 610 through the fixed assembly 650 (such as adsorption fit between the first magnetic portion 651 and the second magnetic portion 652). In addition, as shown in FIG. 45, the support member 610 in the first rotation position can be rotated around the rotating shaft 643 to the second rotation position, so that the footrest device 600 is switched to the folded state.

As shown in FIG. 46 to FIG. 48, during the rotation of the support member 610, the positioning protrusion 673 originally engaged with the first positioning recess 671 moves out of the first positioning recess 671 as the support member 610 rotates, and moves to the first side surface 615b (as shown in FIG. 48) of the first pivot portion 615 between the first positioning recess 671 and the second positioning recess 672. The first side surface 615b pushes against the positioning protrusion 673, so that the positioning protrusion 673 moves from the first movement position to the second movement position, causing the positioning reset member 674 to be compressed. When the support member 610 continues to rotate to the second rotation position, the positioning protrusion 673 is opposite to the second positioning recess 672. In this case, the positioning protrusion 673, which loses a pushing force of the first side surface 615b, moves to the first movement position again under an elastic restoring force of the positioning reset member 674 and engages with the second positioning recess 672. In this way, the folding of the footrest device 600 is completed.

Certainly, during the folding of the footrest device 600, firstly, the support member 610 may be rotated relative to the connecting member 620 to the second rotation position, and then the first footrest 631 and the second footrest 632 are rotated relative to the support member 610 to the folded state. Alternatively, according to the user's personal requirement, the support member 610 may only be rotated relative to the connecting member 620 to the second rotation position, or the first footrest 631 and the second footrest 632 may only be rotated relative to the support member 610 to the folded state, or the like, which is not limited in the present disclosure. The unfolding process of the footrest device 600 is opposite to the above folding process, and will not be described in detail here.

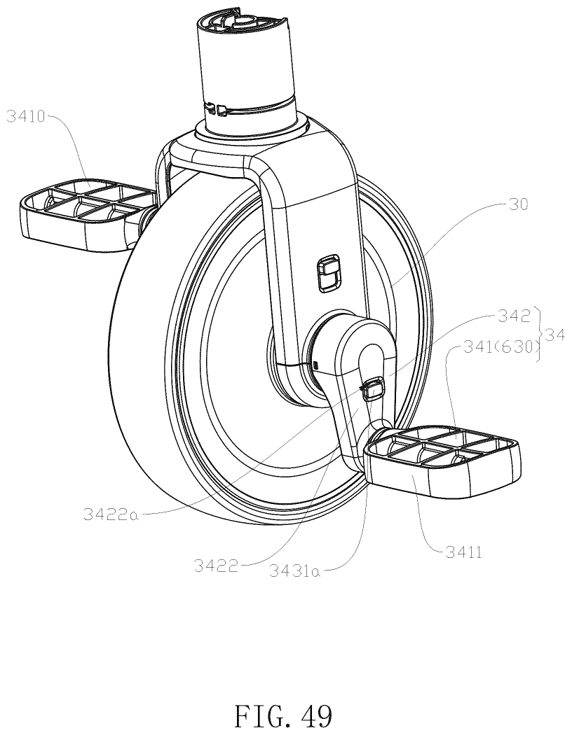

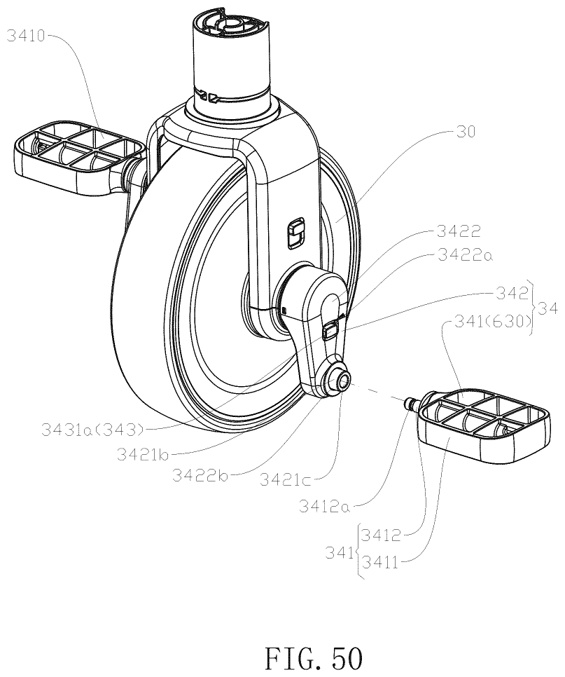

Further, as shown in FIG. 49 and FIG. 50, the pedal device 34 includes a pedal assembly 341, a pedal base 342, and a second disassembly mechanism 343. The pedal base 342 in this embodiment is configured to drive the front wheel assembly 30, but the present disclosure is not limited thereto. The pedal assembly 341 is detachably connected to the pedal base 342 through the second disassembly mechanism 343. In other embodiments, the pedal device 34 may alternatively be directly arranged on the frame body 10.

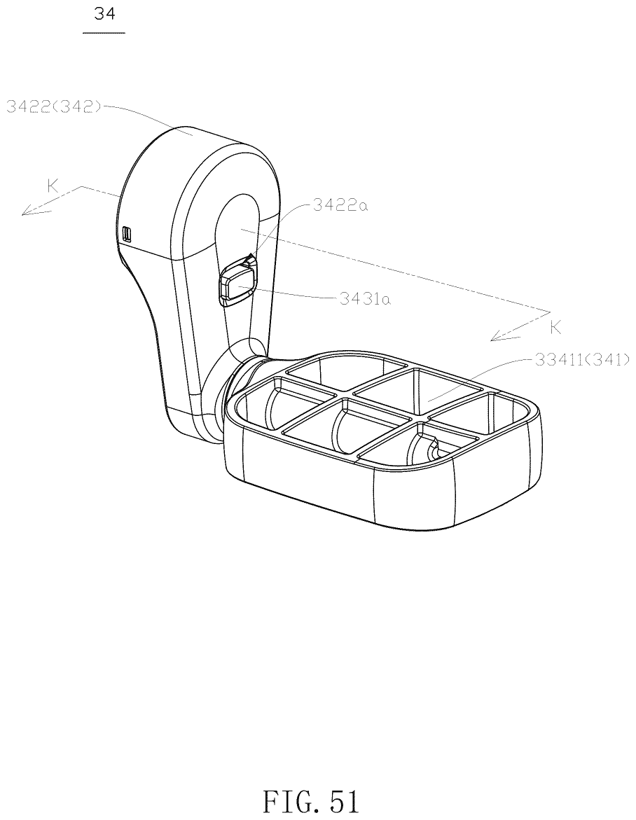

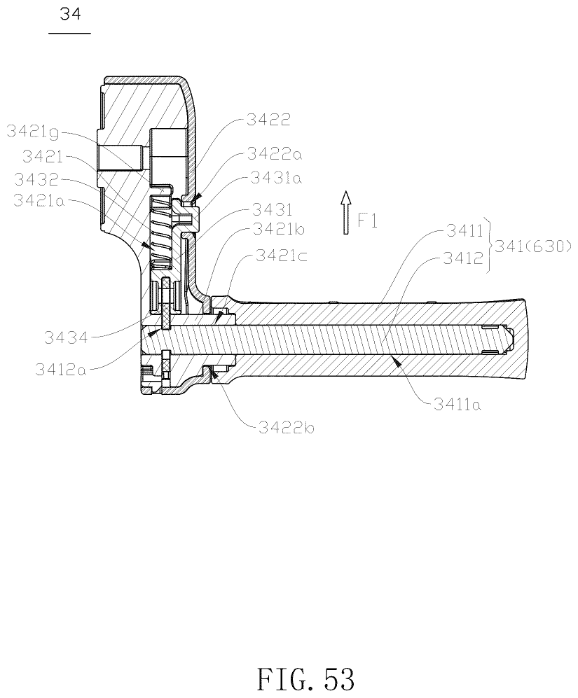

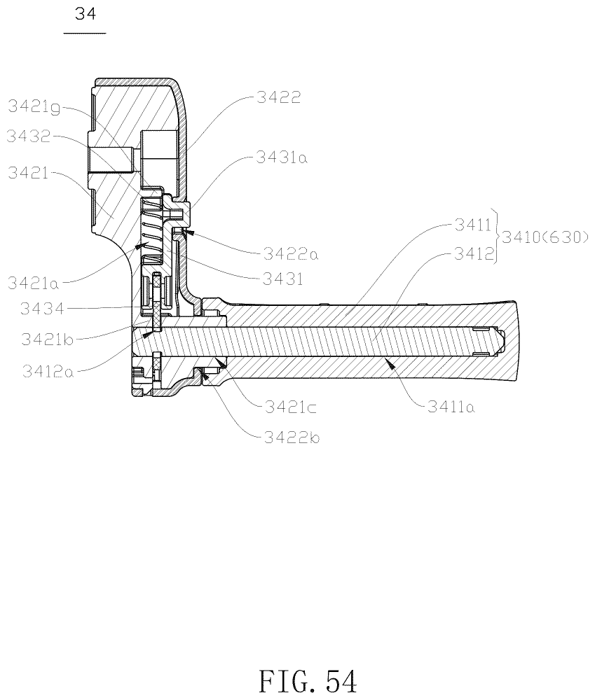

Specifically, as shown in FIG. 50 and FIG. 51, the pedal assembly 341 includes a pedal body 3411 and a second pin shaft 3412. The pedal body 3411 may be stepped on by the child riding thereon, and the pedal body 3411 has a roughly cuboid structure. An approximate axis position of the pedal body 3411 is provided with a second insertion groove 3411a (see FIG. 53 and FIG. 54) along an axial direction thereof. The second pin shaft 3412 is partially inserted into the second insertion groove 3411a, so that the pedal body 3411 can rotate around the second pin shaft 3412 to facilitate the child to adjust a pedaling direction.

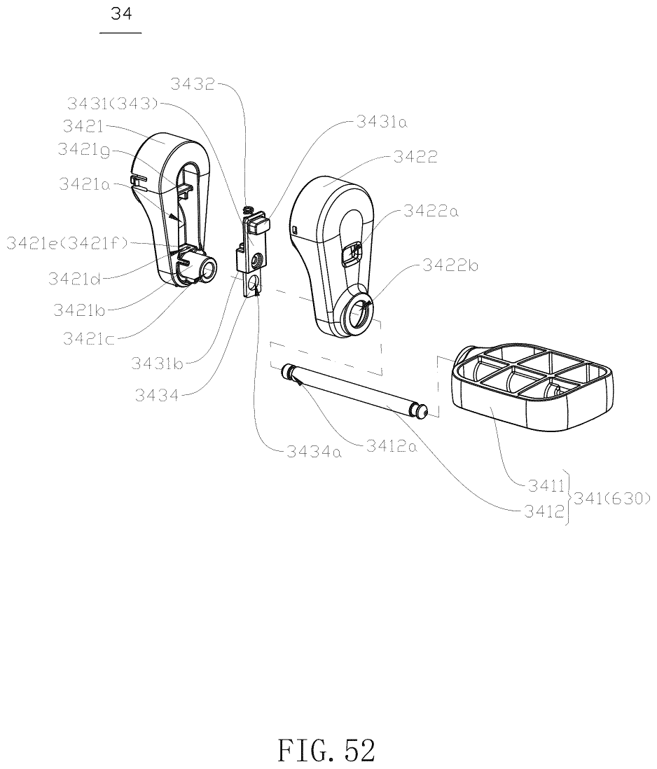

Specifically, as shown in FIG. 51 and FIG. 52, the pedal base 342 includes a first housing 3421 and a second housing 3422. The first housing 3421 and the second housing 3422 are engaged with each other to form a mounting cavity for mounting the second disassembly mechanism 343 (not shown in the drawings). A side of the first housing 3421 facing away from the second housing 3422 is connected to the front fork 32. A side of the first housing 3421 facing the second housing 3422 is provided with an accommodating groove 3421a and an accommodating boss 3421b. The accommodating boss 3421b has a cylindrical structure, and the accommodating boss 3421b is provided with an accommodating cavity 3421c arranged through the axial direction of the second pin shaft 3412. A first groove wall 3421f of the accommodating groove 3421a is provided with a strip insertion hole 3421d, and the accommodating groove 3421a is in communication with the accommodating cavity 3421c through the insertion hole 3421d. The second housing 3422 has an operating hole 3422a and a mounting hole 3422b arranged at intervals. When the second housing 3422 is engaged with the first housing 3421, the accommodating boss 3421b passes through the mounting hole 3422b and protrudes from an outer surface of the second housing 3422, and the second housing 3422, a second groove wall 3421g of the accommodating groove 3421a, and a cavity wall of the accommodating cavity 3421c together define a mounting cavity. The second groove wall 3421g is arranged opposite to the first groove wall 3421f.

Specifically, as shown in FIG. 52 and FIG. 53, the second disassembly mechanism 343 includes a second locking member 3434, an operating member 3431, and an operation reset member 3432.

In this embodiment, as shown in FIG. 52 to FIG. 54, a part of the second pin shaft 3412 outside the second insertion groove 3411a is surrounded by a second locking groove 3412a. The second locking member 3434 is movably arranged on the pedal base 342. In this embodiment, the second locking member 3434 has a generally strip-shaped sheet structure. The second locking member 3434 is provided with a second locking hole 3434a. A radial dimension of the second locking hole 3434a is greater than that of the second pin shaft 3412.

The operating member 3431 is a quick release button. One end of the operating member 3431 is fixedly connected to the second locking member 3434, and the other end of the operating member 3431 is provided with an operating portion 3431a. In this embodiment, at least part of the operating member 3431 and the second locking member 3434 are movably arranged in the mounting cavity. Specifically, at least part of the operating member 3431 is movably arranged in the accommodating groove 3421a. One end of the second locking member 3434 is connected to the operating member 3431, and the other end is inserted into the accommodating cavity 3421c through the insertion hole 3421d. The operating portion 3431a protrudes from the outer surface of the second housing 3422 through the operating hole 3422a to facilitate the user's operation. The operation reset member 3432 is also arranged in the accommodating groove 3421a, and the operation reset member 3432 has one end connected to or abutting against the operating member 3431 and the other end thereof abutting against the second groove wall 3421g of the accommodating groove 3421a. In this embodiment, the operation reset member 3432 is located on a side of the operating member 3431 away from the second locking member 3434. Optionally, the operation reset member 3432 is a spring.

Further, the second locking member 3434 is operable to move between a first movable position (as shown in FIG. 53) and a second movable position (as shown in FIG. 54). In this embodiment, the second movable position is located in an F1 direction of the first movable position. That is, the second movable position is located above the first movable position. One end of the second pin shaft 3412 with the second locking groove 3412a extends into the accommodation cavity 3421c, that is, into the mounting cavity, and at the same time passes through the second locking hole 3434a. When the pedal assembly 341 is mounted in place, a hole wall of the second locking hole 3434a is exactly opposite to the second locking groove 3412a on the second pin shaft 3412.

As shown in FIG. 53, when the second locking member 3434 is at the first movable position, an upper side of the hole wall of the second locking hole 3434a is inserted into the second locking groove 3412a, and the operation reset member 3432 biases the operating member 3431 so that the operating member 3431 drives the second locking member 3434 to move towards the first movable position. In this way, the second locking member 3434 is maintained at the first movable position, and the pedal assembly 341 is connected to the pedal base 342. When the pedal assembly 341 is required to be disassembled from the pedal base 342, the operating portion 3431a may be pushed along the F1 direction, so that the operating member 3431 drives the second locking member 3434 to together move to the second movable position along the F1 direction, the operation reset member 3432 is compressed, and the hole wall of the second locking hole 3434a is detached from the second locking groove 3412a. In this way, the pedal assembly 341 and the pedal base 342 are unlocked, and the pedal assembly 341 can be disassembled from the pedal base 342. It should be noted that, since the radial dimension of the second locking hole 3434a is greater than that of the second pin shaft 3412, a lower side of the hole wall of the second locking hole 3434a is never engaged with the second locking groove 3412a. The process of mounting the pedal assembly 341 on the pedal base 342 is opposite to the above disassembly process, and therefore will not be described in detail again.

Further, as shown in FIG. 52, the mounting cavity is provided with a first limiting portion 3421e, the operating member 3431 is provided with a second limiting portion 3431b, and when the second locking member 3434 is at the first movable position, the first limiting portion 3421e abuts against the second limiting portion 3431b. In this embodiment, the first groove wall 3421f of the accommodating groove 3421a forms a first limiting portion 3421e, and the second limiting portion 3431b is a lower end surface of the operating member 3431. The arrangement of the first limiting portion 3421e and the second limiting portion 3431b may limit a movement stroke of the second locking member 3434, so that the second locking member 3434 does not move excessively in an opposite direction of F1. At the same time, through the setting of the size of the operating hole 3422a on the second housing 3422, movement strokes of the operating member 3431 and the second locking member 3434 in the F1 direction and the opposite direction of F1 may also be limited, thereby limiting the movement of the second locking member 3434 between the first movable position and the second movable position and preventing excessive movement of the second locking member 3434.

In this embodiment, two pedal devices 34 are provided and are respectively arranged on two sides of the front fork 32, to facilitate the child to place the feet on pedal bodies 3411 of the pedal devices 34 on the two sides for riding. Certainly, in other embodiments, more than two pedal devices 34 may alternatively be provided. For example, two pedal assemblies 341 with different heights or sizes may be provided on two sides of the front wheel assembly 30 to facilitate riding by children of different ages or sizes.

In the child carrier of this embodiment, the pedal assembly 341 and the footrest assembly 630 are two independent components.

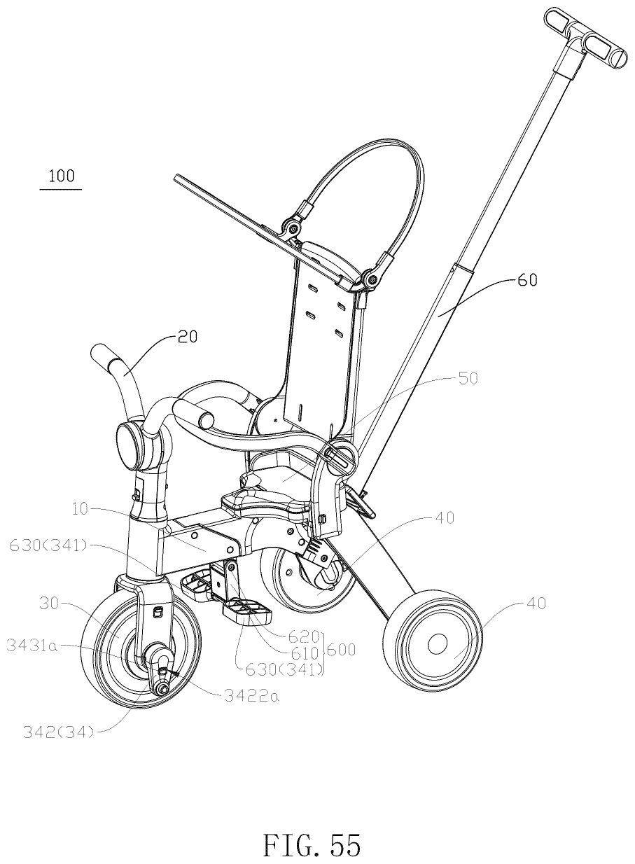

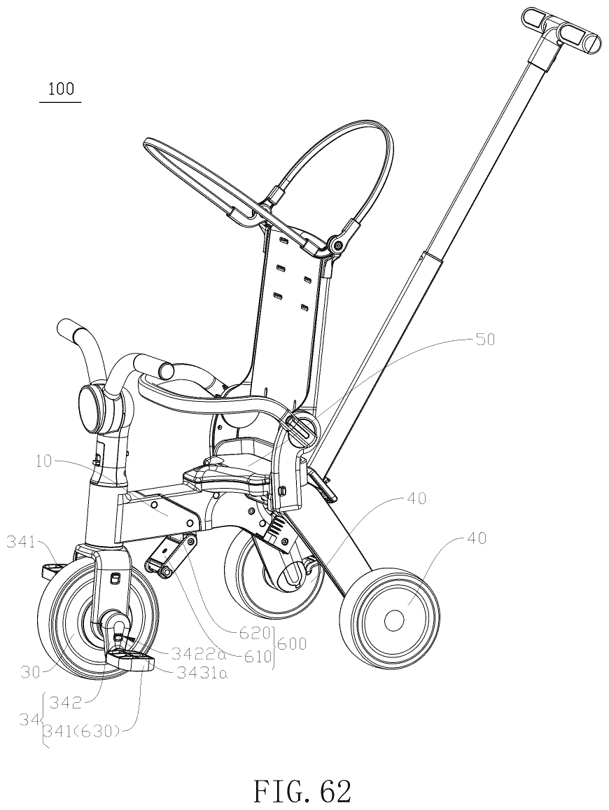

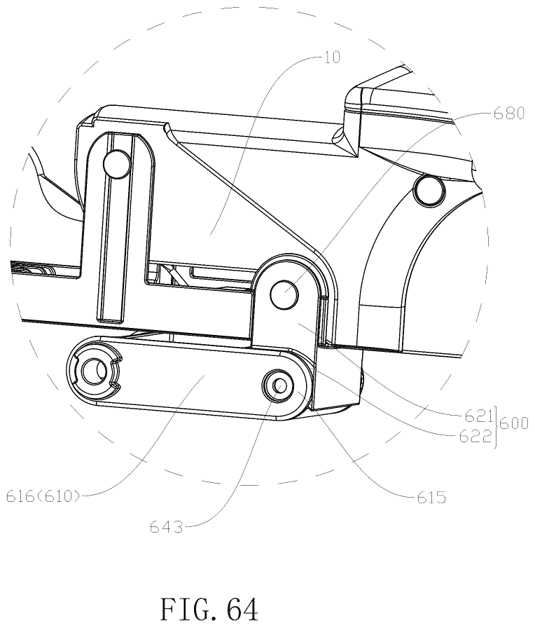

FIG. 55 to FIG. 64 schematically show a child carrier 100 according to a fourth embodiment of the present disclosure, which may be, for example, a child tricycle, a child bicycle, or the like. The child carrier enables the child's feet to rest more fully, and provides better user experience.

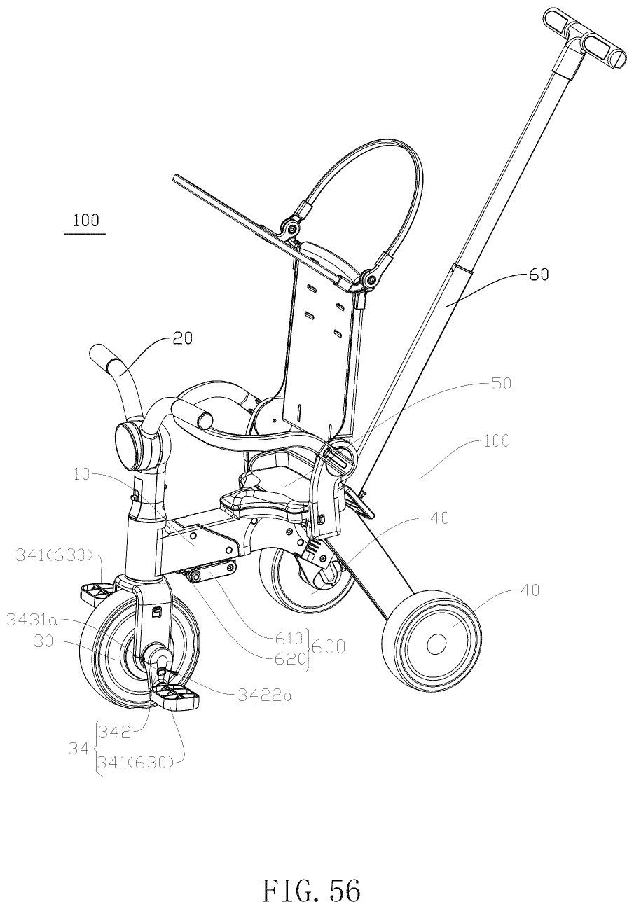

As shown in FIG. 55 to FIG. 56, the child carrier 100 in this embodiment includes a frame body 10, a leading assembly 20, a front wheel assembly 30, a rear wheel assembly 40, a seat 50, a push rod 60, and a footrest device 600. The frame body 10, the leading assembly 20, the front wheel assembly 30, the rear wheel assembly 40, the seat 50, and the push rod 60 in this embodiment all have a same structure and connection relationship as the frame body 10, the leading assembly 20, the front wheel assembly 30, the rear wheel assembly 40, the seat 50, and the push rod 60 in the third embodiment, and a main difference lies in a specific structure of the footrest device 600.

In this embodiment, as shown in FIG. 55 and FIG. 56, the footrest device 600 includes a footrest assembly 630, a support member 610, and a connecting member 620. Structures of the support member 610 and the connecting member 620 in this embodiment are substantially the same as those in the third embodiment, and a main difference lies in the footrest assembly 630 and a manner of connection between the footrest assembly 630 and the support member 610. In this embodiment, the footrest assembly 630 and the pedal assembly 341 of the pedal device 34 are actually a same component. The footrest assembly 630 is detachably connected to the support member 610. When the footrest device 600 is in the use state, the support member 610 is at the first rotation position, and the footrest assembly 630 is mounted on the support member 610. When the footrest device 600 is in the non-use state, the support member 610 is at the second rotation position, and the footrest assembly 630 is disassembled from the support member 610.

Specifically, when the footrest device 600 is in the use state, as shown in FIG. 55, the footrest assembly 630 may be mounted on the support member 610, and at the same time, the support member 610 is at the first rotation position. In this way, the child can place the feet on the footrest assembly 630 to get a rest. When the footrest device 600 is in the non-use state, as shown in FIG. 56, the footrest assembly 630 may be disassembled from the support member 610, and at the same time, the support member 610 is rotated to the second rotation position. The disassembled footrest assembly 630 may be mounted on the pedal base 342 as the pedal assembly 341 for the child to ride. In this embodiment, the footrest assembly 630 and the pedal assembly 341 are actually a same component. The footrest assembly 630 allows the child's feet to rest when in the use state, and can be used as a pedal assembly 341 for riding when in the non-use state, which has two uses, does not require an additional pedal assembly 341 (or footrest assembly 630), is easy to use, and helps to reduce a quantity of components of the child carrier and reduce the manufacturing cost.

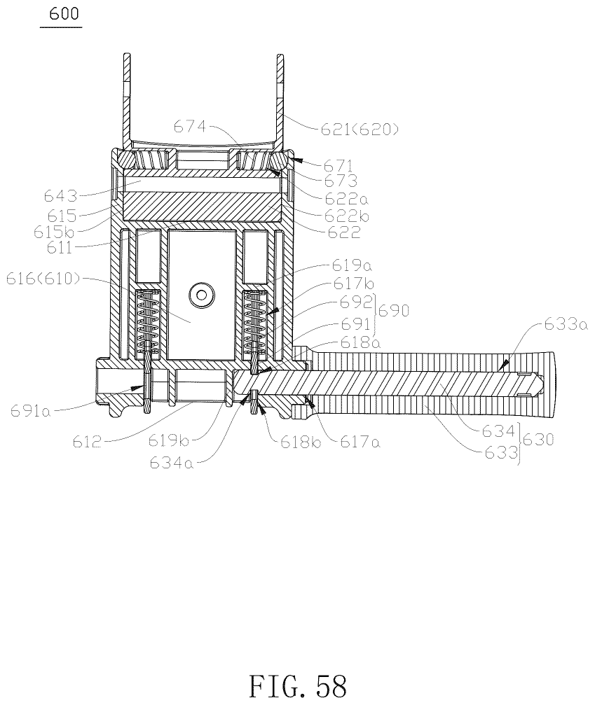

Further, as shown in FIG. 58 to FIG. 60, the footrest device 600 further includes a first disassembly mechanism 690. The footrest assembly 630 is detachably connected to the support member 610 through the first disassembly mechanism 690. In this embodiment, two footrest assemblies 630 and two first disassembly mechanisms 690 are provided. The two footrest assemblies 630 are detachably connected to left and right sides of the support member 610 through the two first disassembly mechanisms 690. Taking one footrest assembly 630 and a corresponding first disassembly mechanism 690 as an example, structures and a related connection relationship thereof are specifically described below.

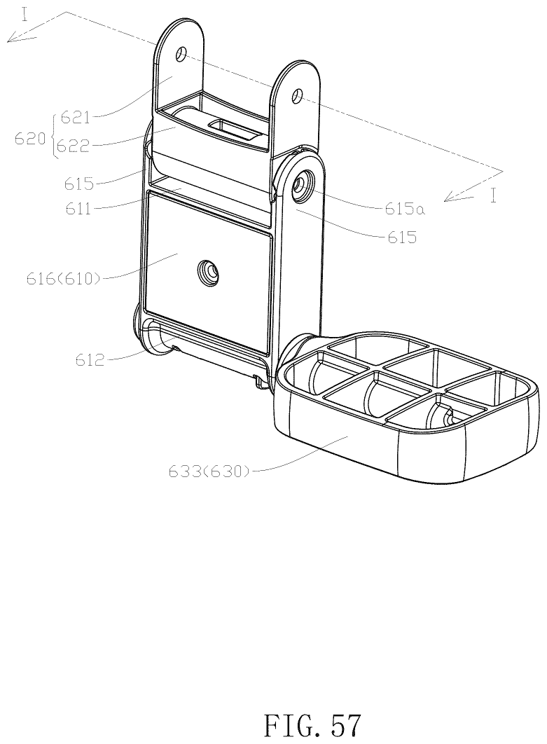

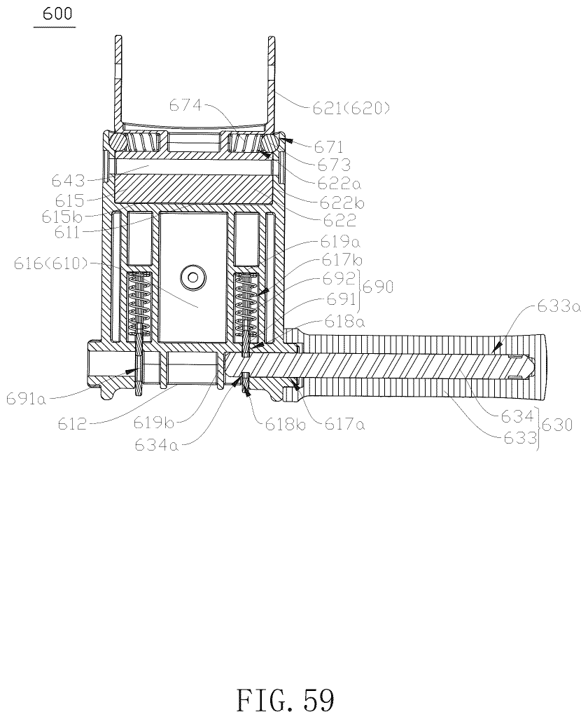

FIG. 57 is a schematic structural diagram of the connecting member 620, the support member 610, and one footrest assembly 630. FIG. 58 and FIG. 59 are sectional views of the structure shown in FIG. 57 along a line D-D. A first locking member 691 (described in detail below) of the first disassembly mechanism 690 in FIG. 58 is at the first lock position, and the first locking member 691 (described in detail below) of the first disassembly mechanism 690 in FIG. 59 is at the first unlock position. Specifically, the footrest assembly 630 includes a footrest body 633 and a first pin shaft 634. The footrest body 633 is configured to carry the child's feet. The footrest body 633 has a roughly cuboid structure. An approximate axis position of the footrest body 633 is provided with a first insertion groove 633a along an axial direction thereof, and one end of the first locking member 691 is inserted into the first insertion groove 633a, so that the footrest body 633 can rotate around the first pin shaft 634, and when the footrest assembly 630 is used as the pedal assembly 341, the child can easily adjust the pedaling direction. A first locking groove 634a is arranged around a part of the first pin shaft 634 outside the first insertion groove 633a.

Specifically, as shown in FIG. 57 to FIG. 59, the first disassembly mechanism 690 includes a first locking member 691 and a locking reset member 692. The first locking member 691 has a substantially sheet-like structure, and a first locking hole 691a is provided in a substantially middle portion of the first locking member 691. A radial dimension of the first locking hole 691a is greater than that of the first pin shaft 634. The first locking member 691 is movably arranged in the support member 610, and the first locking member 691 is switchable between the first lock position and the first unlock position. Specifically, a first accommodating cavity 617a and a second accommodating cavity 617b are arranged inside the support member 610. A cavity wall of the first accommodating cavity 617a is provided with a first perforation 618a and a second perforation 618b opposite to each other. The first accommodating cavity 617a and the second accommodating cavity 617b are in communication through the first perforation 618a, and the second perforation 618b communicates the first accommodating cavity 617a with the outside of the support member 610. The first locking member 691 has one end located in the second accommodating cavity 617b and the other end passing through the first perforation 618a and inserted into the first accommodating cavity 617a. In this embodiment, the other end of the first locking member 691 may pass through the second perforation 618b and be located outside the support member 610. Certainly, in other embodiments, the other end of the first locking member 691 may not extend out of the support member 610. A part of the first locking member 691 with the first locking hole 691a is generally located in the first accommodating cavity 617a.

Further, as shown in FIG. 58 to FIG. 60, the locking reset member 692 is arranged between the first locking member 691 and the support member 610, and the locking reset member 692 is configured to bias the first locking member 691 to move to the first lock position. Specifically, the locking reset member 692 is arranged in the second accommodating cavity 617b. The locking reset member 692 has one end abutting against the first locking member 691 and the other end abutting against a first cavity wall 619a of the second accommodating cavity 617b. The first cavity wall 619a is arranged opposite to the first perforation 618a.

As shown in FIG. 58 to FIG. 60, an end portion of the first pin shaft 634 with the first locking groove 634a can be inserted into the first accommodating cavity 617a in the support member 610 and pass through the first locking hole 691a. When the first locking member 691 is at the first lock position, a hole wall of the first locking hole 691a is inserted into the first locking groove 634a. In this embodiment, the support member 610 is provided with an insertion port 617c in communication with the first accommodating cavity 617a, and the end portion of the first pin shaft 634 with the first locking groove 634a is inserted into the first accommodating cavity 617a through the insertion port 617c and abuts against a second cavity wall 619b of the first accommodating cavity 617a. The second cavity wall 619b is arranged opposite to the insertion port 617c. In this way, an insertion position of the first pin shaft 634 in the support member 610 can be limited. After the first pin shaft 634 is inserted in place, the first pin shaft 634 passes through the first locking hole 691a, and a position of the first locking groove 634a of the first pin shaft 634 corresponds to the first locking member 691. In this case, if the first locking member 691 is at the first lock position, as shown in FIG. 58, the hole wall of the first locking hole 691a is inserted into the first locking groove 634a, and the footrest assembly 630 is mounted and fixed to the support member 610. If the first locking member 691 is at the first unlock position, as shown in FIG. 59, the hole wall of the first locking hole 691a is detached from the first locking groove 634a, and the footrest assembly 630 may be disassembled from the support member 610.

Further, the other end of the first locking member 691 is located outside the support member 610. In this way, a part of the first locking member 691 extending out of the support member 610 is operable to move from the first lock position to the first unlock position. Alternatively, when the end portion of the first pin shaft 634 with the first locking groove 634a is inserted into the support member 610, the first pin shaft 634 can move the first locking member 691 so that the first locking member 691 overcomes an elastic force of the locking reset member 692 and moves from the first lock position to the first unlock position.

Further, an extension direction of the first pin shaft 634 intersects with a movement direction of the first locking member 691. That is, the extension direction of the first pin shaft 634 and the movement direction of the first locking member 691 are arranged at an angle. In this embodiment, the extension direction of the first pin shaft 634 and the movement direction of the first locking member 691 are perpendicular to each other.

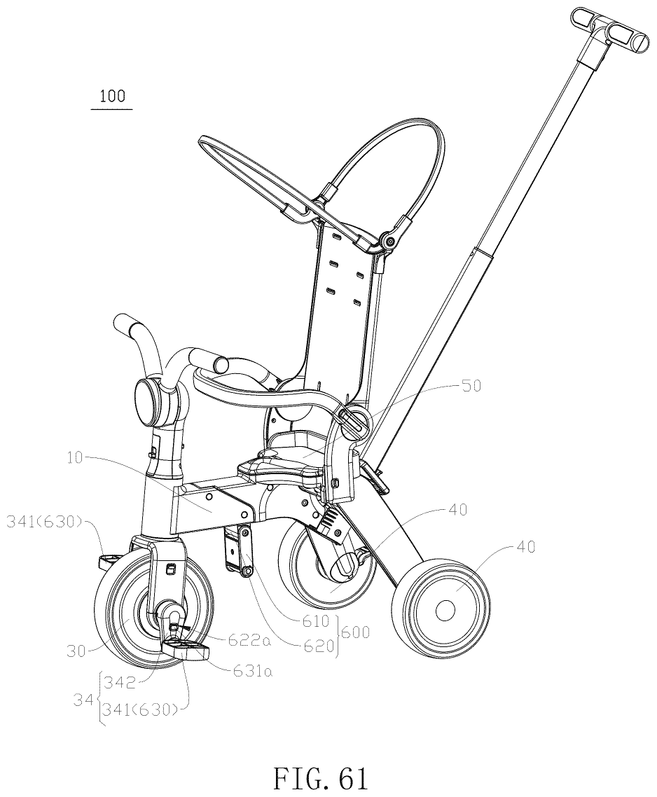

In this embodiment, since the two footrest assemblies 630 are detachably connected to two sides of the support member 610, compared with the first embodiment, the support member 610 in this embodiment is not required to be provided with the synchronization mechanism 660 and the fixed assembly 650, and the footrest device 600 is not required to be provided with the first pivot shaft 641 and the second pivot shaft 642. In addition, as shown in FIG. 61 to FIG. 64, structures of the support member 610 and the connecting member 620 in this embodiment are the same as those in the first embodiment. The positioning mechanism 670 is also used between the support member 610 and the connecting member 620 to fix the support member 610 between at least two rotation positions relative to the connecting member 620.

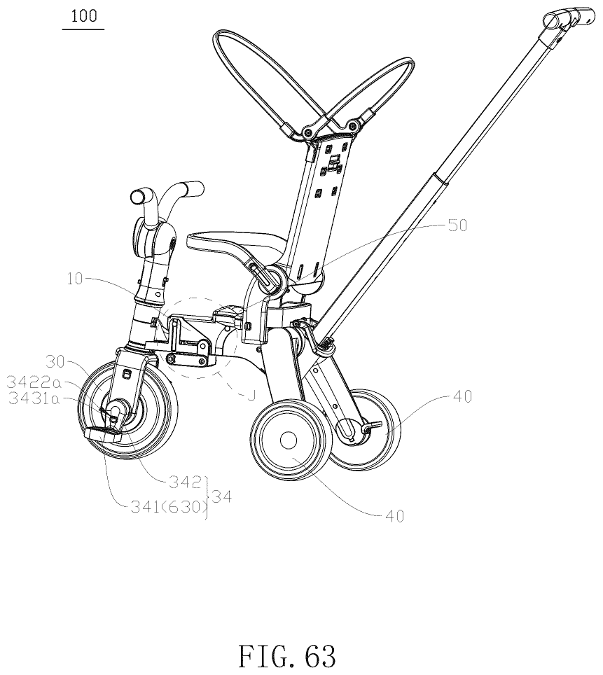

When the footrest device 600 in the third embodiment and the fourth embodiment is in the use state, the support member 610 is rotated to a first rotation position (as shown in FIG. 61) away from the frame body 10, and the footrest assembly 630 is in an unfolded state or mounted on the support member 610 so that the child can place the feet on the footrest assembly 630 to take a rest without making the child too tired because the feet are hung or riding for a long time. When the footrest device 600 is in the non-use state, the support member 610 may be rotated to a second rotation position (as shown in FIG. 63) close to the frame body 10, and at the same time, the footrest assembly 630 is in the folded state or disassembled from the support member 610, so that the footrest assembly 630 may not interfere with the child's riding process, and the child carrier is neater and more beautiful as a whole.

According to one aspect of the present disclosure, a child carrier 100 is provided, including a frame body 10, a leading assembly 20, a front wheel assembly 30, a rear wheel assembly 40, a push rod 60 and a traction assembly 70. The leading assembly 20 is rotatably connected to the frame body 10. The front wheel assembly 30 has a front wheel 31 and a front fork 32. The front fork 32 is coaxially connected to the leading assembly 20 and configured to be selectively fixedly connected or rotatably connected to the leading assembly 20. The rear wheel assembly 40 is connected to the frame body 10. The push rod 60 is rotatably arranged at a rear end of the frame body 10. The traction assembly 70 is connected between the front fork and the push rod 60, so that the push rod 60 controls a rotation direction of the front wheel assembly 30 through rotation.

In one of the embodiments, the front wheel assembly 30 includes an axle, a wheel, a generator assembly 520, a first driving component 560 and a first operating member 540. The wheel has a rim 310 and a hub mounted on the axle to support the rim 310. The generator assembly 520 is mounted in the wheel and configured to be rotatably supported by the axle and selectively receive torque from the axle. The first driving component 560 is slidably arranged on the axle and rotates synchronously with the axle. The first operating member 540 is connected to the first driving component 560 and moves between a first position and a second position to cause the first driving component 560 to slide along the axle. The first driving component 560 is configured to enable the generator assembly 520 to receive torque generated by rotation of the axle when the first operating member 540 is at the first position and to disable the generator assembly 520 from receiving the torque generated by the rotation of the axle when the first operating member 540 is at the second position.

In one of the embodiments, the wheel assembly further includes a fork, a supporting member 510 and a transmission gear 512. The fork has at least a first fork arm 3211 and a second fork arm 3212 respectively connected to two sides of the wheel and connected to each other. The supporting member 510 supports the generator assembly 520 and is configured to be fixed relative to the first fork arm 3211 and rotatably supported by the axle. The transmission gear 512 is slidably mounted on the axle and rotates synchronously with the axle. The hub includes a first hub 311 and a second hub 312 connected to each other, and the generator assembly 520 includes an input shaft 521 and a drive gear 522 selectively engaged with the transmission gear 512. At least part of the first driving component 560 is arranged between the supporting member 510 and the transmission gear 512, and the first driving component 560 is configured to drive the transmission gear 512 to slide to be disengaged from the drive gear 522.

In one of the embodiments, the first operating member 540 is vertically arranged in the first fork arm 3211 and is capable of sliding up and down relative to the first fork arm 3211. The first operating member 540 is configured to clamp an extending end 511 of the supporting member 510 to prevent rotation of the supporting member 510, and/or push the first driving component 560 to slide along the axle to disengage the transmission gear 512 from the drive gear 522.

In one of the embodiments, the first driving component 560 includes at least one rod-shaped portion 562 extending along the axle. The at least one rod-shaped portion 562 is configured to pass through the supporting member 510 to contact the first operating member 540. A tail end of the at least one rod-shaped portion 562 is configured to be pushed by a lower end 543 of the first operating member 540 to push the transmission gear 512 along the axle to be disengaged from the drive gear 522. The tail end of the at least one rod-shaped portion 562 and/or the lower end 543 of the first operating member 540 are/is formed as an inclined slope or a curved surface.

In one of the embodiments, the wheel assembly includes a first axle sleeve 596 and a first elastic member 580. The first axle sleeve 596 is fixed to the axle, rotatably supports the second hub 312, and axially abuts against the second hub 312. The first elastic member 580 arranged between the transmission gear 512 and the first axle sleeve 596 to apply an elastic force to the transmission gear 512.

In one of the embodiments, the first fork arm 3211 includes a first fork arm body 3210 and a first fork arm housing to form a space in the first fork arm 3211 to accommodate at least the first operating member 540. A first opening 3216 is formed in the first fork arm housing, and the first operating member 540 includes a first body part 542, a first operating button 541 and a first positioning assembly. The first body part 542 extends vertically and has a lower end 543 clamping an extending end 511 of the supporting member 510. The first operating button 541 is arranged on the first body part 542 and exposed through the first opening 3216. The first positioning assembly is movably arranged between the first body part 542 and the first fork arm body 3210 to position the first operating. One of the first body part 542 and the first fork arm body 3210 is provided with a first positioning concave portion 3201 and a second positioning concave portion 3202 for accommodating part of the first positioning assembly. The first positioning concave portion 3201 corresponds to one of the first position and the second position, and the second positioning concave portion 3202 corresponds to the other of the first position and the second position.

In one of the embodiments, the wheel assembly includes a second driving component 570 and a second operating member 550. The second driving component 570 is slidably arranged on the axle and rotates synchronously with the axle. The second operating member 550 contacts the second driving component 570 and moves between a third position and a fourth position to cause the second driving component 570 to slide along the axle. The second driving component 570 is configured to be engaged with the second hub 312 so as to transmit torque between the wheel and the axle when the second operating member 550 is at the third position, and to be disengaged from the second hub 312 so as not to transmit the torque between the wheel and the axle when the second operating member 550 is at the fourth position.

In one of the embodiments, the second operating member 550 is vertically arranged in the second fork arm 3212 and is capable of sliding up and down relative to the second fork arm 3212. The second operating member 550 is configured to push the second driving component 570 to slide along the axle to be disengaged from the second hub 312. At least one contact surface between the second driving component 570 and the second operating member 550 is shaped as a slope or a curved surface.

In one of the embodiments, the second fork arm 3212 includes a second fork arm body 3210 and a second fork arm housing to form a space in the second fork arm 3212 to accommodate at least the second operating member 550. A second opening 3215 is formed in the second fork arm housing, and the second operating member 550 includes a second body part 552, a second operating button 551 and a second positioning assembly. The second body part 552 extends vertically and has a lower end 543 slidably contacting the second driving component 570. The second operating button 551 is arranged on the second body part 552 and exposed through the second opening 3215. The second positioning assembly is movably arranged between the second body part 552 and the second fork arm body 3210 to position the second operating. One of the second body part 552 and the second fork arm body 3210 is provided with a third positioning recess and a fourth positioning recess for accommodating part of the second positioning assembly. The third positioning recess corresponds to one of the third position and the fourth position, and the fourth positioning recess corresponds to the other of the third position and the fourth position.

In one of the embodiments, the wheel assembly includes a second axle sleeve 595 and a second elastic member 590. The second axle sleeve 595 is fixed to the axle, rotatably supports the second hub 312, and axially abuts against the second hub 312. The second elastic member 590 is arranged between the second driving component 570 and the second axle sleeve 595 to apply an elastic force to the second driving component 570.

In one of the embodiments, the fork further includes a rotating base 322 configured to be connected to a corresponding connecting portion of a child carrier 100. The rotating base 322 is arranged between the first fork arm 3211 and the second fork arm 3212.

In one of the embodiments, the wheel assembly further includes a rectifier 530 connected to the generator assembly 520 through an electric wire 501. The rectifier 530 is mounted in an internal space 320 formed at a lower end 543 of the rotating base 322, and the electric wire 501 passes through the supporting member 510 and the first fork arm 3211 and is connected to the rectifier 530.

In one of the embodiments, the electric wire 501 passes around the axle and the first operating member 540 in the first fork arm 3211 and goes up to the internal space 320 where the rectifier 530 is mounted.

In one of the embodiments, the axle includes a cylindrical section and a non-cylindrical section. The supporting member 510 or both the first driving component 560 and the supporting member 510 are mounted on the cylindrical section to be rotatably supported by the axle.

In one of the embodiments, a limiting rib 519 is formed on an outer peripheral surface of the supporting member 510 to abut against an inner side of the first hub 311.

In one of the embodiments, the second driving component 570 includes a body part 571 in a frustoconical shape and at least one engaging portion 573 axially and/or radially protruding from the body part 571. The second hub 312 has at least one slot 3127 engaged with the at least one engaging portion 573, or the second driving component 570 includes a body part 571 in a frustoconical shape and at least one slot 3127 formed on the body part 571 and axially and/or radially recessed, and the second hub 312 has at least one engaging portion 3128 engaged with the at least one slot 3127.

In one of the embodiments, the second hub 312 has a central recessed part 3125 to accommodate the second driving component 570 disengaged from the second hub 312. The second hub 312 is rotatably supported by the axle.

In one of the embodiments, the second hub 312 has a central recessed part 3125 to accommodate the second driving component 570 disengaged from the second hub 312.

An inner periphery of the central recessed part 3125 is rotatably supported by the axle, the second axle sleeve 595 axially abuts against an inner side of the second hub 312, and the second axle sleeve 595 axially abuts against an outer side of the second hub 312.

In one of the embodiments, the generator assembly 520 includes a micro motor and a reducer.

In one of the embodiments, the wheel assembly further includes a pair of pedal devices 34 respectively mounted to an outer side of the first fork arm 3211 and an outer side of the second fork arm 3212 and connected to two ends of the axle.

In one of the embodiments, the wheel assembly includes an axle, a wheel, a second driving component 570 and a second operating member 550. The wheel has a rim 310, and a first hub 311 and a second hub 312 mounted on the axle to support the rim 310. The second driving component 570 is slidably arranged on the axle and rotates synchronously with the axle. The second operating member 550 contacts the second driving component 570 and moves between a third position and a fourth position to cause the second driving component 570 to slide along the axle. The second driving component 570 is configured to be engaged with the second hub 312 so as to transmit torque between the wheel and the axle when the second operating member 550 is at the third position, and to be disengaged from the second hub 312 so as not to transmit the torque between the wheel and the axle when the second operating member 550 is at the fourth position.

In one of the embodiments, the wheel assembly further includes a fork connected to two sides of the wheel and a generator assembly 520 arranged in the wheel and fixed relative to the fork. The generator assembly 520 is configured to selectively receive torque from the axle.

In one of the embodiments, the wheel assembly further includes a pair of pedal devices 34 respectively mounted to an outer side of the fork and connected to two ends of the axle.

In one of the embodiments, the wheel assembly is a front wheel assembly 30.

In one of the embodiments, the child carrier 100 further includes a frame body 10 and a leading assembly 20, a seat 50, and a rear wheel assembly 40 that are connected to the frame body 10. The leading assembly 20 is fixedly or rotatably connected to the wheel assembly.

In one of the embodiments, the child carrier 100 further includes a first connecting member 11. The leading assembly 20 and the wheel assembly are connected to the frame body 10 through the first connecting member 11.

In one of the embodiments, the child carrier 100 further includes a push rod 60 and a traction assembly 70. The push rod 60 is arranged behind the seat 50, and the traction assembly 70 is connected between the push rod 60 and the front wheel assembly 30 to control steering of the front wheel assembly 30 by rotating the push rod 60.

In one of the embodiments, the child carrier 100 further includes a second connecting member 12. The push rod 60 is connected to the frame body 10 or connected to both the frame body 10 and the rear wheel assembly 40 through the second connecting member 12.

In one of the embodiments, the rear wheel assembly 40 includes a rear wheel 41 and a rear wheel stand 42 connected to the frame body 10. The rear wheel 41 is connected to the rear wheel stand 42.

In one of the embodiments, the rear wheel assembly 40 has a same structure as the aforementioned wheel assembly.

In one of the embodiments, the child carrier 100 further has at least one of a rechargeable battery, a light-emitting module, a sound-generating module, and a USB interface 130.

According to one aspect of the present disclosure, a child carrier 100 is provided, including a frame body 10, a leading assembly 20, a front wheel assembly 30, a rear wheel assembly 40, a push rod 60 and a traction assembly 70. The leading assembly 20 is rotatably connected to the frame body 10. The front wheel assembly 30 has a front wheel 31 and a front fork 32. The front fork 32 is coaxially connected to the leading assembly 20 and configured to be selectively fixedly connected or rotatably connected to the leading assembly 20. The rear wheel assembly 40 is connected to the frame body 10. The push rod 60 is rotatably arranged at a rear end of the frame body 10. The traction assembly 70 is connected between the front fork 32 and the push rod 60, so that the push rod 60 controls a rotation direction of the front wheel assembly 30 through rotation.

In one of the embodiments, the child carrier 100 further includes a footrest device 600 including a support member 610 and a footrest assembly 630. The support member 610 is configured to be connected to the frame body 10. The support member 610 is switchable between a first rotation position and a second rotation position. When the support member 610 is switched from the first rotation position to the second rotation position, the support member 610 is folded in a direction close to the frame body 10. The footrest assembly 630 is adapted to be pivotally or removably connected to the support member 610. When the footrest assembly 630 is adapted to be pivotally connected to the support member 610, the footrest assembly 630 is switchable between an unfold state and a folded state. When the footrest assembly 630 is in the unfolded state, the footrest assembly 630 is adapted to carry a child's foot. When the footrest assembly 630 is in the folded state, the footrest assembly 630 is folded in a direction close to the frame body 10. The footrest device 600 has a use state and a non-use state. When the footrest device 600 is in the use state, the support member 610 is in the first rotation position, and the footrest assembly 630 is in the unfolded state or mounted on the support member 610. When the footrest device 600 is in the non-use state, the support member 610 is in the second rotation position, and the footrest assembly 630 is in the folded state or detached from the support member 610.

In one of the embodiments, the footrest assembly 630 is capable of being connected to a pedal base 342 of a child carrier 100 to serve as a pedal assembly 341 for a child to drive the child carrier 100 forward.

In one of the embodiments, the footrest assembly 630 includes a footrest body 633 and a first pin shaft 634. The footrest body 633 is configured to carry the child's feet. The first pin shaft 634 is connected to the footrest body 633. An end portion of the first pin shaft 634 is surrounded by a first locking groove 634a. The footrest device 600 further includes a first disassembly mechanism 690, the first disassembly mechanism 690 includes a first locking member 691 and a locking reset member 692. The first locking member 691 is movably arranged on the support member 610. The first locking member 691 is switchable between a first lock position and first unlock position. The first locking member 691 has a first locking hole 691a, and a radial dimension of the first locking hole 691a is greater than that of the first pin shaft 634. The locking reset member 692 is arranged between the first locking member 691 and the support member 610. The locking reset member 692 biases the first locking member 691 to move to the first lock position. An end portion of the first pin shaft 634 with the first locking groove 634a is capable of being inserted into the support member 610 and passing through the first locking hole 691a, and when the first locking member 691 is at the first lock position, a hole wall of the first locking hole 691a is inserted into the first locking groove 634a.

In one of the embodiments, at least part of the first locking member 691 extends out of the support member 610, and the part of the first locking member 691 extending out of the support member 610 is operable to move from the first lock position to the first unlock position. When the end portion of the first pin shaft 634 with the first locking groove 634a is inserted into the support member 610, the first pin shaft 634 is capable of moving the first locking member 691 so that the first locking member 691 moves from the first lock position to the first unlock position.

In one of the embodiments, the first pin shaft 634 is partially inserted into the footrest assembly 630, the end portion of the first pin shaft 634 with the first locking groove 634a extends out of the footrest assembly 630, and an extension direction of the first pin shaft 634 intersects with a movement direction of the first locking member 691.

In one of the embodiments, the footrest device 600 further includes a connecting member 620. The connecting member 620 is fixedly connected to the frame body 10. The support member 610 is pivotally connected to the connecting member 620.

In one of the embodiments, the footrest device 600 further includes a positioning mechanism 670. The positioning mechanism 670 includes a first positioning portion, a second positioning portion, and a third positioning portion. The first positioning portion and the second positioning portion is arranged on one of the support member 610 and the connecting member 620. The third positioning member is arranged on the other of the support member 610 and the connecting member 620. When the support member 610 is at the first rotation position, the third positioning member is locked with the first positioning portion, and when the support member 610 is at the second rotation position, the third positioning member is locked with the second positioning portion.

In one of the embodiments, the footrest device 600 further includes a positioning mechanism 670. The positioning mechanism 670 includes a first positioning recess 671, a second positioning recess 672, and a positioning protrusion 673. The first positioning recess 671 and the second positioning recess 672 are arranged on one of the support member 610 and the connecting member 620. The positioning protrusion 673 is movably arranged on the other of the support member 610 and the connecting member 620. The positioning protrusion 673 has a first movement position and a second movement position. When the positioning protrusion 673 is at the first movement position, the positioning protrusion 673 is engaged with the first positioning recess 671 or the second positioning recess 672, and when the positioning protrusion 673 is at the second movement position, the positioning protrusion 673 is disengaged from the first positioning recess 671 or the second positioning recess 672.

In one of the embodiments, the first positioning recess 671 and the second positioning recess 672 are a first positioning groove and a second positioning groove respectively, and the positioning protrusion 673 is a ball.

In one of the embodiments, the positioning mechanism 670 further includes a positioning reset member 674. The positioning reset member 674 is arranged between the positioning protrusion 673 and the support member 610, and the positioning reset member 674 biases the positioning protrusion 673 to move towards the first movement position.

In one of the embodiments, the wheel assembly includes a support body 616 and a first pivot portion 615. The support body 616 is configured to be connected to the footrest assembly 630. The first pivot portion 615 protrudes from the support body 616. The first pivot portion 615 has a first side surface 615b. The first side surface 615b is provided with the first positioning recess 671 and the second positioning recess 672. The connecting member 620 includes a second pivot portion 622. The second pivot portion 622 pivotally connected to the first pivot portion 615 through a rotating shaft 643. The second pivot portion 622 has a second side surface 622b facing the first side surface 615b. The second side surface 622b is provided with a mounting groove 622a. The positioning protrusion 673 is movably arranged in the mounting groove 622a. When the positioning protrusion 673 is at the first movement position, at least part of the positioning protrusion 673 is capable of extending out of the mounting groove 622a to be engaged with the first positioning recess 671 or the second positioning recess 372, and when the positioning protrusion 673 is at the second movement position, the positioning protrusion 673 is capable of retracting into the mounting groove 622a to be disengaged from the first positioning recess 671 or the second positioning recess 672.

In one of the embodiments, the first positioning recess 671 and the second positioning recess 672 are arranged around the rotating shaft 643; and an extension direction of the mounting groove 622a is parallel to a length direction of the rotating shaft 643.

In one of the embodiments, the support member 610 includes two first pivot portions 615 arranged opposite to each other. Two sides of the second pivot portion 622 are pivotally connected to the two first pivot portions 615 through the rotating shaft 643. Two second side surfaces of the second pivot portion 622 opposite to the two first pivot portions 615 are both provided with the mounting groove 622a. Two positioning mechanism 670s are provided and are respectively arranged between the second pivot portion 622 and the two first pivot portions 615.

In one of the embodiments, the footrest device 600 further includes a positioning mechanism 670. The positioning mechanism 670 includes a first positioning portion, a second positioning portion, and a third positioning portion. The first positioning portion and the second positioning portion are arranged on one of the support member 610 and the connecting member 620. The third positioning member is arranged on the other of the support member 610 and the connecting member 620, and the first positioning portion and the second positioning portion are configured to be magnetically locked with the third positioning portion.

In one of the embodiments, the footrest assembly 630 includes at least a first footrest 631 and a second footrest 632. The first footrest 631 and the second footrest 632 are pivotally connected to opposite sides of the support member 610, respectively.

In one of the embodiments, the footrest device 600 further includes a synchronization mechanism 660 including a first driving member 661 connected to a first footrest 631 and a second driving member 662 connected to a second footrest 632. The first drive member 661 and the second drive member 662 are drivingly connected.

In one of the embodiments, the footrest device 600 further includes a synchronization mechanism 660 including a first driving member 661 connected to the first footrest 631 and a second driving member 662 connected to the second footrest 632. The first driving member 661 has a first wheel tooth portion 661a, the second drive member 662 has a second wheel tooth portion 662a, and the first wheel tooth portion 661a and the second wheel tooth portion 662a are engaged with each other.

In one of the embodiments, the footrest device 600 further includes a first pivot shaft 641 and a second pivot shaft 642. Each of the first driving member 661 and the first footrest 631 is fixedly connected to the first pivot shaft 641. The first pivot shaft 641 is rotatably connected to the support member 610. Each of the second driving member 662 and the second footrest 632 is fixedly connected to the first pivot shaft 641, and the second pivot shaft 642 is rotatably connected to the support member 610.

In one of the embodiments, the footrest assembly 630 is pivotally connected to the support member 610, and the footrest device 600 further includes a fixed assembly 650 including a first magnetic portion 651 and a second magnetic portion 652. The first magnetic portion 651 is disposed to the footrest assembly 630. The second magnetic portion 652 is disposed on the support member 610. When the footrest body 633 is in the folded state, the first magnetic portion 651 and the second magnetic portion 652 can be adsorbed together.

In one of the embodiments, the footrest assembly 630 is pivotally connected to the support member 610, and the footrest device 600 further includes a fixed assembly 650 including a permanent magnet and a rotating shaft 643. The permanent magnet is disposed on the footrest assembly 630. The support member 610 is pivotally connected to the frame body 10 by a rotating shaft 643 made of a ferromagnetic material. When the footrest body 633 is in the folded state, the permanent magnet can be adsorbed to the rotating shaft 643.

In one of the embodiments, the footrest assembly 630 and the support member 610 are pivotally connected at the first pivot shaft 641, and the support member 610 and the connecting member 620 are pivotally connected at the rotating shaft 643. The rotating shaft 643 is spaced apart from and non-parallel to the first pivot shaft 641.

In one of the embodiments, the child carrier 100 further includes a pedal device 34 including a pedal assembly 341, a pedal base 342, and a second disassembly mechanism 343. The pedal base 342 is connected to a wheel assembly. The pedal assembly 341 is detachably connected to the pedal base 342 by a second disassembly mechanism 343.

In one of the embodiments, the pedal assembly 341 is a same component as the footrest assembly 630.

In one of the embodiments, the pedal assembly 341 is provided with a second locking groove 3412a. The second disassembly mechanism 343 includes a second locking member 3434 movably arranged on the pedal base 342. The second locking member 3434 has a first movable position and a second movable position. When the second locking member 3434 is at the first movable position, the second locking member 3434 is capable of being inserted into the second locking groove 3412a so that the pedal assembly 341 is fixedly connected to the pedal base 342, and when the second locking member 3434 is at the second movable position, the second locking member 3434 is detached from the second locking groove 3412a, and the pedal assembly 341 is detachable from the pedal base 342.

In one of the embodiments, the pedal assembly 341 includes a pedal body 3411 and a second pin shaft 3412 connected to each other. The second pin shaft 3412 is provided with a second locking groove 3412a, and the second disassembly mechanism 343 includes a second locking member 3434 movably arranged on the pedal base 342. The second locking member 3434 has a second locking hole 3434a. A radial dimension of the second locking hole 3434a is greater than that of the second pin shaft 3412. The second pin shaft 3412 passes through the second locking hole 3434a. A position of the second locking groove 3412a corresponds to the second locking hole 3434a. The second locking member 3434 has a first movable position and a second movable position. When the second locking member 3434 is at the first movable position, part of a hole wall of the second locking hole 3434a is inserted into the second locking groove 3412a, and when the second locking member 3434 is at the second movable position, the hole wall of the second locking hole 3434a is detached from the second locking groove 3412a.

In one of the embodiments, the wheel assembly includes a second driving component 570 and a second operating member 550. The operating member 3431 is fixedly connected to the second locking member 3434. The operating member 3431 is operated to move the second locking member 3434 from the first movable position to the second movable position. The operation reset member 3432 is arranged between the operating member 3431 and the pedal base 342. The operation reset member 3432 biases the operating member 3431 so that the operating member 3431 drives the second locking member 3434 to move to the first movable position.

In one of the embodiments, the child carrier 100 includes a wheel assembly rotatably connected to the frame body 10, and the pedal base 342 includes a first housing 3421 and a second housing 3422. The first housing 3421 is connected to a wheel assembly. The first housing 3421 is provided with an accommodating groove 3421a and an accommodating boss 3421b. The accommodating boss 3421b is provided with an accommodating cavity 3421c that runs through the accommodating boss 3421b. A first groove wall 3421f of the accommodating groove 3421a is provided with an insertion hole 3421d. The accommodating groove 3421a is in communication with the accommodating cavity 3421c through the insertion hole 3421d. The second housing 3422 has an operating hole 3422a and a mounting hole 3422b arranged at intervals. The first housing 3421 and the second housing 3422 are interlocked to form a mounting cavity. The accommodating groove 3421a and the accommodating boss 3421b are located in the mounting cavity. The accommodating boss 3421b passes through the mounting hole 3422b and protrudes from an outer surface of the second housing 3422. At least part of the second pin shaft 3412 is inserted into the accommodating cavity 3421c. The second locking member 3434 and at least part of the operating member 3431 are movably arranged in the mounting cavity. At least part of the second locking member 3434 is inserted into the accommodating cavity 3421c through the insertion hole 3421d so as to fit or unfit the second locking groove 3412a of the second pin shaft 3412, and at least part of the operating member 3431 extends out of the mounting cavity through the operating hole 3422a.

In one of the embodiments, two ends of the operation reset member 3432 abut against the operating member 3431 and a second groove wall 3421g of the accommodating groove 3421a respectively, and the second groove wall 3421g is arranged opposite to the first groove wall 3421f.

In one of the embodiments, the first groove wall 3421f forms a first limiting portion 3421e, the operating member 3431 is provided with a second limiting portion 3431b, and when the second locking member 3434 is at the first movable position, the first limiting portion 3421e abuts against the second limiting portion 3431b.

In one of the embodiments, at least two pedal devices 34 are provided. The at least two pedal devices 34 are drivingly connected to two sides of a wheel assembly respectively.

In one of the embodiments, the pedal device 34 includes a pedal assembly 341, a pedal base 342, and a second disassembly mechanism 343. The pedal base 342 is connected to a wheel assembly. The pedal assembly 341 is detachably connected to the pedal base 342 by a second disassembly mechanism 343. According to one aspect of the present disclosure, a child carrier 100 is provided, including: a frame body 10, a leading assembly 20, a front wheel assembly 30, a rear wheel assembly 40, a push rod 60 and a traction assembly 70. The leading assembly 20 is rotatably connected to the frame body 10; The front wheel assembly 30 has a front wheel 31 and a front fork 32. The front fork 32 is coaxially connected to the leading assembly 20 and configured to be selectively fixedly connected or rotatably connected to the leading assembly 20. The rear wheel assembly 40 is connected to the frame body 10. The push rod 60 is rotatably arranged at a rear end of the frame body 10. The traction assembly 70 is connected between the front fork 32 and the push rod 60, so that the push rod 60 controls a rotation direction of the front wheel assembly 30 through rotation.

According to one aspect of the present disclosure, a child carrier 100 is provided, including: a frame body 10, a leading assembly 20, a front wheel assembly 30, a rear wheel assembly 40, a push rod 60 and a traction assembly 70. The leading assembly 20 is rotatably connected to the frame body 10; The front wheel assembly 30 has a front wheel 31 and a front fork 32. The front fork 32 is coaxially connected to the leading assembly 20 and configured to be selectively fixedly connected or rotatably connected to the leading assembly 20. The rear wheel assembly 40 is connected to the frame body 10. The push rod 60 is rotatably arranged at a rear end of the frame body 10. The traction assembly 70 is connected between the front fork 32 and the push rod 60, so that the push rod 60 controls a rotation direction of the front wheel assembly 30 through rotation.

In one of the embodiments, the child carrier 100 includes a footrest device 600 including a footrest body 633. The footrest body 633 is connected to the frame, and has an unfolded state and a folded state. When the footrest body 633 is in the unfolded state, the footrest body 633 is configured to carry a child's foot.

In one of the embodiments, the footrest device 600 further includes a support member 610. The support member 610 is configured to be connected to the frame. The footrest body 633 is rotatably connected to the support member 610. The footrest body 633 has an unfolded state and a folded state with respect to the support member 610. When the footrest body 633 is in the unfolded state, the footrest body 633 is configured to carry the child's foot. When the footrest body 633 is in the folded state, the footrest body 633 is folded close to the support member 610.

In one of the embodiments, the footrest device 600 further includes a support member 610. The support member 610 is configured to be connected to the frame. The footrest body 633 includes at least a first footrest 631 and a second footrest 632. The first footrest 631 and the second footrest 632 are rotatably connected to opposite sides of the support member 610. Each of the first footrest 631 and the second footrest 632 has an unfolded state and a folded state with respect to the support member 610. When the first footrest 631 or the second footrest 632 is in the unfolded state, the first footrest 631 or the second footrest 632 is configured to carry the child's foot, and when the first footrest 631 or the second footrest 632 is in the folded state, the first footrest 631 or the second footrest 632 is folded close to the support member 610.

In one of the embodiments, the footrest device 600 further includes a synchronization mechanism 660. The synchronization mechanism 660 is arranged between the first footrest 631 and the second footrest 632, and is configured to realize synchronous rotation of the first footrest 631 and the second footrest 632.

In one of the embodiments, the footrest device 600 further includes a support member 610 and a connecting member 620. The support member 610 is configured to be connected to the frame. The footrest body 633 is rotatably connected to the support member 610. The connecting member 620 is configured to be connected to the frame. The support member 610 is rotatably connected to the connecting member 620, and the support member 610 has a first rotation position and a second rotation position with respect to the connecting member 620. When the support member 610 is in the first rotation position and the footrest body 633 is in the unfolded state, the footrest body 633 is configured to carry the child's foot, and when the support member 610 is in the second rotation position, the support member 610 is folded in a direction close to the frame.

In one of the embodiments, the footrest body 633 and the support member 610 are pivotally connected at the first pivot shaft 641, and the support member 610 and the connecting member 620 are pivotally connected at the rotating shaft 643. The rotating shaft 643 is spaced apart from and non-parallel to the first pivot shaft 641.

In one of the embodiments, the rotating shaft 643 is perpendicular to the first pivot shaft 641.

In one of the embodiments, the footrest device 600 further includes a positioning mechanism 670. The positioning mechanism 670 is arranged between the support member 610 and the connecting member 620 and is configured to fix the support member 610 to the first rotation position or the second rotation position with respect to the connecting member 620.

In one of the embodiments, the footrest device 600 further includes a positioning mechanism 670. The positioning mechanism 670 includes a first positioning portion, a second positioning portion, and a third positioning portion. The first positioning portion and the second positioning portion are arranged on one of the support member 610 and the connecting member 620. The third positioning member is arranged on the other of the support member 610 and the connecting member 620, and the first positioning portion and the second positioning portion are configured to be magnetically locked with the third positioning portion.

In one of the embodiments, the footrest device 600 further includes a support member 610. The support member 610 is rotatably connected to the frame. The footrest body 633 is connected to the support member 610. The support member 610 has a first rotation position and a second rotation position. When the support member 610 is in the first rotation position and the footrest body 633 is in the unfolded state, the footrest body 633 is configured to carry the child's foot, and when the support member 610 is in the second rotation position, the support member 610 is folded in a direction close to the frame body 10. In one of the embodiments, the footrest device 600 further includes a support member 610 and a connecting member 620. The connecting member 620 is connected to the frame. The support member 610 is rotatably connected to the connecting member 620. The support member 610 has a first rotation position and a second rotation position with respect to the connecting member 620. When the support member 610 is in the first rotation position, the footrest body 633 is capable of carrying the child's foot, and when the support member 610 is in the second rotation position, the footrest body 633 is folded in a direction close to the frame.

In one of the embodiments, the second disassembly mechanism 343 includes a first locking portion disposed in one of the pedal assembly 341 and the pedal base 342, and a second locking portion movably disposed in the other of the pedal assembly 341 and the pedal base 342. When the first locking portion and the second locking portion are engaged, the pedal assembly 341 and the pedal base 342 are fixedly connected, and when the first locking portion and the second locking portion are disengaged, the pedal assembly 341 can be disassembled from the pedal base 342.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the invention. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. A child carrier, comprising:
a frame body;
a leading assembly rotatably connected to the frame body;
a front wheel assembly having a front wheel and a front fork, the front fork being coaxially connected to the leading assembly and configured to be selectively fixedly connected or rotatably connected to the leading assembly;
a rear wheel assembly connected to the frame body;
a push rod rotatably arranged at a rear end of the frame body; and
a traction assembly connected between the front fork and the push rod, so that the push rod controls a rotation direction of the front wheel assembly through rotation.

2. The child carrier according to claim 1, wherein the front fork further comprises:
a pair of fork arms configured to be coupled to two opposite sides of the front wheel respectively; and
a rotating base connected between the pair of fork arms and selectively rotatably connected or fixedly connected to the leading assembly,
wherein the traction assembly is connected between the rotating base and the push rod, and the push rod drives, through the traction assembly, the rotating base to rotate.

3. The child carrier according to claim 2, wherein the traction assembly further comprises a two-way traction cable connected between the rotating base and the push rod, end coupling protrusions arranged at two ends of the two-way traction cable, and an intermediate coupling protrusion arranged on a middle section of the two-way traction cable,
wherein one of the end coupling protrusions and the intermediate coupling protrusion is fixed to the push rod, and the other of the end coupling protrusions and the intermediate coupling protrusion is mounted to the rotating base.

4. The child carrier according to claim 3, wherein one of the rotating base and the push rod is provided with a first positioning structure, and the other of the rotating base and the push rod is provided with a second positioning structure, the first positioning structure being adapted to fix the end coupling protrusions of the two-way traction cable, and the second positioning structure being adapted to fix the intermediate coupling protrusion of the two-way traction cable.

5. The child carrier according to claim 3, wherein the rotating base is further provided with a mounting groove and end engaging grooves located at two ends of the mounting groove,
wherein the mounting groove is adapted to mount the two-way traction cable, and the end engaging grooves are adapted to be engaged with the end coupling protrusions,
wherein a depth of each of the end engaging grooves is greater than that of the mounting groove, and/or a width of each of the end engaging grooves is greater than that of the mounting groove.

6. The child carrier according to claim 3, wherein the rotating base is further provided with an annular mounting groove and an intermediate engaging groove located in the annular mounting groove, wherein the annular mounting groove is adapted to mount the two-way traction cable, and the intermediate engaging groove is adapted to be engaged with the intermediate coupling protrusion,
wherein a depth of the intermediate engaging groove is greater than that of the annular mounting groove, and/or a width of the intermediate engaging groove is greater than that of the annular mounting groove.

7. The child carrier according to claim 3, wherein the push rod is further provided with a mounting groove and end engaging grooves located at two ends of the mounting groove,
wherein the mounting groove is adapted to mount the two-way traction cable, and the end engaging grooves are adapted to be engaged with the end coupling protrusions,
wherein a depth of each of the end engaging grooves is greater than that of the mounting groove, and/or a width of each of the end engaging grooves is greater than that of the mounting groove.

8. The child carrier according to claim 3, wherein the push rod is further provided with an annular mounting groove and an intermediate engaging groove located in the annular mounting groove,
wherein the annular mounting groove is adapted to mount the two-way traction cable, and the intermediate engaging groove is adapted to be engaged with the intermediate coupling protrusion,
wherein a depth of the intermediate engaging groove is greater than that of the annular mounting groove, and/or a width of the intermediate engaging groove is greater than that of the annular mounting groove.

9. The child carrier according to claim 1, further comprising an unlocking assembly, the unlocking assembly being arranged between the leading assembly and the front fork and having a lock position and an unlock position, wherein, at the lock position, the leading assembly and the front wheel assembly are circumferentially locked to rotate synchronously, and at the unlock position, the leading assembly and the front wheel assembly are rotatably connected to rotate independently of each other.

10. The child carrier according to claim 9, wherein the front fork further comprises a pair of fork arms and a rotating base connected between the pair of fork arms, wherein the unlocking assembly comprises a locking member, the locking member being slidably arranged on the leading assembly and having a locking pin and an operating portion arranged on the locking pin, wherein, at the lock position, the locking pin is vertically inserted into a pin hole formed in the rotating base, and at the unlock position, the locking pin is detached from the pin hole.

11. The child carrier according to claim 10, wherein the unlocking assembly further comprises:
an elastic member configured to comprise a first fixed end, a second fixed end, and a bent elastic body located between the first fixed end and the second fixed end; and
a support protrusion arranged on the leading assembly and adjacent to the locking member, wherein the first fixed end and the second fixed end are respectively fixed to the locking member, the elastic body comprises a first part and a second part, wherein, when the locking member is at the lock position, the support protrusion supports the first part to apply a downward elastic force to the locking member, and wherein, when the locking member is at the unlock position, the support protrusion supports the second part to apply an upward elastic force to the locking member.

12. The child carrier according to claim 10, wherein the leading assembly comprises:
a handlebar assembly having a handlebar and a connecting portion extending downwards from a middle portion of the handlebar; and
a connecting assembly configured to support the unlocking assembly and fixedly connected to the connecting portion of the handlebar assembly and rotatably connected to the rotating base,
wherein the connecting assembly comprises a support frame having the support protrusion and a gland detachably connected to the support frame, the unlocking assembly is slidably arranged between the gland and the support frame, and the operating portion is exposed through an opening in the gland.

13. The child carrier according to claim 12, wherein the support frame comprises a connecting pipe located at a lower part thereof, a lamp support portion located at an upper part thereof, a locking member support portion located at a middle part thereof, and a hollow connecting shaft located at the center of the connecting pipe, wherein the locking member support portion has the support protrusion and is connected to the gland and the connecting portion.

14. The child carrier according to claim 13, wherein the front fork further comprises:
a stepped connecting hole arranged at the center of the rotating base, the connecting shaft being inserted into the stepped connecting hole; and
a rotating nail and a fastening assembly, the rotating nail being inserted into a central hole of the connecting shaft and the stepped connecting hole, so as to rotatably axially connect the front fork and the leading assembly.

15. The child carrier according to claim 13, wherein the connecting pipe is further provided with a pair of stop ribs,
wherein the rotating base further comprises a limiting protrusion arranged adjacent to the pin hole, and is configured such that when the unlocking assembly is at the unlock position, the rotating base is rotatable between the pair of stop ribs.

16. The child carrier according to claim 1, further comprising:
a first connecting member configured to rotatably connect the leading assembly and the front wheel assembly to the frame body;
a second connecting member configured to connect the frame body and the push rod; and
a cover plate configured to cover a bottom side of the frame body and/or a bottom end surface of the push rod,
wherein the first connecting member comprises:
a tubular connecting portion rotatably connecting the leading assembly and a rotating base of the front fork; and
at least one connecting rib connected between the tubular connecting portion and the frame body.

17. The child carrier according to claim 16, wherein the traction assembly comprises:
a two-way traction cable connected between the front fork and the push rod;
a sheath wrapping a part of the two-way traction cable other than a part connected to the push rod and the front fork; and
at least one protective clamp arranged on an end portion of the sheath and clamped in the first connecting member and/or the second connecting member.

18. The child carrier according to claim 16, wherein the second connecting member has a through hole for accommodating the push rod, and a pair of spaced snap protrusions are arranged at a bottom end of the through hole to constrain a bottom end of the push rod.

19-21. (canceled)

22. The child carrier according to claim 1, wherein the traction assembly further comprises a two-way traction cable connected between the front wheel assembly and the push rod, end coupling protrusions arranged at two ends of the two-way traction cable, and an intermediate coupling protrusion arranged on a middle section of the two-way traction cable,
wherein the end coupling protrusions are engaged with one of the push rod and the front fork, the intermediate coupling protrusion is engaged with the other of the push rod and the front fork, and the two-way traction cable is mounted around the other.

23-29. (canceled)

30. The child carrier according to claim 1, wherein the child carrier further comprises at least one power generation assembly mounted in at least one wheel of the front wheel assembly and the rear wheel assembly, wherein the power generation assembly has a rectifier to transmit, through the rectifier, power generated by the power generation assembly to at least one of a light-emitting device, an electronic sound-generating module, a battery, and a USB interface.

31-72. (canceled)
